(19) United States
(12) Patent Application Publication
(10) Pub. No.: US 2010/0311941 A1
(43) Pub. Date: Dec. 9, 2010

(54) COPOLYMERIZATION OF EPOXIDES AND CYCLIC ANHYDRIDES

(76) Inventors: Geoffrey W. Coates, Lansing, NY (US); Ryan Jeske, Zionsville, IN (US); Scott D. Allen, Ithaca, NY (US)

Correspondence Address: CHOATE, HALL & STEWART LLP, TWO INTERNATIONAL PLACE, BOSTON, MA, 02110, US

(21) Appl. No.: 12/674,012

(22) PCT Filed: Aug. 20, 2008
(86) PCT No.: PCT/US08/09978

§ 371 Date: Feb. 18, 2010

Related U.S. Application Data
(60) Provisional application No. 60/935,568, filed on Aug. 20, 2007.

(51) Int. Cl. C08G 65/26

(52) U.S. Cl. 528/405; 528/417

(57) ABSTRACT

The present invention provides novel polymers and methods of preparing the same.

### CROSS REFERENCE TO RELATED APPLICATIONS

This application claims priority to U.S. Provisional Patent Application Ser. No. 60/935,568, filed Aug. 20, 2007.

### BACKGROUND

Polyesters constitute an important class of polymers due to their biodegradability and biocompatibility, which enables their use in drug delivery systems, artificial tissues, and commodity materials. Polyesters such as poly(butylenesuccinate) are commonly produced through condensation polymerization; however, this method is energy intensive, requiring high temperature and the removal of the alcohol or water byproduct to achieve high molecular weight (Mₙ) polymers. Poly(hydroxyalkanoate)s can alternatively be synthesized through bacterial fermentation, yet this process is also energy intensive. Polyesters such as poly(lactic acid) (PLA) and poly(ε-caprolactone) may be prepared by the ring-opening polymerization of lactones, a technique mild enough to avoid the formation of small molecule byproducts but hampered by limitations in scope; polymer architecture is generally constrained by the availability of structurally diverse lactones. A different approach, the ring opening copolymerization of epoxides and cyclic anhydrides, has the potential to produce a wider variety of polymer backbone structures; see, for example, Aida et. al., Macromolecules 1985, 18, 1049-1055. However, catalysts reported for this reaction exhibit relatively low activities and produce polyesters with low Mₙ values.

### DEFINITIONS

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain compounds of the present invention can comprise one or more asymmetric centers, and thus can exist in various isomeric forms, e.g., stereoisomers and/or diastereomers. Thus, inventive compounds and compositions may be in the form of an individual enantiomer; diastereomer or geometric isomer, or may be in the form of a mixture of stereoisomers. In certain embodiments, compounds provided and/or utilized herein are enantiopure compounds. In certain other embodiments, mixtures of stereoisomers or diastereomers are provided.

Furthermore, certain compounds, as described herein may have one or more double bonds that can exist as either the Z or E isomer, unless otherwise indicated. In certain embodiments, the invention encompasses such compounds and/or their preparation and/or use as individual isomers substantially free of other isomers and alternatively, as mixtures of various isomers, e.g., racemic mixtures of stereoisomers. In addition to the particular compounds that are illustrated per se herein, in certain embodiments, the present invention encompasses derivatives (e.g., pharmaceutically acceptible and/or industrially appropriate derivatives) of the illustrated compounds, and compositions comprising one or more such derivatives.

Where a particular enantiomer is preferred, it may, in some embodiments be provided substantially free of the corresponding enantiomer, for example in an “optically enriched” preparation. “Optically-enriched,” as used herein, means that a significantly greater proportion of one enantiomer is present as compared with the other enantiomer. In certain embodiments, an optically enriched preparation comprises at least about 90% by weight of a preferred enantiomer. In some embodiments, an optically enriched preparation contains at least about 95%, 98%, or 99% by weight of a particular enantiomer. Individual enantiomers may be isolated from racemic mixtures by any method known to those skilled in the art, including, for example, chiral high pressure liquid chromatography (HPLC) and the formation and crystallization of chiral salts or prepared by asymmetric syntheses. See, for example, Jacques, et al., Enantiomers, Racemates and Resolutions (Wiley Interscience, New York, 1981); Wilen, S. H., at al., Tetrahedron 33:2725 (1977); Eliel, E. L. Stereochemistry of Carbon Compounds (McGraw-Hill, N.Y., 1962); Wilen, S. H. Tables of Resolving Agents and Optical Resolutions p. 268 (E. L. Eliel, Ed., Univ. of Notre Dame Press, Notre Dame, IN 1972).

The terms “halo” and “halogen” as used herein refer to an atom selected from fluorine (fluoro, —F), chlorine (chloro, —Cl), bromine (bromo, —Br), and iodine (iodo, —I).

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-10 carbon atoms. In certain embodiments, aliphatic groups contain 1-8 carbon atoms. In certain embodiments, aliphatic groups contain 1-6 carbon atoms. In some embodiments, aliphatic groups contain 1-5 carbon atoms, in some embodiments, aliphatic groups contain 1-4 carbon atoms, in yet other embodiments aliphatic groups contain 1-3 carbon atoms, and in yet other embodiments aliphatic groups contain 1-2 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “unsaturated”, as used herein, means that a moiety has one or more double or triple bonds.

The terms “cycloaliphatic”, “carbocycle”, or “carbocyclic”, used alone or as part of a larger moiety, refer to a saturated or partially unsaturated cyclic aliphatic monocyclic or bicyclic ring systems, as described herein, having from 3 to 10 members, wherein the aliphatic ring system is optionally substituted as defined above and described herein. Cycloaliphatic groups include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, and cyclooctadienyl. In some embodiments, the cycloalkyl has 3-6 carbons. The terms “cycloaliphatic”, “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring.

The term “alkyl,” as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-10 carbon atoms. In certain embodiments, alkyl groups contain 1-8 carbon atoms. In certain embodiments, allyl groups contain 1-6 carbon atoms. In some embodiments, alkyl groups contain 1-5 carbon atoms, in some embodiments, alkyl groups contain 1-4 carbon atoms, in yet other embodiments alkyl groups contain 1-3 carbon atoms, and in yet other embodiments alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “alkenyl,” as used herein, denotes a monovalent group derived from a straight- or branched-chain aliphatic moiety having at least one carbon-carbon double bond by the removal of a single hydrogen atom. Unless otherwise specified, alkenyl groups contain 2-10 carbon atoms. In certain embodiments, alkenyl groups contain 2-8 carbon atoms. In certain embodiments, alkenyl groups contain 2-6 carbon atoms. In some embodiments, alkenyl groups contain 2-5 carbon atoms, in some embodiments, alkenyl groups contain 2-4 carbon atoms, in yet other embodiments alkenyl groups contain 2-3 carbon atoms, and in yet other embodiments alkenyl groups contain 2 carbon atoms. Alkenyl groups include, for example, ethenyl, propenyl, butenyl, 1-methyl-2-buten-1-yl, and the like.

The term “alkynyl,” as used herein, refers to a monovalent group derived from a straight- or branched-chain aliphatic moiety having at least one carbon-carbon triple bond by the removal of a single hydrogen atom. Unless otherwise specified, alkynyl groups contain 2-10 carbon atoms. In certain embodiments, alkynyl groups contain 2-8 carbon atoms. In certain embodiments, alkynyl groups contain 2-6 carbon atoms. In some embodiments, alkynyl groups contain 2-5 carbon atoms, in some embodiments, alkynyl groups contain 2-4 carbon atoms, in yet other embodiments alkynyl groups contain 2-3 carbon atoms, and in yet other embodiments alkynyl groups contain 2 carbon atoms. Representative alkynyl groups include, but are not limited to, ethynyl, 2-propynyl (propargyl), 1-propynyl, and the like.

The term “aryl” used alone or as part of a larger moiety as in “aralkyl”, “aralkoxy”, or “aryloxyalkyl”, refers to monocyclic and bicyclic ring systems having a total of five to 10 ring members, wherein at least one ring in the system is aromatic and wherein each ring in the system contains three to seven ring members. The term “aryl” may be used interchangeably with the term “aryl ring”. In certain embodiments of the present invention, “aryl” refers to an aromatic ring system which includes, but not limited to, phenyl, biphenyl, naphthyl, anthracyl and the like, which may bear one or more substituents. Also included within the scope of the term “aryl”, as it is used herein, is a group in which an aromatic ring is fused to one or more non-aromatic rings, such as indanyl, phthalimidyl, naphthimidyl, phenantriidinyl, or tetrahydronaphthyl, and the like.

The terms “heteroaryl” and “heteroar-”, used alone or as part of a larger moiety, e.g., “heteroaralkyl”, or “heteroaralkoxy”, refer to groups having 5 to 10 ring atoms, preferably 5, 6, or 9 ring atoms; having 6, 10, or 14 π electrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of a basic nitrogen. Heteroaryl groups include, without limitation, thienyl, furanyl, pyrrolyl, imidazolyl, pyrazolyl, triazolyl, tetrazolyl, oxazolyl, isoxazolyl, oxadiazolyl, thiazolyl, isothiazolyl, thiadiazolyl, pyridyl, pyridazinyl, pyrimidinyl, pyrazinyl, indolizinyl, purinyl, naphthyridinyl, and pteridinyl. The terms “heteroaryl” and “heteroar-”, as used herein, also include groups in which a heteroaromatic ring is fused to one or more aryl, cycloaliphatic, or heterocyclyl rings, where the radical or point of attachment is on the heteroaromatic ring. Nonlimiting examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. A heteroaryl group may be mono- or bicyclic. The term “heteroaryl” may be used interchangeably with the terms “heteroaryl ring”, “heteroaryl group”, or “heteroaromatic”, any of which terms include rings that are optionally substituted. The term “heteroaralkyl” refers to an alkyl group substituted by a heteroaryl, wherein the alkyl and heteroaryl portions independently are optionally substituted.

As used herein, the terms “heterocycle”, “heterocyclyl”, “heterocyclic radical”, and “heterocyclic ring” are used interchangeably and refer to a stable 5- to 7-membered monocyclic or 7-10-membered bicyclic heterocyclic moiety that is either saturated or partially unsaturated, and having, in addition to carbon atoms, one or more, preferably one to four, heteroatoms, as defined above. When used in reference to a ring atom of a heterocycle, the term “nitrogen” includes a substituted nitrogen. As an example, in a saturated or partially unsaturated ring having 0-3 heteroatoms selected from oxygen, sulfur or nitrogen, the nitrogen may be N (as in 3,4-dihydro-2H-pyrrolyl), NH (as in pyrrolidinyl), or ⁺NR (as in N-substituted pyrrolidinyl).

A heterocyclic ring can be attached to its pendant group at any heteroatom or carbon atom that results in a stable structure and any of the ring atoms can be optionally substituted. Examples of such saturated or partially unsaturated heterocyclic radicals include, without limitation, tetrahydrofuranyl, tetrahydrothienyl, pyrrolidinyl, pyrrolidonyl, piperidinyl, pyrrolinyl, tetrahydroquinolinyl, tetrahydroisoquinolinyl, decahydroquinolinyl, oxazolidinyl, piperazinyl, dioxanyl, dioxolanyl, diazepinyl, oxazepinyl, thiazepinyl, morpholinyl, and quinuclidinyl. The terms “heterocycle”, “heterocyclyl”, “heterocyclyl ring”, “heterocyclic group”, “heterocyclic moiety”, and “heterocyclic radical”, are used interchangeably herein, and also include groups in which a heterocyclyl ring is fused to one or more aryl, heteroaryl, or cycloaliphatic rings, such as indolinyl, 3H-indolyl, chromanyl, phenanthridinyl, or tetrahydroquinolinyl, where the radical or point of attachment is on the heterocyclyl ring. A heterocyclyl group may be mono- or bicyclic. The term “heterocyclylalkyl” refers to an alkyl group substituted by a heterocyclyl, wherein the alkyl and heterocyclyl portions independently are optionally substituted.

As used herein, the term “electron withdrawing group” refers to a group characterized by a tendency to attract electrons. Exemplary such groups are known in the art and include, by way of nonlimiting example, halogen, nitriles, carboxylic acids, and carbonyls.

As used herein, the term “election donating group” refers to —OR^{∘}; —NR^{∘}; —SR^{∘}; wherein each R^{∘} may be substituted as defined below and is independently hydrogen, C₁₋₆ aliphatic, —(CH₂)₀₋₁Ph, or a 5-6-membered saturated, partially unsaturated, or aryl ring having 0-4 heteroatoms independently selected from nitrogen, oxygen, or sulfur.

As used herein, the term “partially unsaturated” refers to a ring moiety that includes at least one double or triple bond. The term “partially unsaturated” is intended to encompass rings having multiple sites of unsaturation, but is not intended to include aryl or heteroaryl moieties, as herein defined.

As described herein, compounds of the invention may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

Suitable monovalent substituents on a substitutable carbon atom of an “optionally substituted” group are independently halogen; —(CH₂)₀₋₄R^{∘}; —(CH₂)₀₋₄OR^{∘}; —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘}N(R^{∘})C(O)R^{∘}; —N(R^{∘}N(R^{∘})C(O)NR^{∘}₂; —N(R^{∘})C(S)C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂) ₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —SC(S)SR^{∘}, —(CH₂)₀₋₄OC(O)NR^{∘}₂; —C(O)N(OR^{∘}R^{∘}; —C(O)C(O)R^{∘}; —C(O)CH₂C(O)R^{∘}; —C(NOR^{∘}R^{∘}; —(CH₂)₀₋₄SSR^{∘}; —(CH₂)₀₋₄S(O)₂R^{∘}; —(CH₂)₀₋₄(O)₂OR^{∘}; —(CH₂)₀₋₄OS(O)₂R^{∘}; —S(O)₂NR^{∘}₂; —(CH₂)₀₋₄S(O)R^{∘}; —N(R^{∘}S(O)₂NR^{∘}₂; —N(R^{∘})S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘}₂; SiR^{∘}₃; —(C₁₋₄ straight or branched allylene)O—N(R^{∘})₂; or —(C₁₋₄ straight or branched)alkylene)C(O)O—N(R^{∘}₂, wherein each R^{∘} may be substituted as defined below and is independently hydrogen, C₁₋₆ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or bicyclic ring having 0-4 heteroatoms independently selected from nitrogen, oxygen, or sulfur, which may be substituted as defined below.

Suitable monovalent substituents on R^{∘} (or the ring formed by taking two independent occurrences of R^{∘} together with their intervening atoms), are independently halogen, —(CH₂)₀₋₂R^{}, -(halonR^{}), —(CH₂)₀₋₂OH, —(CH₂)₀₋₂OR^{}, —(CH₂)₀₋₂CH(OR^{}₂; —O(haloR^{}), —CN, —N₃, —(CH₂)₀₋₂C(O)R^{}, —(CH₂)₀₋₂C(O)OH, —(CH₂)₀₋₂C(O)OR^{}, —(CH₂)₀₋₂SR^{}, —(CH₂)₀₋₂SH, —(CH₂)₀₋₂NH₂, —(CH₂)₀₋₂NHR^{}, —(CH₂)₀₋₂NR^{}₂, —NO₂, —SiR^{}₃, —OSiR^{}₃, —C(O)SR^{}, —(C₁₋₄ straight or branched alkylene)C(O)OR^{}, or —SSR^{} wherein each R^{} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{∘} include ═O and ═S.

Suitable divalent substituents on a saturated carbon atom of an “optionally substituted” group include the following: ═S, ═NNR*₂, ═NNHC(O)R*, ═NNHC(O)OR*, ═NNHS(O)₂R*, ═NR*, NOR*, —O(C(R*₂))₂₋₃O—, or —S(C(R*₂))₂₋₃S—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{}, —(haloR^{}), —OH, —OR^{}, —O(haloR^{}), —CN, —C(O)OH, —C(O)OR^{}, —NH₂, —NHR^{}, —NR^{}₂, or —NO₂, wherein each R^{} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)R^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur. A substitutable nitrogen may be substituted with three R^{†} substituents to provide a charged ammonium moiety —N⁺(R^{†})₃, wherein the ammonium moiety is further complexed with a suitable counterion.

Suitable substituents on the aliphatic group of R^{†} are independently halogen, —R^{}, -(haloR^{}), —OH, —OR^{}, —O(haloR^{}), —CN, —C(O)OH, —C(O)OR^{}, —NH₂, —NHR^{}, —NR^{}₂, or —NO₂, wherein each R′ is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

As used herein, the term “tautomer” includes two or more interconvertable compounds resulting from at least one formal migration of a hydrogen atom and at least one change in valency (e.g., a single bond to a double bond, a triple bond to a single bond, or vice versa). The exact ratio of the tautomers depends on several factors, including temperature, solvent, and pH. Tautomerizations (i.e., the reaction providing a tautomeric pair) may catalyzed by acid or base. Exemplary tautomerizations include keto-to-enol; amide-to-imide; lactam-to-lactim; enamine-to-imine; and enamine-to-(a different) enamine tautomerizations.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the invention. For instance, an isomer/enantiomer may, in some embodiments, be provided substantially free of the corresponding enantiomer, and may also be referred to as “optically enriched.” “Optically-enriched,” as used herein, means that the compound is made up of a significantly greater proportion of one enantiomer. In certain embodiments the compound of the present invention is made up of at least about 90% by weight of a preferred enantiomer. In other embodiments the compound is made up of at least about 95%, 98%, or 99% by weight of a preferred enantiomer. Preferred enantiomers may be isolated from racemic mixtures by any method known to those skilled in the art, including chiral high pressure liquid chromatography (HPLC) and the formation and crystallization of chiral salts or prepared by asymmetric syntheses. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, N.Y., 1962); Wilen, S. H. Tables of Resolving Agents and Optical Resolutions p. 268 (E. L. Eliel, Ed., Univ. of Notre Dame Press, Notre Dame, IN 1972).

As used herein, “polymorph” refers to a crystalline inventive compound existing in more than one crystalline form/structure. When polymorphism exists as a result of difference in crystal packing it is called packing polymorphism. Polymorphism can also result from the existence of different conformers of the same molecule in conformational polymorphism. In pseudopolymorphism the different crystal types are the result of hydration or solvation.

### BRIEF DESCRIPTION OF THE DRAWING

FIG. 1 depicts ¹H and ¹³C NMR peak assignments for poly(cyclohexene diglycolate), Table 2, entry 1

FIG. 2 depicts ¹H NMR spectrum of poly(cyclohexene diglycolate), entry 1

FIG. 3 depicts ¹³C NMR spectrum of poly(cyclohexene diglycolate), entry 1

FIG. 4 depicts ¹H NMR and ¹³C peak assignments for poly(vinylcyclohexene diglycolate), Table X, entry 2

FIG. 5 depicts ¹H NMR spectrum of poly(vinylcyclohexene diglycolate), entry 2.

FIG. 6 depicts ¹³C NMR spectrum of poly(cyclohexene diglycolate), entry 2

FIG. 7 depicts ¹H NMR and ¹³C peak assignments for poly(limonene diglycolate), Table 2, entry 3

FIG. 8 depicts ¹H NMR spectrum of poly(limonene diglycolate), entry 3.

FIG. 9 depicts ¹³C NMR spectrum of poly(limonene diglycolate), entry 3

FIG. 10 depicts ¹H NMR and ¹³C peak assignments for poly(propylene diglycolate), Table 2, entry 4

FIG. 11 depicts ¹H NMR spectrum of poly(propylene diglycolate), entry 4.

FIG. 12 depicts ¹³C NMR spectrum of poly(propylene diglycolate), entry 4

FIG. 13 depicts ¹H NMR and ¹³C peak assignments for poly(cis-butene diglycolate), Table 2, entry 5

FIG. 14 depicts ¹H NMR spectrum of poly(cis-butene diglycolate), entry 5.

FIG. 15 depicts ¹³C NMR spectrum of poly(cis-butene diglycolate), entry 5

FIG. 16 depicts ¹H NMR and ¹³C peak assignments for poly(isobutylene diglycolate), Table 2, entry 6

FIG. 17 depicts ¹H NMR spectrum of poly(isobutylene diglycolate), entry 6.

FIG. 18 depicts ¹³C NMR spectrum of polyisobutylene diglycolate), entry 6

FIG. 19 depicts ¹H NMR and ¹³C peak assignments for poly(cyclohexene succinate), Table 2, entry 7

FIG. 20 depicts ¹H NMR spectrum of poly(cyclohexene succinate), entry 7.

FIG. 21 depicts ¹³C NMR spectrum of poly(cyclohexene succinate), entry 7

FIG. 22 depicts ¹H NMR and ¹³C peak assignments for poly(vinylcyclohexene succinate), Table 2, entry 8

FIG. 23 depicts ¹H NMR spectrum of poly(vinylcyclohexene succinate), entry 8.

FIG. 24 depicts ¹³C NMR spectrum of poly(vinylcyclohexene succinate), entry 8

FIG. 25 depicts ¹H NMR and ¹³C peak assignments for poly(limonene maleate), Table 2, entry 9

FIG. 26 depicts ¹H NMR spectrum of poly(limonene maleate), entry 9.

FIG. 27 depicts ¹³C NMR spectrum of poly(limonene maleate), entry 9

FIG. 28 depicts ORTEP drawing of 4 (non-hydrogen atoms) with thermal ellipsoids drawn at the 40% probability level.

FIG. 29 depicts a plot of the experimental concentrations of polyester and polycarbonate repeat units during the terpolymerization (polyester:; polycarbonate:) as measured by in situ IR spectroscopy (v_{c-o} polycarbonate=1328 cm⁻¹ and v_{c-o} polyester=1139 cm⁻¹). 37 μmol 1, 20 mmol CHO, 3.7 mmol DGA, 8.0 mL toluene, 6.8 atm CO₂, 50° C. Solid lines are calculated concentrations.

FIG. 30. depicts the effects of DGA (diglycolic anhydride) loading on terpolymerization.

FIG. 31 depicts elementary reactions, differential equations, initial concentrations and rate constants used to calculate theoretical concentrations of polyester and polycarbonate.

FIG. 32 depicts ¹H NMR spectrum of poly(cyclohexene diglycolate-block-cyclohexene carbonate), Table X, entry 3 (500 MHz, CDCl₃).

FIG. 33 depicts ¹³C NMR spectrum of poly(cyclohexene diglycolate-block-cyclohexene carbonate), Table X, entry 3 (125 MHz, CDCl₃).

FIG. 34 depicts ¹H NMR spectrum of poly(cyclohexene succinate-block-cyclohexene carbonate) (500 MHz, CDCl₃).

FIG. 35 depicts ¹³C NMR spectrum of poly(cyclohexene succinate-block-cyclohexene carbonate) (125 MHz, CDCl₃).

FIG. 36 depicts ¹H NMR spectrum of poly(vinylcyclohexene diglycolate-block-vinylcyclohexene carbonate) (500 MHz, CDCl₃).

FIG. 37 depicts ¹³C NMR spectrum of poly(vinylcyclohexene diglycolate-block-vinylcyclohexene carbonate) (125 MHz, CDCl₃).

FIG. 38 depicts the carbonyl region of ¹³C NMR spectra for Table X, entries 1, 3-7. The shift of the polycarbonate (PC) resonance toward higher field at 41 and 54 atm can be attributed to random CO₂ incorporation into the polyester (PE) block.

### DETAILED DESCRIPTION OF CERTAIN EMBODIMENTS

As generally described above, the present invention provides systems for preparing novel polyester compositions. For example, in one aspect the present invention provides methods of synthesizing novel polyester compositions from epoxides and cyclic anhydrides in the presence of a metal complex. In certain embodiments, the polyester is an alternating polymer. In certain embodiments, the polymer is an alternating polymer of an epoxide and a cyclic anhydride (e.g., with regular alternating units of epoxide and anhydride). In certain embodiments, the polyester is a random copolymer of poly(epoxide) and poly(anhydride).

In some embodiments, provided polyesters are copolymers of epoxides and cyclic anhydrides. In certain embodiments, provided polyesters are heteropolymers incorporating simple epoxide monomers including, but not limited to: ethylene oxide, propylene oxide, butylene oxide, hexene oxide, cyclopentene oxide, limonene oxide, norbornene oxide, and cyclohexene oxide.

According to one aspect, the present invention provides methods of making polymers. In certain embodiments, polymers are provided via polymerization of an epoxide and anhydride in the presence of a metallic complex, and encompass polyester polymers. In some embodiments, the polymer is a polyester. In certain embodiments, the polyester is highly is an alternating copolymer. In certain embodiments, the polyester is a random copolymer. In some embodiments, the polyester polymer is tapered. In some embodiments, the polyester is a block co-polymer. It will be appreciated that the term “compound”, as used herein, includes polymers described by the present disclosure.

In one aspect, the present invention provides a method of synthesizing a polyester polymer, the method comprising the step of reacting an epoxide in the presence of any of the above described metallic complexes.

In some embodiments, a provided polyester is of the formula I:

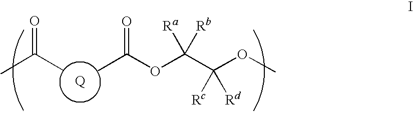

wherein:
R^{a}, R^{b}, R^{c} and R^{d} are each independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group.

In certain embodiments, the PDI of the composition is less than 2. In certain embodiments, the PDI of the composition is less than 1.8. In certain embodiments, the PDI of the composition is less than 1.5. In certain embodiments, the PDI of the composition is less than 1.4. In certain embodiments, the PDI of the composition is less than 1.3. In certain embodiments, the PDI of the composition is less than 1.2. In certain embodiments, the PDI of the composition is less than 1.1.

In certain embodiments, the present invention provides polymer of formula II:

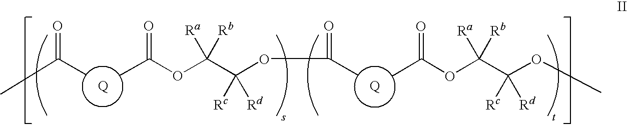

wherein:
s is an integer from 1 to 100,000;
t is an integer from 1 to 100,000;
the sum of s and t is greater than 9;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl; each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur, and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group;
wherein at least one [t] bracketed structure is different from an [s] bracketed structure.

In certain embodiments, the present invention provides a random co-polymer of formula

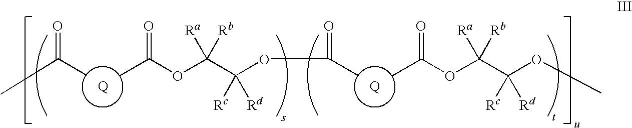

wherein:
s is an integer from 1 to 100,000;
t is an integer from 1 to 100,000;
the sum of s and t is greater than 9;
u is an integer greater than zero; each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group;
wherein at least one [t] bracketed structure is different from the [s] bracketed structure.

One of ordinary skill will appreciate that for compounds of formula M, each occurrence of a [t] bracketed structure and [s] bracketed structure are dispersed randomly within a [u] bracketed structure. In certain embodiments, compounds of formula III are tapered such that the occurrence of one block or more blocks gradually decreases from one end of the polymer to the other.

In certain embodiments, the present invention provides a block copolymer of formula IV:

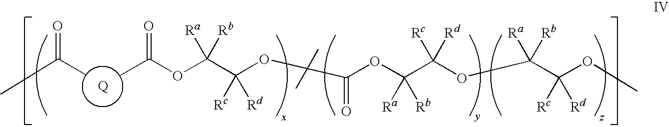

wherein:
x is an integer from 1 to 100,000;
y is an integer from 1 to 100,000;
z is an integer from 0 to 5000;
the sum of x and y is greater than 9;
each occurrence of R^{a}, R^{b}, R^{c}, and R^{d} is independently hydrogen or a C₁₋₃₀ carbon containing Moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group.

In certain embodiments, the value of z is less than 3% x+y+z. Thus the present invention provides a method for polymerization wherein the mole fraction of polyether linkages is less than 3%. In some embodiments, the mole fraction of polyether linkages is less than 2%. In some embodiments, the mole fraction of polyether linkages is less than 1%.

In some embodiments, the present invention provides a random copolymer of formula V:

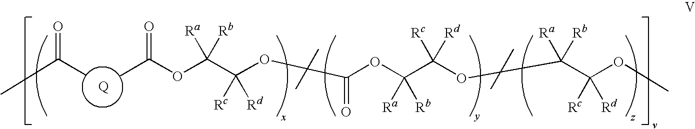

wherein:
x is an integer from 1 to 100,000;
y is an integer from 1 to 100,000;
z is an integer from 0 to 5000;
the sum of x and y is greater than 9;
v is an integer greater than zero;
each occurrence of R^{a}, R^{b}, R^{c}, and R^{d} is independently hydrogen or a C₁₋₃₀ carbon containing moiety; wherein any of (R^{a} and R^{b}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur, 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—.

One of ordinary skill will appreciate that for compounds of formula V, each occurrence of a [x] bracketed structure, [y] bracketed structure, and [z] bracketed structure are dispersed randomly within a [v] bracketed structure. In certain embodiments, compounds of formula V are tapered such that the occurrence of one block or more blocks gradually decreases from one end of the polymer to the other.

In certain embodiments, the value of z is less than 3% x+y+z. Thus the present invention provides a method for polymerization wherein the mole fraction of polyether linkages is less than 3%. In some embodiments, the mole fraction of polyether linkages is less than 2%. In some embodiments, the mole fraction of polyether linkages is less than 1%.

In certain embodiments, the polymer comprises a copolymer of two different repeating units where R^{a}, R^{b}, R^{c} and R^{d} of the two different repeating units are not all the same. In some embodiments, the polymer comprises a copolymer of three or more different repeating units wherein R^{a}, R^{b}, R^{c} and R^{d} of each of the different repeating units are not all the same as R^{a}, R^{b}, and R^{c} of any of the other different repeating units. In some embodiments, the polymer is a random copolymer. In some embodiments, the polymer is a tapered copolymer.

In some embodiments, R^{a} is optionally substituted C₁₋₁₂ aliphatic. In some embodiments, R^{a} is optionally substituted C₁₋₁₂ heteroaliphatic having 1-4 heteroatoms independently selected from the group consisting of nitrogen, oxygen, and sulfur. In some embodiments, R^{a} is optionally substituted 6-10-membered aryl. In some embodiments, R^{a} is optionally substituted 5-10-membered heteroaryl having 1-4 heteroatoms independently selected from nitrogen, oxygen, or sulfur. In some embodiments, R^{a} is optionally substituted 4-7-membered heterocyclic having 1-2 heteroatoms independently selected from the group consisting of nitrogen, oxygen, and sulfur. In some embodiments, R^{a} is selected from methyl, ethyl, propyl, or butyl.

In some embodiments, R^{a} is hydrogen. In some embodiments, R^{b} is optionally substituted C₁₋₁₂ aliphatic. In some embodiments, R^{b} is optionally substituted C₁₋₁₂ heteroaliphatic having 1-4 heteroatoms independently selected from the group consisting of nitrogen, oxygen, and sulfur. In some embodiments, R^{b} is optionally substituted 6-10-membered aryl. In some embodiments, R^{b} is optionally substituted 5-10-membered heteroaryl having 1-4 heteroatoms independently selected from nitrogen, oxygen, or sulfur. In some embodiments, R^{b} is optionally substituted 4-7-membered heterocyclic having 1-2 heteroatoms independently selected from the group consisting of nitrogen, oxygen, and sulfur. In some embodiments, R^{b} is methyl or taken together with R^{a} to form an optionally substituted 6-membered ring.

In some embodiments, R^{c} is hydrogen. In some embodiments, R^{c} is optionally substituted C₁₋₁₂ aliphatic. In some embodiments, R^{c} is optionally substituted C₁₋₁₂ heteroaliphatic having 1-4 heteroatoms independently selected from the group consisting of nitrogen, oxygen, and sulfur. In some embodiments, R^{c} is optionally substituted 6-10-membered aryl. In some embodiments, R^{c} is optionally substituted 5-10-membered heteroaryl having 1-4 heteroatoms independently selected from nitrogen, oxygen, or sulfur. In some embodiments, R^{c} is optionally substituted 4-7-membered heterocyclic having 1-2 heteroatoms independently selected from the group consisting of nitrogen, oxygen, and sulfur. In some embodiments, R^{c} is methyl

In some embodiments, R^{d} is hydrogen. In some embodiments, R^{c} is optionally substituted C₁₋₁₂ aliphatic. In some embodiments, R^{d} is optionally substituted C₁₋₁₂ heteroaliphatic having 1-4 heteroatoms independently selected from the group consisting of nitrogen, oxygen, and sulfur. In some embodiments, R^{d} is optionally substituted 6-10-membered aryl. In some embodiments, R^{d} is optionally substituted 5-10-membered heteroaryl having 1-4 heteroatoms independently selected from nitrogen, oxygen, or sulfur. In some embodiments, R^{d} is optionally substituted 4-7-membered heterocyclic having 1-2 heteroatoms independently selected from the group consisting of nitrogen, oxygen, and sulfur.

In certain embodiments, one of R^{B}, R^{b}, R^{c}, and R^{d} is hydrogen. In certain embodiments, two of R^{a}, R^{b}, R^{c}, and R^{d} are hydrogen. In certain embodiments, three of R^{a}, R^{b}, R^{c}, and R^{d} are hydrogen.

In certain embodiments, R^{a}, R^{b}, R^{c}, and R^{d} are each independently an optionally substituted C₁₋₃₀ aliphatic group. In certain embodiments, R^{a}, R^{b}, R^{c}, and R^{d} are each independently an optionally substituted C₁₋₂₀ aliphatic group. In certain embodiments, R^{a}, R^{b}, R^{c}, and R^{d} are each independently an optionally substituted C₁₋₁₂ aliphatic group. In certain embodiments, R^{B}, R^{b}, R^{c}, and R^{d} are each independently an optionally substituted C₁₋₈ aliphatic group. In certain embodiments, R^{a}, R^{b}, R^{c}, and R^{d} are each independently an optionally substituted C₃₋₈ aliphatic group. In certain embodiments, R^{a}, R^{b}, R^{c}, and R^{d} are each independently an optionally substituted C₃₋₁₂ aliphatic group.

In certain embodiments, R^{a} is an optionally substituted C₁₋₃₀ aliphatic group. In certain embodiments, R^{b} is an optionally substituted C₁₋₃₀ aliphatic group. In certain embodiments, R^{c} is an optionally substituted C₁₋₃₀ aliphatic group. In certain embodiments, R^{d} is an optionally substituted C₁₋₃₀ aliphatic group.

In some embodiments, an R^{a} and an R^{b} attached to the same carbon are taken together to form one or more optionally substituted 3-12-membered carbocyclic rings. In some embodiments, an R^{a} and an R^{b} attached to the same carbon are taken together to form a polycyclic carbocycle comprising two or more optionally substituted 3-8-membered carbocyclic rings. In some embodiments, an R^{a} and an R^{b} attached to the same carbon are taken together to form a polycyclic carbocycle comprising two or more optionally substituted 5-7-membered carbocyclic rings.

In some embodiments, an R^{a} and an R^{b} attached to the same carbon are taken together to form a bicyclic carbocycle comprising two optionally substituted 3-12-membered carbocyclic rings. In some embodiments, an R^{a} and an R^{b} attached to the same carbon are taken together to form a bicyclic carbocycle comprising two optionally substituted 3-8-membered carbocyclic rings. In some embodiments, an R^{a} and an R^{b} attached to the same carbon are taken together to form a bicyclic carbocycle comprising two optionally substituted 5-7-membered carbocyclic rings.

In some embodiments, an R^{a} and an R^{c} attached to adjacent carbons are taken together to form one or more optionally substituted 3-12-membered carbocyclic rings. In some embodiments, an R^{a} and an R^{c} attached to adjacent carbons are taken together to form a polycyclic carbocycle comprising two or more optionally substituted 3-8-membered carbocyclic rings. In some embodiments, an R^{a} and an R^{c} attached to adjacent carbons are taken together to form a polycyclic carbocycle comprising two or more optionally substituted 5-7-membered carbocyclic rings.

In some embodiments, an R^{a} and an R^{c} attached to adjacent carbons are taken together to form a bicyclic carbocycle comprising two optionally substituted 3-12-membered carbocyclic rings. In some embodiments, an R^{a} and an R^{c} attached to adjacent carbons are taken together to form a bicyclic carbocycle comprising two optionally substituted 3-8-membered carbocyclic rings. In some embodiments, an R^{a} and an R^{c} attached to adjacent carbons are taken together to form a bicyclic carbocycle comprising two optionally substituted 5-7-membered carbocyclic rings.

In certain embodiments, an R^{a} and an R^{c} attached to adjacent carbons are taken together to form an optionally substituted 3-12-membered carbocyclic ring. In certain embodiments, an R^{a} and an R^{c} attached to adjacent carbons are taken together to form an optionally substituted 3-8-membered carbocyclic ring. In certain embodiments, an R^{a} and an R^{c} attached to adjacent carbons are taken together to form an optionally substituted 5-7-membered carbocyclic ring.

In certain embodiments, Q is an optionally substituted, straight or branched, saturated or unsaturated, C₁₋₃₀ carbon containing moiety. In certain embodiments, Q is an optionally substituted C₁₋₃₀ aliphatic group. In certain embodiments, Q is an optionally substituted C₁₋₃₀ aliphatic group. In certain embodiments, Q is an optionally substituted C₁₋₁₂ aliphatic group. In certain embodiments, Q is an optionally substituted C₁₋₈ aliphatic group. In certain embodiments, Q is an optionally substituted C₃₋₈ aliphatic group. In certain embodiments, Q is an optionally substituted C₃₋₁₂ aliphatic group.

In some embodiments, Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur, 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—.

In some embodiments, Q is —CH₂CH₂—. In some embodiments, Q is —CH2OCH2—. In some embodiments, Q is —CHCH—. In some embodiments. Q is —CHMeCH₂—. In some embodiments, Q is —CHEtCH₂—. In some embodiments, Q is

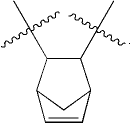

In some embodiments, Q is

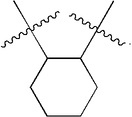

In some embodiments, Q is

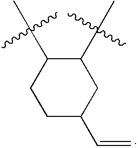

In some embodiments, Q comprises a limonene moiety.

As described and defined above for provided polyesters of the invention, in certain embodiments Q is an optionally substituted C₁₋₃₀ aliphatic. In certain embodiments, any carbon-hydrogen bond of Q may be replaced with an R′″ group, where R′″ is selected from halogen; —(CH₂)₀₋₄R^{∘}; —(CH₂)₀₋₄OR^{∘}; —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O—(CH₂)₀₋₁Ph which may be substituted with R^{∘}; —CH═CHPh, which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘}N(R^{∘})C(O)NR^{∘}₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)N(R^{∘}₂; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —SC(S)SR^{∘}, —(CH₂)₀₋₄OC(O)NR^{∘}₂; —C(O)N(OR^{∘})R^{∘}; —C(O)C(O)R^{∘}; —C(O)CH₂C(O)R^{∘}; —C(NOR^{∘}R^{∘}; —(CH₂)₀₋₄SSR^{∘}; —(CH₂)₀₋₄S(O)₂R^{∘}; —(CH₂)₀₋₄S(O)₂R^{∘}; —(CH₂)₀₋₄OS(O)₂R^{∘}; —S(O)NR^{∘}₂; —(CH₂)₀₋₄S(O)R^{∘}; —N(R^{∘})S(O)₂NR^{∘}₂; —N(R^{∘}S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘}₂; SiR^{∘}₃; —(C₁₋₄ straight or branched alkylene)O—N(R^{∘})₂; or —(C₁₋₄ straight or branched allylene)C(O)O—N(R^{∘})₂, wherein each R^{∘} may be substituted as defined above and is independently hydrogen, C₁₋₈ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or polycyclic ring having 0-4 heteroatoms independently selected from nitrogen, oxygen, or sulfur. In certain embodiments, one or more of the carbon atoms of the aliphatic ring may be replaced by a heteroatom.

In some embodiments, the polymer contains a metallic complex. In some embodiments, the polymer comprises residue of a metallic complex. In some embodiments, the polymer comprises a salt of an organic cation and X, wherein X is a nucleophile or counterion. In some embodiments, the organic cation is quaternary ammonium. In some embodiments, X is 2,4-dinitrophenolate anion.

As described and defined above for provided polyesters of the invention, in certain embodiments R^{a}, R^{b}, R^{c}, and R^{d} are each independently optionally substituted C₁₋₃₀) aliphatic. In certain embodiments, any carbon-hydrogen bond of R^{a}, R^{b}, R^{c}, and R^{d} may be replaced with an R′″ group, where R′″ is selected from halogen; —(CH₂)₀₋₄R^{∘}; —(CH₂)₀₋₄OR^{∘}; —O—(CH₂)₀₋₄C(O)OR^{∘}; —(CH₂)₀₋₄CH(OR^{∘}₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘}N(R^{∘})C(O)NR^{∘}₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)N(R^{∘}₂; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —SC(S)SR^{∘}, —(CH₂)₀₋₄OC(O)NR^{∘}₂; —C(O)N(OR^{∘})R^{∘}; —C(O)C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘}₂; —(CH₂)₀₋₄S(O)R^{∘}; —N(R^{∘}S(O)₂NR^{∘}₂; —N(R^{∘}S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘}₂; SiR^{∘}₃; —(C₁₋₄ straight or branched allylene)O—N(R^{∘})₂; or —(C₁₋₄ straight or branched alkylene)C(O)O—N(R^{∘})₂, wherein each R^{∘} may be substituted as defined above and is independently hydrogen, C₁₋₈ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or polycyclic ring having 0-4 heteroatoms independently selected from nitrogen, oxygen, or sulfur. In certain embodiments, one or more of the carbon atoms of the aliphatic ring may be replaced by a heteroatom.

### II. Epoxides

Epoxides for use in accordance with the present invention include epoxides substituted with one or more C₁₋₃₀ carbon containing groups. In some embodiments, the carbon containing group is aliphatic, where “aliphatic” denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. In some embodiments, any epoxide may be utilized as a starting material in accordance with the invention, and thus polyesters provided by the present invention may incorporate any epoxide monomer. In certain embodiments, epoxides comprise one or more optionally substituted C₁₋₃₀ aliphatic groups. In certain embodiments, epoxides comprise one or more optionally substituted C₁₋₁₂ aliphatic groups. In certain embodiments, epoxides comprise one or more optionally substituted C₁₋₈ aliphatic groups. In certain embodiments, epoxide monomers have cyclic or polycyclic motifs.

One of ordinary skill in the art will recognize that epoxides described herein may be prepared from a corresponding olefin (i.e., alkene). Any alkene may be used that provides a corresponding epoxide as described herein. In some embodiments, the alkene is optionally substituted C₁₋₃₀ acyclic. In some embodiments, the alkene is optionally substituted C₁₋₃₀ cyclic. In some embodiments, the alkene is optionally substituted C₁₋₃₀ polycyclic. In certain embodiments, one or more double bonds are exocyclic. In certain embodiments, one or more double bonds are endocyclic. In certain embodiments, the alkene is an allylic alcohol.

It will be appreciated that epoxidation of exocyclic and endocyclic double bonds can be achieved under any of a number of suitable conditions. Suitable epoxidation reagents and conditions are known to one of ordinary skill in the art, and include those described in March (supra); U.S. Pat. No. 4,882,442; Kratz et al., Peroxide Chemistry, 2005, 39-59; Journal of Molecular Catalysis, 222, 2004, 103-119); and others cited herein. Non-limiting examples of suitable epoxidation reagents include peroxyacids such as m-chloroperoxybenzoic acid, trifluoroperoxyacetic acid, and 3,15-dinitroperoxybenzoic acid; allyl peroxides such as t-butyl hydroperoxide; hydrogen peroxide; complexes of transition metals such as V, Mn, Mg, Mo, Ti, or Co; DCC; Oxone®; VO(O-isopropyl)₃ in liquid CO₂; polymer-supported cobalt(II) acetate; dimethyl dioxirane; magnesium monoperoxyphthalate; oxygen; and photooxygenation in the presence of a Ti, V, or Mo complex. Suitable epoxidation condition may be stoichiometric or catalytic in nature, may optionally comprise metal complexes with or without asymmetric ligands. Catalytic epoxidations may include an oxidant in stoichiometric or superstoichiometric amounts.

Suitable epoxidation conditions typically employ a suitable solvent. In certain embodiments, nonpolar solvents are used. Examples of such nonpolar solvents include, but are not limited to, hydrocarbons and halogenated hydrocarbons such as dichloromethane, pentane, benzene, and toluene.

As described above, in certain embodiments, the polyesters are copolymers of cyclic anhydrides and epoxides. Suitable spiro-epoxides are well known in the art and many are available through known means by epoxidation of exocyclic, double bonds as shown in Scheme A.

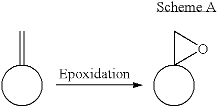

In some embodiments, the epoxide monomers include ring systems wherein the epoxide is part of a fused ring system. Compounds of this class are well known in art and methods to synthesize them are well established (vide supra). Typically, such epoxides are accessed through epoxidation of double bonds that are part of a ring system.

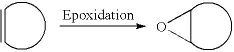

Suitable fused-ring epoxides include those where the epoxide ring contains two carbons that are part of another ring system. Examples of such substructures include, but are not limited to:

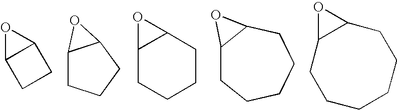

wherein any carbon hydrogen bond may be replaced with an R′″ group as defined above. In certain embodiments, one or more of the carbon atoms of the aliphatic ring may be replaced by a heteroatom. In certain embodiments, one or more of the bonds in the ring system may be a double bond.

Examples of potentially suitable polycyclic epoxides include, but are not limited to, those shown in above and herein

One of ordinary skill in the art, reading the present discloser, will recognize that carbon containing compounds comprising multiple double bonds may be subject to undergoing epoxidation at multiple sites. Techniques available to a skilled artisan allow for the selective epoxidation of one or more double bonds, and all such permutations of epoxides are contemplated by the present invention.

In certain embodiments, epoxide monomers include epoxides derived from naturally occurring materials such as epoxidized resins or oils. Examples of such epoxides include, but are not limited to: Epoxidized Soybean Oil; Epoxidized Linseed Oil; Epoxidized Octyl Soyate; Epoxidized PGDO; Methyl Epoxy Soyate; Butyl Epoxy Soyate; Epoxidized Octyl Soyate; Methyl Epoxy Linseedate; Butyl Epoxy Linseedate; and Octyl Epoxy Linseedate. These and similar materials are available commercially from Arkema Inc. under the trade name Vikoflex®. Examples of such commerically available Vikoflex® materials include Vikoflex 7170 Epoxidized Soybean Oil, Vikoflex 7190 Epoxidized Linseed, Vikoflex 4050 Epoxidized Octyl Soyate, Vikoflex 5075 Epoxidized PGDO, Vikoflex 7010 Methyl Epoxy Soyate, Vikoflex 7040 Butyl Epoxy Soyate, Vikoflex 7080 Epoxidized Octyl Soyate, Vikoflex 9010 Methyl Epoxy Linseedate, Vikoflex 9040 Butyl Epoxy Linseedate, and Vikoflex 9080 Octyl Epoxy Linseedate. In certain embodiments, provided polycarbonates derived from epoxidized resins or oils are heteropolymers incorporating other simpler epoxide monomers including, but not limited to: ethylene oxide, propylene oxide, butylene oxide, hexene oxide, cyclopentene oxide and cyclohexene oxide. These heteropolymers can include random co-polymers, tapered copolymers and block copolymers.

In certain embodiments of the present invention, monomers include epoxides derived from alpha olefins. Examples of such epoxides include, but are not limited to those derived from C₁₀ alpha olefin, C₁₂ alpha olefin, C₁₄ alpha olefin, C₁₆ alpha olefin, C₁₈ alpha olefin, C₂₀-C₂₄ alpha olefin, C₂₄-C₂₈ alpha olefin and C₃₀₊ alpha olefins. These and similar materials are commercially available from Arkema Inc. under the trade name Vikolox®. Commerically available Vikolox® materials include those depicted in Table 4, below. In certain embodiments, provided polycarbonates derived from alpha olefins are heteropolymers incorporating other simpler epoxide monomers including, but not limited to: ethylene oxide, propylene oxide, butylene oxide, hexene oxide, cyclopentene oxide and cyclohexene oxide. These heteropolymers can include random co-polymers, tapered copolymers and block copolymers.

Methods for the epoxidation of terpenes are known in the art. For instance, selective epoxidation of monoterpenes may be carried out with H₂O₂ and polymer-supported methylrheniumtrioxide systems (Tetrahedron, 2003, 59, 7403-7408; Boehlow, et al., Tetrahedron Lett., 1996, 37, 2717-2720; Villa de P., et al., Tetrahedron Lett., 1998, 39, 8521-8524). Other methods include alumina catalyzed epoxidation with hydrogen peroxide (Journal of Molecular Catalysis, 2006, 252, 186-193), heterogeneous tungsten catalysts and tungsten-catalyzed synthesis of acid-sensitive terpene epoxides (J. Org. Chem., 64, 7267-7270). Other methods include those described by Nakamura, M. et al., Tetrahedron Lett., 1984, 25, 32231-3232; Fringuelli, F., et al., Synlett, 1991, 7, 475-476).

In certain embodiments, provided polyesters are heteropolymers incorporating two or more of the above-described epoxide monomers (e.g. terpene oxides, epoxides derived from resins or oils, and epoxides derived from alpha olefins). Such heteropolymers optionally include other simpler epoxide monomers including, but not limited to: ethylene oxide, propylene oxide, butylene oxide, hexene oxide, cyclopentene oxide and cyclohexene oxide. These heteropolymers can include random co-polymers, tapered copolymers and block copolymers.

The term “incorporation” or “incorporating” as used above can refer to use of the monomer as the only comonomer with carbon dioxide, and/or use of the monomer as one constituent in the composition of a heteropolymer containing carbon dioxide and two or more epoxide monomers.

### Metal Complexes

In certain embodiments, polymers of the present invention are provided using metal complexes of formula IX:

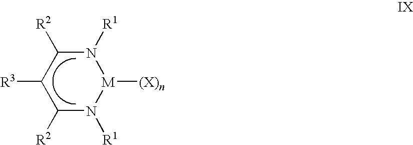

wherein:

M is a metal atom;

X is a nucleophilic ligand;

n is an integer from 0-2 inclusive.
each instance of R¹ is independently an optionally substituted group selected from the group consisting of aliphatic, heteroaliphatic, aryl, and heteroaryl; wherein the atom of R¹ attached to the diimidate nitrogen is carbon;
   each instance of R² and R³ is independently hydrogen, halogen, OR^{∘}, SR^{∘}, N(R^{∘})₂ a suitable electron withdrawing group, an optionally substituted group selected from aliphatic, heteroaliphatic, aryl, and heteroaryl; or R² and R³ are joined with their intervening atoms to form an optionally substituted ring selected from the group consisting of 3-12-membered carbocyclic; 3-12 membered heterocyclyl having 1-3 heteroatoms independently selected from nitrogen, oxygen, or sulfur; 6-10 membered aryl; and 5-10 membered heteroaryl having 1-4 heteroatoms independently selected from nitrogen, oxygen, or sulfur; or R¹ and R² are joined with their intervening atoms to form an optionally substituted ring selected from the group consisting of 3-12-membered carbocyclic; 3-12 membered heterocyclyl having 1-3 heteroatoms independently selected from nitrogen, oxygen, or sulfur; 6-10 membered aryl; and 5-10 membered heteroaryl having 1-4 heteroatoms independently selected from nitrogen, oxygen, or sulfur.

In certain embodiments, M is a main group metal. In certain embodiments, M is a transition metal selected from the periodic table groups 5-12, inclusive, boron, or aluminum. In certain embodiments, M is a transition metal selected from the periodic table groups 4-11, inclusive. In certain embodiments, M is selected from the lanthanides. In certain embodiments, M is a transition metal selected from the periodic table groups 5-10, inclusive. In certain embodiments, M is a transition metal selected from the periodic table groups 7-9, inclusive. In some embodiments, M is selected from the group consisting of Cr, Mn, V, Fe, Co, Mo, W, Ru, Ti, Al, Zr, Hf, and Ni. In certain embodiments, M is Zn.

Methods of making and using certain metal complexes of are described in detail in U.S. Pat. No. 6,133,402; and Allen, Scott D., Alternating copolymerization of epoxides and carbon dioxide with electron deficient zinc complexes: Structural analysis, isolation of copolymerization intermediates and the synthesis of polycarbonates with controlled architectures (Cornell, 2004); the entire contents of each of which is hereby incorporated by reference.

As described above for compounds of formula IX, X is a nucleophilic ligand. Exemplary nucleophilic ligands include, but are not limited to, —OR^{x}, —SR^{x}, —O(C═O)R^{x}, —O(C═O)OR^{x}, —O(C═O)N(R^{x})₂, —N(R^{x})(C═O)R^{x}, —NC, —CN, halo, —N₃, —O(SO₂)R^{x} and —OPR^{x}₃, wherein each R^{x} is, independently, selected from hydrogen, optionally substituted aliphatic, optionally substituted heteroaliphatic, optionally substituted aryl and optionally substituted heteroaryl.

In certain embodiments, X is —O(C═O)R^{x}, wherein R^{x} is selected from optionally substituted aliphatic, fluorinated aliphatic, optionally substituted heteroaliphatic, optionally substituted aryl, fluorinated aryl, and optionally substituted heteroaryl.

For example, in certain embodiments, X is —O(C═O)R^{x}, wherein R^{x} is optionally substituted aliphatic. In certain embodiments, X′ is —O(C═O)R^{x}, wherein R^{x} is optionally substituted alkyl and fluoroalkyl. In certain embodiments, X′ is —O(C═O)CH₃ or —O(C═O)CF₃.

Furthermore, in certain embodiments, X is —O(C))R^{x}, wherein R^{x} is optionally substituted aryl, fluoroaryl, or heteroaryl. In certain embodiments, X is —O(C═O)R^{x}, wherein R^{x} is optionally substituted aryl. In certain embodiments, X is —O(C═O)R^{x}, wherein R^{x} is optionally substituted phenyl. In certain embodiments, X is —O(C═O)C₆H₅ or —O(C═O)C₆F₅.

In certain embodiments, X is —OR^{x}, wherein R^{x} is selected from optionally substituted aliphatic, optionally substituted heteroaliphatic, optionally substituted aryl, and optionally substituted heteroaryl.

For example, in certain embodiments, X is —OR^{x}, wherein R^{x} is optionally substituted aryl. In certain embodiments, X is —OR^{x}, wherein R^{x} is optionally substituted phenyl. In certain embodiments, X is —OC₆H₅ or —OC₆H₃(2,4—NO₂).

In certain embodiments, X is halo. In certain embodiments, X is —Br. In certain embodiments, X is —Cl. In certain embodiments, X is —I.

In certain embodiments, X is —O(SO₂)R^{x}. In certain embodiments X is —OTs. In certain embodiments X is —OSO₂Me. In certain embodiments X is —OSO₂CF₃.

In certain embodiments, X is —N₃.

In certain embodiments, X is —NC

In certain embodiments, X is —CN.

In certain embodiments, R¹ is optionally substituted aliphatic, optionally substituted heteroaliphatic, optionally substituted aryl, or optionally substituted heteroaryl. In certain embodiments, each instance of R¹ is optionally substituted aliphatic. In certain embodiments, each instance of R¹ is optionally substituted heteroaliphatic. In certain embodiments, each instance of R¹ is optionally substituted aryl. In certain embodiments, each instance of R¹ is optionally substituted heteroaryl.

In certain embodiments, each instance of R² is hydrogen, halogen, optionally substituted aliphatic, optionally substituted heteroaliphatic, optionally substituted aryl, or optionally substituted heteroaryl. In certain embodiments, each instance of R² is hydrogen. In certain embodiments, each instance of R² is halogen. In certain embodiments, each instance of R² is optionally substituted aliphatic. In certain embodiments, each instance of R² is optionally substituted heteroaliphatic. In certain embodiments, each instance of R² is optionally substituted aryl. In certain embodiments, each instance of R² is optionally substituted heteroaryl.

In certain embodiments, R³ is hydrogen, halogen, optionally substituted aliphatic, optionally substituted heteroaliphatic, optionally substituted aryl, or optionally substituted heteroaryl. In certain embodiments, R³ is hydrogen. In certain embodiments, R³ is halogen. In certain embodiments, R³ is optionally substituted aliphatic. In certain embodiments, R³ is optionally substituted heteroaliphatic. In certain embodiments, R³ is optionally substituted aryl. In certain embodiments, R³ is optionally substituted heteroaryl.

In certain embodiments, R² and R³ are joined with their intervening atoms to form an optionally substituted ring selected from the group consisting of 3-12-membered carbocyclic; 3-12 membered heterocyclyl having 1-3 heteroatoms independently selected from nitrogen, oxygen, or sulfur; 6-10 membered aryl; and 5-10 membered heteroaryl having 1-4 heteroatoms independently selected from nitrogen, oxygen, or sulfur. In some embodiments, R² and R³ are joined with their intervening atoms to form an optionally substituted 3-12-membered carbocyclic ring. In some embodiments, R² and R³ are joined with their intervening atoms to form an optionally substituted 3-12 membered heterocyclyl ring having 1-3 heteroatoms independently selected from nitrogen, oxygen, or sulfur. In some embodiments, R² and R³ are joined with their intervening atoms to form an optionally substituted 6-10 membered aryl ring. In some embodiments, R² and R³ are joined with their intervening atoms to form an optionally substituted 5-10 membered heteroaryl ring having 1-4 heteroatoms independently selected from nitrogen, oxygen, or sulfur.

In some embodiments, one R² group is joined with R³ to form an optionally substituted ring selected from the group consisting of 3-12-membered carbocyclic; 3-12 membered heterocyclyl having 1-3 heteroatoms independently selected from nitrogen, oxygen, or sulfur, 6-10 membered aryl; and 5-10 membered heteroaryl having 1-4 heteroatoms independently selected from nitrogen, oxygen, or sulfur.

In certain embodiments, R¹ and R² are joined with their intervening atoms to form an optionally substituted ring selected from the group consisting of 3-12-membered carbocyclic; 3-12 membered heterocyclyl having 1-3 heteroatoms independently selected from nitrogen, oxygen, or sulfur; 6-10 membered aryl; and 5-10 membered heteroaryl having 1-4 heteroatoms independently selected from nitrogen, oxygen, or sulfur. In some embodiments, R¹ and R² are joined with their intervening atoms to form an optionally substituted 3-12-membered carbocyclic ring. In some embodiments, R¹ and R² are joined with their intervening atoms to form an optionally substituted 3-12 membered heterocyclyl ring having 1-3 heteroatoms independently selected from nitrogen, oxygen, or sulfur. In some embodiments, R¹ and R² are joined with their intervening atoms to form an optionally substituted 6-10 membered aryl ring. In some embodiments, R¹ and R² are joined with their intervening atoms to form an optionally substituted 5-10 membered heteroaryl ring having 1-4 heteroatoms independently selected from nitrogen, oxygen, or sulfur.

In some embodiments, one R¹ group is joined with R² to form an optionally substituted ring selected from the group consisting of 3-12-membered carbocyclic; 3-12 membered heterocyclyl having 1-3 heteroatoms independently selected from nitrogen, oxygen, or sulfur; 6-10 membered aryl; and 5-10 membered heteroaryl having 1-4 heteroatoms independently selected from nitrogen, oxygen, or sulfur.

In certain embodiments, each instance of R² and R³ is hydrogen. In certain embodiments, each instance of R² is hydrogen.

In some embodiments, each instance of R² is independently hydrogen or optionally substituted aliphatic. In some embodiments, each instance of R² is independently hydrogen or optionally substituted C₁₋₆ aliphatic. In some embodiments, each instance of R² is independently hydrogen or optionally substituted C₁₋₃ aliphatic. In some embodiments, each instance of R² is independently hydrogen or methyl. In some embodiments, each instance of R² is independently hydrogen or trifluoromethyl.

In some embodiments, R³ is independently hydrogen or optionally substituted aliphatic.

In certain embodiments, wherein R¹ is an optionally substituted aryl ring:

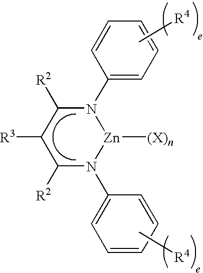

wherein X, R², and R³ are as defined above and herein;
each instance of R⁴ is, independently, selected from hydrogen, halogen, —OR^{g}, —OC(═O)R^{g}, —OC(═O)OR^{g}, —OC(═O)N(R^{h})₂, —OSO₂R^{h}, —C(═O)OR^{g}, —C(═O)N(R^{h})₂, —CN, —CNO, —NCO, —N₃, —NO₂, —N(R^{h})₂, —N(R^{h})C(═O)OR^{g}, —C(R^{h})C(═O)R^{g}, —N(R^{h})SO₂R^{h}, —SO₂R^{h}, —SOR^{h}, —SO₂N(R^{h})₂, optionally substituted aliphatic, optionally substituted heteroaliphatic, optionally substituted aryl, optionally substituted heteroaryl, wherein each instance of R^{g} is, independently, optionally substituted aliphatic, optionally substituted heteroaliphatic, optionally substituted aryl, optionally substituted heteroaryl, and each instance of R^{h} is, independently, hydrogen, optionally substituted aliphatic, optionally substituted heteroaliphatic, optionally substituted aryl, optionally substituted heteroaryl; and/or two R⁴ groups adjacent to each other are joined to form an optionally substituted 5- to 6-membered ring; and
e is 0 to 5, inclusive.

In certain embodiments, e is 0 to 2. In certain embodiments, e is 0 to 1. In certain embodiments, e is 0. In certain embodiments, e is 1. In certain embodiments, e is 2.

In certain embodiments, each instance of R⁴ is, independently, selected from hydrogen, optionally substituted aliphatic, optionally substituted heteroaliphatic, optionally substituted aryl, and optionally substituted heteroaryl, and/or two R⁴ groups adjacent to each other are joined to form an optionally substituted 5- to 6-membered ring. In certain embodiments, each instance of R⁴ is, independently, selected from hydrogen or optionally substituted aliphatic. In certain embodiments, each instance of R¹¹ is, independently, selected from hydrogen or optionally substituted heteroaliphatic. In certain embodiments, each instance of R⁴ is, independently, selected from hydrogen or optionally substituted aryl. In certain embodiments, each instance of R⁴ is, independently, selected from hydrogen or optionally substituted heteroaryl.

In certain embodiments, each instance of R⁴ is hydrogen.

In certain embodiments, each instance of R⁴ is independently selected from hydrogen, optionally substituted aliphatic, or optionally substituted heteroaliphatic. In some embodiments, each instance of R⁴ is independently selected from hydrogen or optionally substituted aliphatic. In some embodiments, each instance of R⁴ is independently selected from hydrogen or optionally substituted C₁₋₆ aliphatic. In some embodiments, each instance of R⁴ is independently selected from hydrogen or optionally substituted C₁₋₃ aliphatic. In some embodiments, each instance of R⁴ is independently selected from hydrogen or ethyl. In some embodiments, each instance of R⁴ is independently selected from hydrogen or propyl.

In certain embodiments, R¹, R², R³, R⁴ are independently a C₁₋₁₂ aliphatic group substituted with one or more organic cations, wherein each cation is complexed with an X, as defined herein. It will be appreciated that any X of an [organic cation][X] substituent is separate and in addition to any X moieties complexed with M. In some embodiments, the organic cation is a quaternary ammonium. In some embodiments, an organic cation substituent of a C₁₋₁₂ aliphatic group is selected from

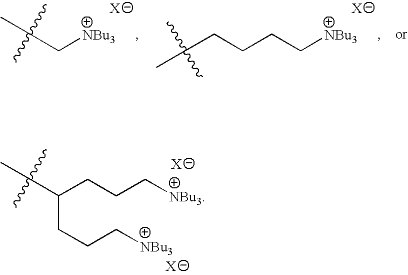

In certain embodiments, X is 2,4-dinitrophenolate anion.

In some embodiments, the metal complex is:

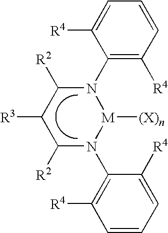

wherein M, X, n, R², R³, and R⁴ are as described above.

In certain embodiments, the metal complex is:

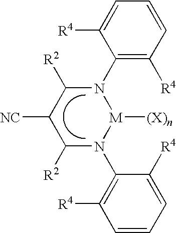

wherein M, X, n, R², and R⁴ are as described above.

In some embodiments, the metal complex is:

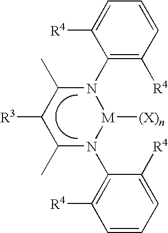

wherein M, X, n, R³, and R⁴ are as described above.

In some embodiments, the metal complex is:

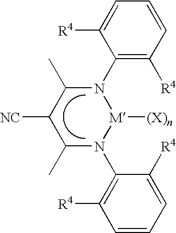

wherein M, X, n, and R⁴ are as described above.

In some embodiments, the metal complex is:

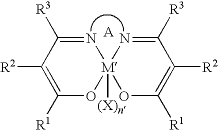

wherein:

M′ is a metal atom;

X is absent or is a nucleophilic ligand;

n′ is an integer from 0-2, inclusive

each instance of R¹, R², and R³ is, independently, hydrogen, halogen, OR^{∘}, SR^{∘}, N(R^{∘})₂ a suitable electron withdrawing group, an optionally substituted group selected from aliphatic, heteroaliphatic, aryl, and heteroaryl; or R² and R³ are joined with their intervening atoms to form an optionally substituted ring selected from the group consisting of 3-12-membered carbocyclic; 3-12 membered heterocyclyl having 1-3 heteroatoms independently selected from nitrogen, oxygen, or sulfur, 6-10 membered aryl; and 5-10 membered heteroaryl having 1-4 heteroatoms independently selected from nitrogen, oxygen, or Sulfur, or R¹ and R², or R² and R³, are joined to form an optionally substituted aryl or optionally substituted heteroaryl ring; and

Ring A forms an optionally substituted 5- to 6-membered ring.

In certain embodiments, the metal complex is not tetraphenylporphyrin aluminum chloride. In some embodiments, the epoxide is not propylene oxide. In some embodiments, the anhydride is not phthalic anhydride.

In certain embodiments the metal complex is:

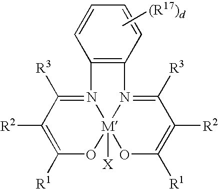

wherein each instance of R¹⁷ is, independently, selected from hydrogen, halogen, —OR^{c}, —OC(═O)R^{c}, —OC(═O)OR^{c}, —OC(═O)N(R^{d})₂, —C(═O)OR^{c}, —C(═O)N(R^{d})₂, —CN, —CNO, —NCO, —N₃, —NO₂, —N(R^{d})₂, —N(R^{d})C(═O)OR^{c}, —N(R^{d})SO₂R^{d}, —SO₂R^{d}, —SOR^{d}, —SO₂N(R^{d})₂, optionally substituted aliphatic, optionally substituted heteroaliphatic, optionally substituted aryl, optionally substituted heteroaryl, wherein each instance of R^{c} is, independently, optionally substituted aliphatic, optionally substituted heteroaliphatic, optionally substituted aryl, optionally substituted heteroaryl, and each instance of R^{d} is, independently, hydrogen, optionally substituted aliphatic, optionally substituted heteroaliphatic, optionally substituted aryl, optionally substituted heteroaryl; and/or two R′⁷ groups adjacent to each other are joined to form an optionally substituted 5- to 6-membered ring.

In certain embodiments, R¹, R², R³, and R¹⁷ are independently a C₁₋₁₂ aliphatic group substituted with one or more organic cations, wherein each cation is complexed with an X, as defined herein. It will be appreciated that any X of an [organic cation][X] substituent is separate and in addition to any X moieties complexed with M. In some embodiments, the organic cation is a quaternary ammonium. In some embodiments, an organic cation substituent of a C₁₋₁₂ aliphatic group is selected from

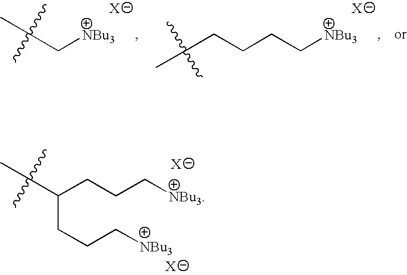

In certain embodiments, X is 2,4-dinitrophenolate anion.

In some embodiments, the metal complex is selected from:

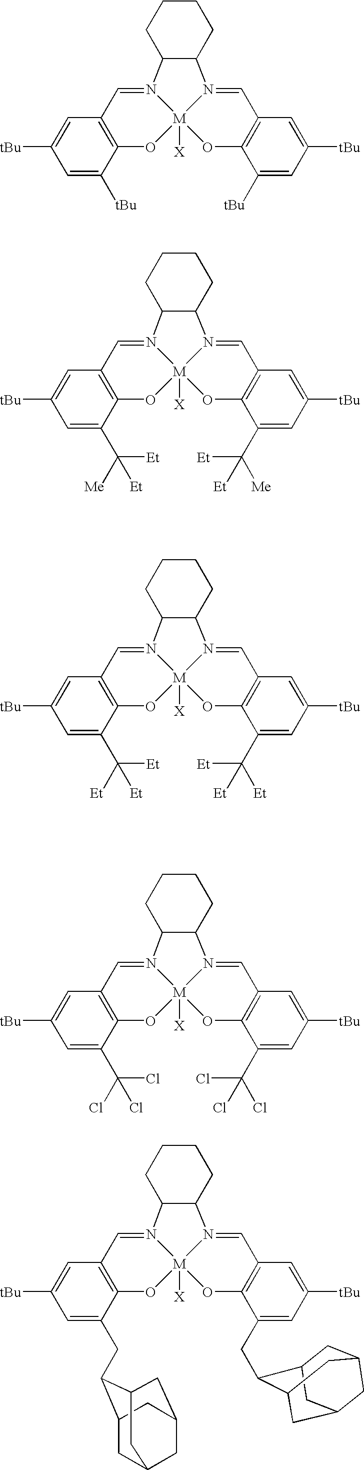

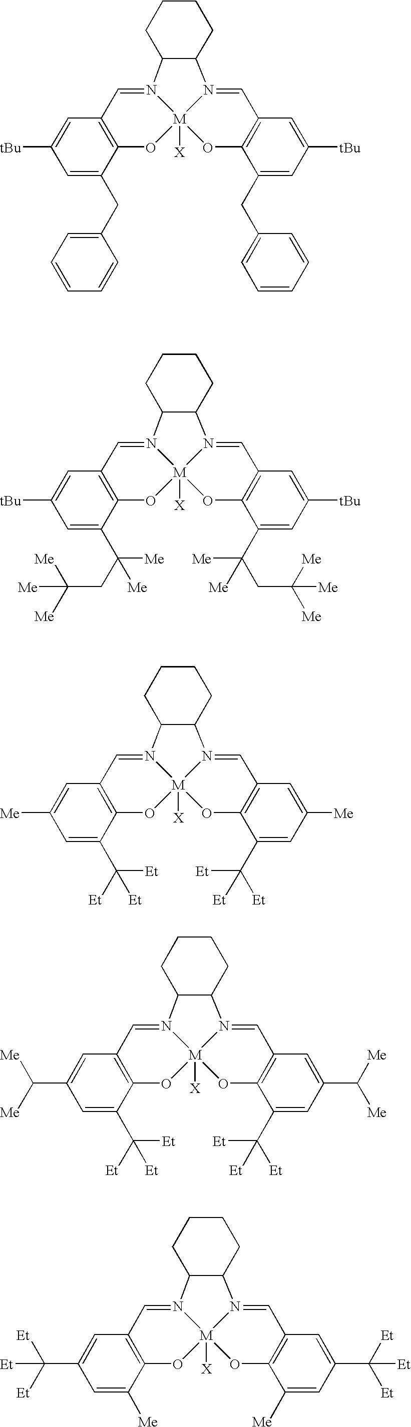

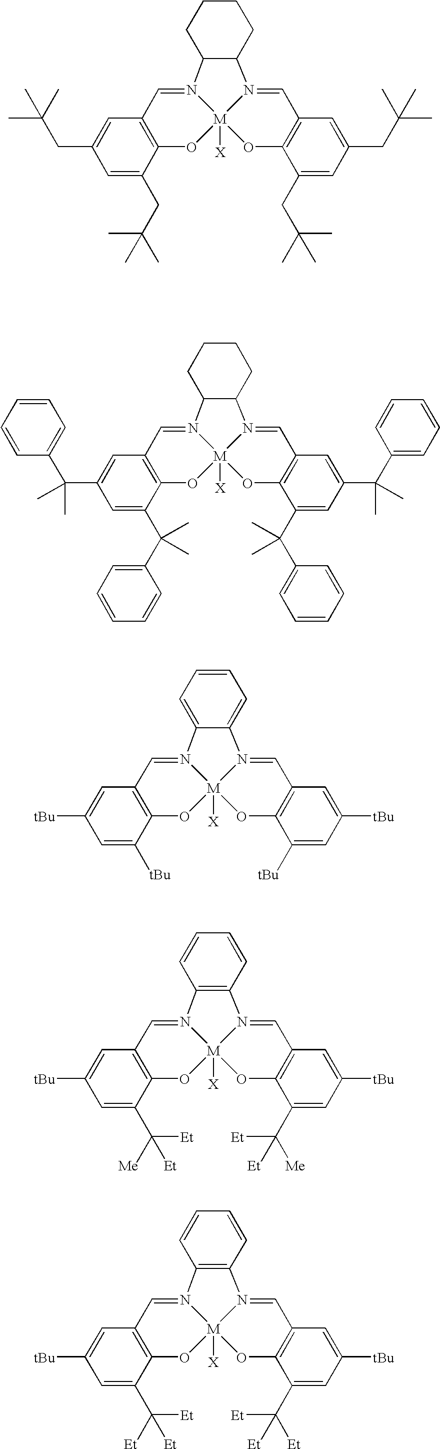

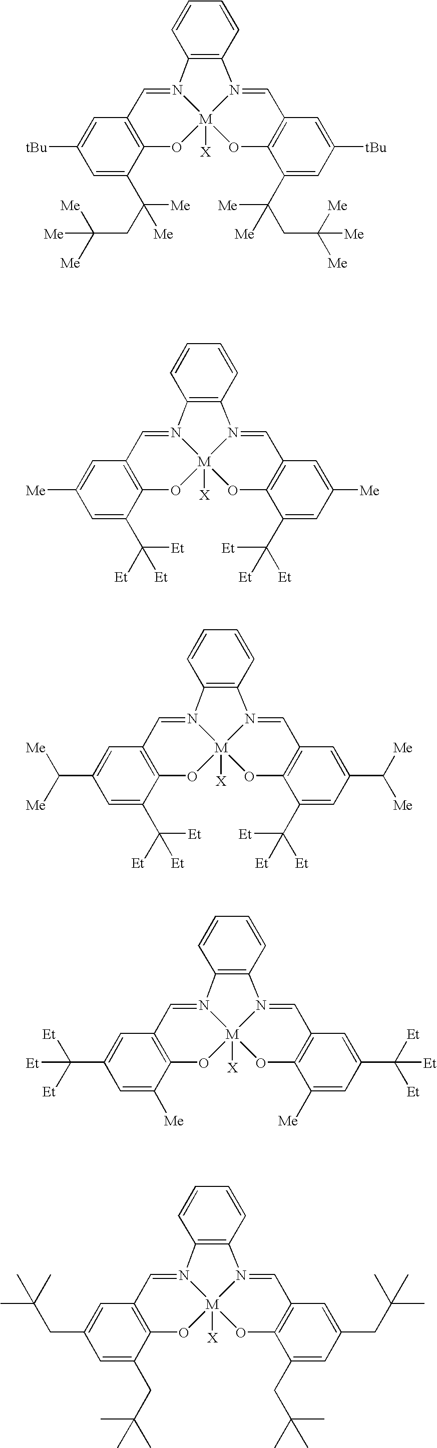

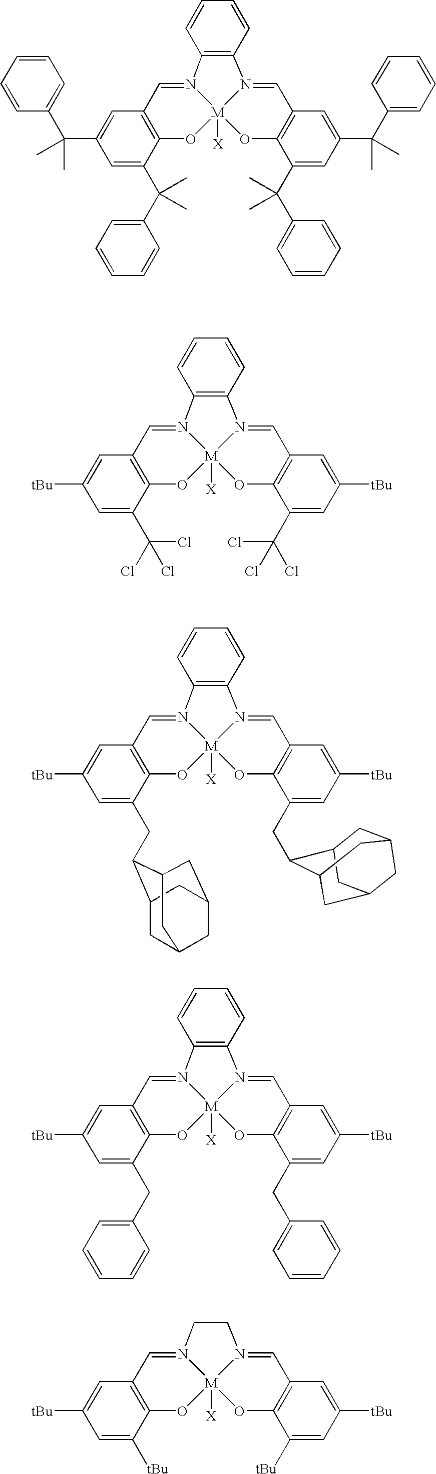

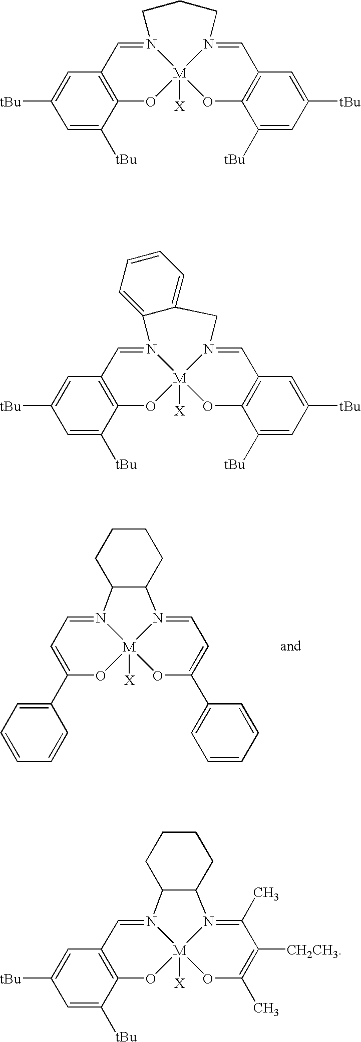

In certain embodiments, metal complexes used include:

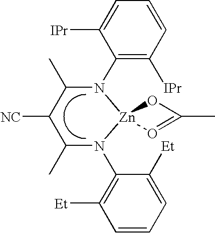

The present invention also provides methods of making various polyester polymers. As used herein, polyester polymers are provided via polymerization of an epoxide and cyclic anhydride in the presence of a metal complex, and encompass polyesters, as well as polymers which comprise polyesters, such as, for example, poly(epoxide)-co-poly(anhydride).

In certain embodiments, the present invention provides a method of synthesizing an polyester polymer, the method comprising the step of reacting an epoxide with an cyclic anhydride in the presence of a zinc complex of any of the above described metal complexes wherein M is zinc.

In certain embodiments, the present invention provides a method of synthesizing an polyester polymer, the method comprising the step of reacting an epoxide with an cyclic anhydride in the presence of a cobalt complex of any of the above described metal complexes, wherein M is cobalt.

In certain embodiments, the present invention provides methods of synthesizing polyester polymers, these methods comprising the step of reacting epoxides with cyclic anhydrides in the presence of a zinc complex of any of the above described metal complexes or alternatively in the presence of a cobalt complex of any of the above described metal complexes. In certain embodiments, polyester polymers comprising cyclic or polycylic epoxide monomers are provided using a metal complex. In certain embodiments, polyester polymers comprising cyclic or polycylic epoxide monomers are provided using a metal complex as described above. In certain embodiments, polyester terpolymers comprising two epoxide monomers and an cyclic anhydride are provided using a metal complex as described above. In certain embodiments, polyester terpolymers comprising two epoxide monomers and a cyclic anhydride are provided using a metal complex as described above. In certain embodiments, polyester polymers comprising three or more epoxide monomers and cyclic anhydride are provided using a metal complex as described above. In certain embodiments, polyester polymers comprising three or more epoxide monomers and cyclic anhydride are provided using a metal complex as described above. While not wishing to be bound by any particular theory, it is believed that the size of the R groups can be modified to afford polyesters comprising cyclic and polycyclic monomers with desirable properties (vide infra).

In some embodiments, polyester polymers comprising cyclic or polycylic epoxide monomers are provided using a metal complex as provided herein. In some embodiments, polyester polymers comprising cyclic or polycylic epoxide monomers are provided using a metal complex as described above. In certain embodiments, polyester terpolymers comprising two epoxide monomers and cyclic anhydrides are provided using a metal complex as described above. In certain embodiments, polyester terpolymers comprising two epoxide monomers and cyclic anhydrides are provided using a metal complex as described above. In certain embodiments, polyester polymers comprising three or more epoxide monomers and cyclic anhydride are provided using a metal complex of as described above. In certain embodiments, polyester polymers comprising three or more epoxide monomers and cyclic anhydride are provided using a metal complex as described above. While not wishing to be bound by any particular theory, it is believed that the size of the R groups can be modified to afford polyesters comprising cyclic and polycyclic monomers with desirable properties (vide infra).
In certain embodiments, the present invention provides s method of polymerization, the method comprising:
a) providing an epoxide of formula VI:

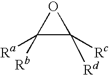

wherein:
R^{a}, R^{b}, R^{c} and R^{d} are each independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
b) providing a cyclic anhydride of formula VII:

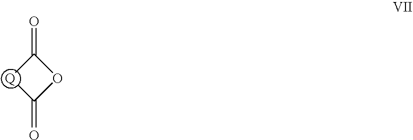

wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S— —SO—, —C(═S)—, —C(═NR^{y})—, —C(═NOR^{y})— or —N═N—;
   each occurrence of R^{y} is independently hydrogen or an optionally substituted C₁₋₆ aliphatic group;
c) admixing the epoxide and cyclic anhydride under suitable conditions for polymerization in the presence of a metal complex of formula VIII:

Lₙ-M-(X)ₙ VIII

wherein:

M is a metal atom;

Lₙ is a suitable permanent ligand set comprised of one or more ligands;

X is a nucleophilic ligand; and

n is an integer between 1-5, inclusive; to provide a polymer composition of formula I:

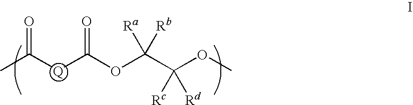

wherein:
wherein the PDI of the composition is less than 2.
In some embodiments, the present invention provides a method of polymerization, the method comprising:
a) providing at least a first epoxide of formula VI:

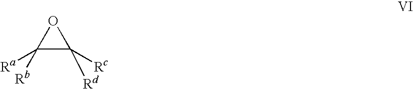

wherein:
R^{a}, R^{b}, R^{c}, and R^{d} are each independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
b) providing at least a first cyclic anhydride of formula VII:

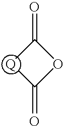

### VII

wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur, and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —C(═S)—, —C(═NR^{y})—, —C(═NOR^{y})— or —N═N—; each occurrence of R^{y} is independently hydrogen or an optionally substituted C₁₋₆ aliphatic group;
c) admixing a first epoxide and a first cyclic anhydride, under suitable conditions for polymerization in the presence of a metal complex of formula VIII:

Lₙ-M-(X)ₙ VIII

wherein:

M is a metal atom;

Lₙ is a suitable permanent ligand set comprised of one or more ligands;

X is a nucleophilic ligand; and

n is an integer between 1-5, inclusive; and
d) after substantially complete incorporation of a first epoxide or a first cyclic anhydride to the polymer, admixing at least one selected from:

i) a second epoxide of formula VI, or

ii) a second cyclic anhydride of formula VII;

to provide a polymer of formula II:

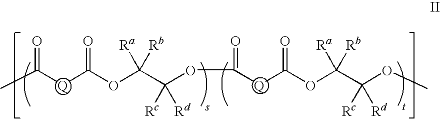

wherein:
s is an integer from 1 to 100,000;
t is an integer from 1 to 100,000;
each occurrence of R^{a}, R^{b}, R^{c}, and R^{d} is independently a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or and
each occurrence of R^{y} is independently hydrogen or an optionally substituted C₁₋₆ aliphatic group;
wherein at least one [t] bracketed structure is different from an [s] bracketed structure.

In some embodiments, the above method further comprises the step of:
a) after substantially complete incorporation of at least a second epoxide to the polymer, admixing at least a third epoxide selected from the group consisting of epoxides of formula VI, and combinations thereof, with a least at first anhydride to provide a polymer of formula II. In some embodiments, the admixing of at least a third and any additional epoxide is performed in stepwise fashion.
   In some embodiments, the above method further comprising the step of:
   a) after substantially complete incorporation of at least a second cyclic anhyride to the polymer, admixing at least a third cyclic anhydride selected from the group consisting of cyclic anhydride of formula VII, and combinations thereof with a least at first epoxide to provide a polymer of formula II. In some embodiments, the admixing of at least a third and any additional cyclic anhydrides is performed in stepwise fashion.

In some embodiments, A method of polymerization, the method comprising:
a) providing at least a first epoxide of formula VI:

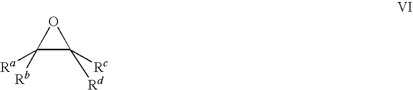

wherein:
R^{a}, R^{b}, R^{c}, and R^{d} are each independently a C₁₋₃₀ carbon containing moiety; wherein any of (12, and)R^{∘}, or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
b) providing at least a first cyclic anhydride of formula VII:

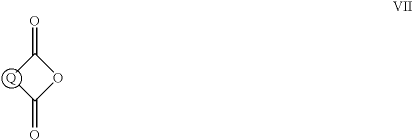

wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
   each occurrence of R^{y} is independently hydrogen or an optionally substituted C₁₋₆ aliphatic group;
c) admixing at least a first epoxide and at least first cyclic anhydride, under suitable conditions for polymerization in the presence of a metal complex of formula VIII:

Lₙ-M-(X)ₙ VIII

wherein:

M is a metal atom;

Lₙ is a suitable permanent ligand set comprised of one or more ligands;

X is a nucleophilic ligand; and

n is an integer between 1-5, inclusive;

to provide a random co-polymer of formula III:

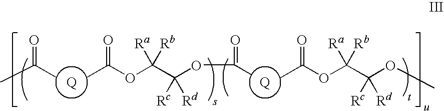

wherein:
s is an integer from 1 to 100,000;
t is an integer from 1 to 100,000;
each occurrence of R^{a}, R^{b}, R^{c}, and R^{d} is hydrogen or independently a C₁₋₃₀ carbon containing moiety; wherein any of (R^{a} and R^{b}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —OC(O)—, —C(O)O—, —S—, —SO—, —SO₂—, —C(═NR^{Y})—, —C(═NOR^{y})— or —N═N—; and
each occurrence of R^{y} is independently hydrogen or an optionally substituted C₁₋₆ aliphatic group;
wherein at least one [t] bracketed structure is different from the [s] bracketed structure.

In certain embodiments of the above method, step (c) further comprises admixing at least a second epoxide of formula VI, and combinations thereof, with at least a first cyclic anhydride of formula VII, to provide a random co-polymer of formula III. In some embodiments, the step (c) further comprises admixing at least a second cyclic anhydride of formula VII, and combinations thereof, with at least a first epoxide anhydride of formula VI to provide a random co-polymer of formula III.

In some embodiments, the invention provides a method of polymerization, the method comprising:
a) providing at least a first epoxide of formula VI:

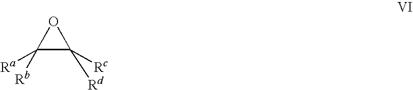

wherein:
R^{a}, R^{b}, R^{c}, and R^{d} are each independently a C₁₋₃₀ carbon containing moiety; wherein any of (R^{a} and R^{c}), or (R^{a} and R^{b}) can be taken together with their intervening atoms to form one or more rings selected from the group consisting of optionally substituted C₃-C₁₄ carbocycle, optionally substituted C₃-C₁₄ heterocycle, optionally substituted C₆-C₃₀ aryl, and optionally substituted C₅-C₁₀ heteroaryl;
b) providing at least a first cyclic anhydride of formula VII:

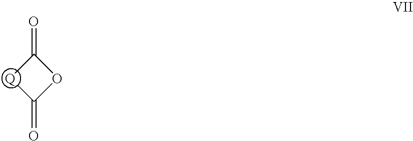

wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—; —C(═NOR^{y})— or —N═N—;
   each occurrence of R^{y} is independently hydrogen or an optionally substituted C₁₋₆ aliphatic group;
c) admixing a first epoxide, a first cyclic anhydride, and CO₂ under suitable conditions for polymerization in the presence of a metal complex of formula VIII:

Lₙ-M-(X)ₙ VIII

wherein:

M is a metal atom;

Lₙ is a suitable permanent ligand set comprised of one or more ligands;

X is a nucleophilic ligand; and

n is an integer between 1-5, inclusive;

to provide a block copolymer of formula IV:

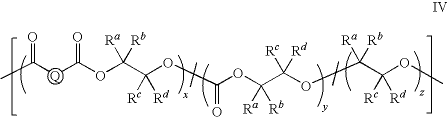

wherein:
x is an integer from 1 to 100,000;
y is an integer from 1 to 100,000;
z is an integer from 0 to 5000;
each occurrence of R^{a}, R^{b}, R^{c}, and R^{d} is independently a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group.

In some embodiments, the invention provides a method of polymerization, the method comprising:
a) providing at least a first epoxide of formula VI:

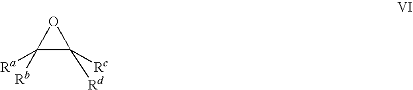

wherein:
R^{a}, R^{b}, R^{c}, and R^{d} are each independently a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
b) providing at least a first cyclic anhydride of formula VII:

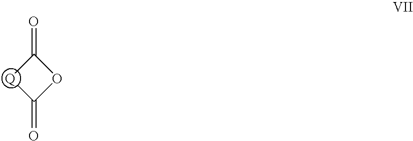

wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
   each occurrence of R^{y} is independently hydrogen or an optionally substituted C₁₋₆ aliphatic group;
c) admixing at least a first epoxide, at least first cyclic anhydride, and CO₂ under suitable conditions for polymerization in the presence of a metal complex of formula VIII:

Lₙ-M-(X)ₙ VIII

wherein:

M is a metal atom;

Lₙ is a suitable permanent ligand set comprised of one or more ligands;

X is a nucleophilic ligand; and

n is an integer between 1-5, inclusive;

to provide a random co-polymer of formula V:

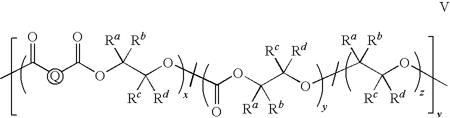

wherein:
x is an integer from 1 to 100,000;
y is an integer from 1 to 100,000;
z is an integer from 0 to 5000;
each occurrence of R^{a}, R^{b}, R^{c}, and R^{d} is independently a C₁₋₃₀ carbon containing moiety; wherein any of (R^{a} and R^{c}), or (R^{a} and R^{b}) can be taken together with their intervening atoms: to form one or more rings selected from the group consisting of optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═NR^{y})—, —C(═NOR^{y})— or —N═N—; and
   each occurrence of R^{y} is independently hydrogen or an optionally substituted C₁₋₆ aliphatic group.

In certain embodiments, the polymer is an alternating polymer of epoxide and cyclic anhydride (e.g., with regular alternating units an epoxide and anhydride).

In certain embodiments, the metal complex is a zinc, cobalt, chromium, aluminum, titanium, ruthenium or manganese complex. In certain embodiments, the metal complex is an aluminum complex. In certain embodiments, the metal complex is a chromium complex. In certain embodiments, the complex metal is zinc complex. In certain embodiments, the metal complex is a titanium complex. In certain embodiments, the metal complex is a ruthenium complex. In certain embodiments, the metal complex is a manganese complex. In certain embodiments, the metal complex is cobalt complex. In certain embodiments, wherein the metal complex is a cobalt complex, the cobalt metal has a valency of +3 (i.e., Co(III)).

In certain embodiments, the present invention encompasses polyesters incorporating monomers having cyclic or polycyclic motifs. Without wishing to be bound by any particular theory, it is believed that these cyclic and polycyclic ring systems help to rigidify to the polymer chains which can translate into higher definition and more desirable material properties, as described above.

In certain embodiments, polymers of the present invention have T_{g} values above 50° C. In some embodiments, the T_{g} value of the polymer is in the range of about 50 to about 120° C. In some embodiments, the T_{g} value of the polymer is in the range of about 50-70° C. In other embodiments, the T_{g} value of the polymer is above about 70° C. In certain embodiments, the T_{g} value of the polymer is between about 70° C. and about 120° C. In certain embodiments, the T_{g} value of the polymer is between about 80° C. and about 120° C. In certain embodiments, the T_{g} value of the polymer is between about 90° C. and about 120° C. In certain embodiments, the T_{g} value of the polymer is between about 100° C. and about 120° C.

In certain embodiments, polymers of the present invention have average molecular weight numbers (Mₙ) between about 50,000 and about 300,000 g/mol. In some embodiments, the Mₙ of the polymer is in the range of about 75,000 to about 250,000 g/mol. In some embodiments, the Mₙ of the polymer is in the range of about 75,000 to about 200,000 g/mol. In some embodiments, the Mₙ of the polymer is in the range of about 100,000 to about 200,000 g/mol. In some embodiments, the Mₙ of the polymer is in the range of about 100,000 to about 150,000 g/mol. In some embodiments, the Mₙ of the polymer is in the range of about 75,000 to about 150,000 g/mol.

In some embodiments, the polymer is a high molecular weight polymer (greater than 10000 amu). In some embodiments, the polymer is a low molecular weight polymer (less than 10000 amu). In some embodiments, the polymer is a very high molecular weight polymer (greater than 100000 amu).

In some embodiments of the present invention the polydispersity index (PDI) of the polymers is between 1 and about 2. In certain embodiments the PDI of the polymers is less than 1.5. In certain embodiments the PDI of the polymers is less than 1.4. In certain embodiments the PDI of the polymers is less than 1.3. In other embodiments of the present invention, the PDI of the polymers is less than 1.2. In certain embodiments the PDI of the polymers is less than 1.1.

In certain embodiments of the present invention, the polyester compositions decompose at temperatures below about 300° C. In some embodiments, the polymers decompose essentially completely at temperatures below 300° C. In other embodiments, the polymers decompose at temperatures below about 250° C. In certain embodiments of the present invention, the polymers decomposed essentially completely leaving minimal-residue. In certain embodiments, the polymers decompose to leave essentially no residue.

### Reaction Conditions

In certain embodiments, any of the above methods further comprise use of one or more co-catalysts.

In certain embodiments, a co-catalyst is a Lewis base. Exemplary Lewis bases include, but are not limited to: N-methylimidazole (N-MeIm), dimethylaminopyridine (DMAP), 1,4-diazabicyclo[2.2.2]octane (DABCO), triethyl amine, and diisopropyl ethyl amine.

In certain embodiments, a co-catalyst is a salt. In certain embodiments, a co-catalyst is an ammonium salt, a phosphonium salt or an arsonium salt. In certain embodiments, a co-catalyst is an ammonium salt. Exemplary ammonium salts include, but are not limited to: (n-Bu)₄NCl, (n-Bu)₄NBr, (n-Bu)₄NN₃, [PPN]Cl, [PPN]Br, and [PPN]N₃, Ph₃PCPh₃]Cl [PPN]O(C═O)R^{c} (PPN=Bis (triphenylphosphoranylidene)ammonium)). In certain embodiments, a co-catalyst is a phosphonium salt. In certain embodiments, the co-catalyst is an arsonium salt.

In certain embodiments, a co-catalyst is the ammonium salt bis(triphenylphosphoranylidene)ammonium chloride ([PPN]Cl).

In certain embodiments, the anion of a salt co-catalyst has the same structure as the ligand X of the above described metal complexes, wherein X is a nucleophilic ligand. For example, in certain embodiments, the co-catalyst is ([PPN]X) or (n-Bu)₄NX.

In certain embodiments, any of the above methods comprise a ratio of about 50:1 to about 500,000:1 of epoxide to metal complex. In certain embodiments, any of the above methods comprise a ratio of about 100:1 to about 100,000:1 of epoxide to metal complex. In certain embodiments, any of the above methods comprise a ratio of about 100:1 to about 50,000:1 of epoxide to metal complex. In certain embodiments, any of the above methods comprise a ratio of about 100:1 to about 5,000:1 of epoxide to metal complex. In certain embodiments, any of the above methods comprise a ratio of about 100:1 to about 1,000:1 of epoxide to metal complex.

In certain embodiments, any of the above methods comprise epoxide present in amounts between about 0.5 M to about 20 M. In certain embodiments, epoxide is present in amounts between about 0.5 M to about 2 M. In certain embodiments, epoxide is present in amounts between about 2 M to about 5 M. In certain embodiments, epoxide is present in amounts between about 5 M to about 20 M. In certain embodiments, epoxide is present in an amount of about 20 M. In certain embodiments, liquid epoxide comprises the reaction solvent.

In certain embodiments, any of the above methods comprise cyclic anhydride present in amounts between about 0.5 M to about 20 M. In certain embodiments, cyclic anhydride is present in amounts between about 0.5 M to about 2 M. In certain embodiments, cyclic anhydride is present in amounts between about 2 M to about 5 M. In certain embodiments, cyclic anhydride is present in amounts between about 5 M to about 20 M. In certain embodiments, cyclic anhydride is present in an amount of about 20 M. In certain embodiments, cyclic anhydride comprises the reaction solvent.

In certain embodiments, any of the above methods comprise the reaction to be conducted at a temperature of between about 0° C. to about 100° C. In certain embodiments, the reaction is conducted at a temperature of between about 23° C. to about 100° C. In certain embodiments, the reaction to be conducted at a temperature of between about 23° C. to about 80° C. In certain embodiments, the reaction to be conducted at a temperature of between about 23° C. to about 50° C. In certain embodiments, the reaction to be conducted at a temperature of about 23° C.

In certain embodiments, the reaction step of any of the above methods does not further comprise a solvent.

In certain embodiments, the reaction step of any of the above methods does further comprise one or more solvents. In certain embodiments, the solvent is an organic solvent. In certain embodiments, the solvent is a hydrocarbon. In certain embodiments, the solvent is an aromatic hydrocarbon. In certain embodiments, the solvent is an aliphatic hydrocarbon. In certain embodiments, the solvent is a halogenated hydrocarbon.

In certain embodiments, the solvent is an organic ether. In certain embodiments the solvent is a ketone.

In certain embodiments suitable solvents include, but are not limited to: methylene chloride, chloroform, 1,2-dichloroethane, propylene carbonate, acetonitrile, dimethylformamide, N-methyl-2-pyrrolidone, dimethyl sulfoxide, nitromethane, caprolactone, 1,4-dioxane, and 1,3-dioxane.

In certain other embodiments, suitable solvents include, but are not limited to: methyl acetate, ethyl acetate, acetone, methyl ethyl ketone, propylene oxide, tetrahydrofuran, monoglyme, triglyme, propionitrile, 1-nitropropane, cyclohexanone.

In certain embodiments, any of the above methods [using a zinc complex] comprise the reaction to be done in the presence of CO₂, In certain embodiments, CO² is present at a pressure of between about 30 psi to about 800 psi. In certain embodiments, CO₂ is present at a pressure of between about 30 psi to about 500 psi. In certain embodiments, CO₂ is present at a pressure of between about 30 psi to about 400 psi. In certain embodiments, CO₂ is present at a pressure of between about 30 psi to about 300 psi. In certain embodiments, CO₂ is present at a pressure of between about 30 psi to about 200 psi. In certain embodiments, CO₂ is present at a pressure of between about 30 psi to about 100 psi. In certain embodiments, CO₂ is present at a pressure of between about 30 psi to about 80 psi. In certain embodiments, CO₂ is present at a pressure of about 30 psi. In certain embodiments, CO₂ is present at a pressure of about 50 psi. In certain embodiments, CO₂ is present at a pressure of about 100 psi. In certain embodiments, the CO₂ is supercritical.

### Tapered and Block Co-Polymers

In certain embodiments, the polyester polymer is a tapered co-polymer of units j and k (e.g., wherein the incorporation of k increases or decreases along the length of a given polymer chain.):

In certain embodiments, a provided block-co-polymer comprises an polyester polymer and a polycarbonate polymer. Examples of such co-polymers include to name but a few.

Co-polymers comprising two or more different polyesters may be provided as tapered, block, and random co-polymers, as defined and described above and herein. The present invention contemplates said co-polymers comprising any of the epoxides described above and herein

Co-polymers comprising an polyester polymer and a polycarbonate polymer may be provided as tapered, block, and random co-polymers, as defined and described above and herein. The present invention contemplates said co-polymers comprising any of the epoxides described above and herein.

In certain embodiments, the present invention provides a method of making an polyester block co-polymer, comprising the steps of (i) providing a polyepoxide polymer, and (ii) reacting the polyepoxide polymer with an cyclic anhydride and carbon dioxide in the presence of a metal complex. In certain embodiments, the metal complex is a metal complex, or any subset thereof. [

In certain embodiments, the polyepoxide polymer of step (i) is provided by reacting an epoxide in the presence of a metal complex. In certain embodiments, the metal complex is a metal complex, or any subset thereof. In certain embodiments, the metal complex is a metal complex as described above, or any subset thereof.

In certain embodiments, block copolymer compositions may be produced by varying or removing the CO₂ pressure during part of the polymerization process. When the CO₂ pressure is low or non-existent, the catalyst will produce polymer having a higher degree of ether linkages than when the CO₂ pressure is high. Thus, in certain embodiments of the present invention the polymerization may be initiated with any of the metal complexes described above at a relatively high CO₂ pressure (for example, higher than 100 psi, higher than about 200 psi, or higher than about 400 psi). These conditions will produce polymer having a predominance of carbonate linkages. After a length of time, the CO₂ pressure is lowered (for example to less than 100 psi, less than 50 psi, or to atmospheric pressure) or is removed completely. These conditions result in new block with more ether bonds being incorporated into the growing polymer chains. The above described process can optionally be repeated one or more times to build diblock, triblock or multiblock polymers. Additionally, several different CO₂ pressure levels can be used in the process to produce polymers with several different block types. In certain embodiments, the CO₂ pressure is initially low and is then increased. In certain other embodiments the CO₂ pressure is varied periodically. In certain other embodiments, the CO₂ pressure is varied smoothly over time to form tapered polyester co polycarbonate polymer compositions or blocks with a tapered copolymeric structure.

The present invention also provides methods of making various polyester polymers. As used herein, polyester polymers are provided via polymerization of ethylene oxide (EO) and carbon dioxide (CO₂) in the presence of a metal complex, and encompass encompasses poly(ethylene carbonate) (PEC), as well as polymers which comprise poly(ethylene carbonate), such as, for example, polyethylene oxide-co-polyethylene carbonate.

For example, in one aspect, the present invention provide a method of synthesizing a poly(ethylene carbonate) polymer, wherein the polymer is made up of Y, and optionally Z, and wherein the percentage of Y is greater than the percentage of Z

In certain embodiments, the metal complex is a zinc, cobalt, chromium, aluminum, titanium, ruthenium or manganese complex. In certain embodiments, the metal complex is an aluminum complex. In certain embodiments, the metal complex is a chromium complex. In certain embodiments, the complex metal is zinc complex. In certain embodiments, the metal complex is a titanium complex. In certain embodiments, the metal complex is a ruthenium complex. In certain embodiments, the metal complex is a manganese complex. In certain embodiments, the metal complex is cobalt complex. In certain embodiments, wherein the metal complex is a cobalt complex, the cobalt metal has a valency of +3 (i.e., Co(III)).

In another aspect, the present invention provides a method of synthesizing a poly(ethylene carbonate) polymer, the method comprising the step of reacting ethylene oxide with carbon dioxide in the presence of a cobalt complex of any of the above described metal complexes or a subset thereof, wherein M is cobalt.

In certain embodiments, any of the above methods further comprise a co-catalyst.

In certain embodiments, the co-catalyst is a Lewis base. Exemplary Lewis bases include N-methylimidazole (N-MeIm), dimethylaminopyridine (DMAP), and 1,4-diazabicyclo[2.2.2]octane (DABCO)

In certain embodiments, the co-catalyst is a salt. In certain embodiments, the co-catalyst is an ammonium salt, a phosphonium salt or an arsonium salt. In certain embodiments, the co-catalyst is an ammonium salt. Exemplary ammonium salts (n-Bu)₄NCl, (n-Bu)₄NBr, (n-Bu)₄NN₃, [PPN]Cl, [PPN]Br, and [PPN]N₃ (PPN=bis(triphenylphosphine)ammonium). In certain embodiments, the co-catalyst is a phosphonium salt. Exemplary phosphonium salts include PCy₃. In certain embodiments, the co-catalyst is an arsonium salt In certain embodiments, the co-catalyst is the ammonium salt bis(triphenylphosphoranylidene)ammonium chloride ([PPN]Cl).

In certain embodiments, the anion of the salt co-catalyst has the same structure as the ligand X of the above described metal complexes, or subsets thereof, wherein X is a nucleophilic ligand. For example, in certain embodiments, wherein the co-catalyst is ([PPN]Cl) or (n-Bu)₄NCl, X is Cl.

In certain embodiments, any of the above methods comprise a ratio of about 500:1 to about 500,000:1 of ethylene oxide to metal complex. In certain embodiments, any of the above methods comprise a ratio of about 500:1 to about 100,000:1 of ethylene oxide to metal complex. In certain embodiments, any of the above methods comprise a ratio of about 500:1 to about 50,000:1 of ethylene oxide to metal complex. In certain embodiments, any of the above methods comprise a ratio of about 500:1 to about 5,000:1 of ethylene oxide to metal complex. In certain embodiments, any of the above methods comprise a ratio of about 500:1 to about 1,000:1 of ethylene oxide to metal complex.

In certain embodiments, any of the above methods comprise ethylene oxide present in amounts between about 10 M to about 30 M. In certain embodiments, ethylene oxide is present in amounts between about 15 M to about 30 M. In certain embodiments, ethylene oxide is present in an amount of about 20 M.

In certain embodiments, CO₂ is present at a pressure of between about 30 psi to about 800 psi. In certain embodiments, CO₂ is present at a pressure of between about 30 psi to about 500 psi. In certain embodiments, CO₂ is present at a pressure of between about 30 psi to about 400 psi. In certain embodiments, CO₂ is present at a pressure of between about 30 psi to about 300 psi. In certain embodiments, CO₂ is present at a pressure of between about 30 psi to about 200 psi. In certain embodiments, CO₂ is present at a pressure of between about 30 psi to about 100 psi. In certain embodiments, CO₂ is present at a pressure of between about 30 psi to about 80 psi. In certain embodiments, CO₂ is present at a pressure of about 30 psi. In certain embodiments, CO₂ is present at a pressure of about 50 psi. In certain embodiments, CO₂ is present at a pressure of about 100 psi.

In certain embodiments, any of the above methods comprise the reaction to be conducted at a temperature of between about 0° C. to about 100° C. In certain embodiments, the reaction is conducted at a temperature of between about 23° C. to about 100° C. In certain embodiments, the reaction to be conducted at a temperature of between about 23° C. to about 80° C. In certain embodiments, the reaction to be conducted at a temperature of between about 23° C. to about 50° C. In certain embodiments, the reaction to be conducted at a temperature of about 23° C.

In certain embodiments, the reaction step of any of the above methods does not further comprise a solvent.

However, in certain embodiments, the reaction step of any of the above methods does further comprise one or more solvents. In certain embodiments, the solvent is an organic solvent. In certain embodiments, the solvent is an organic ether. In certain embodiments, the organic ether solvent is 1,4-dioxane.

In certain embodiments, the reaction step of any of the above methods produces ethylene carbonate (EC) as a by-product in amounts of less than about 20%. In certain embodiments, ethylene carbonate (EC) is produced as a by-product in amounts of less than about 15%. In certain embodiments, ethylene carbonate (EC) is produced as a by-product in amounts of less than about 10%. In certain embodiments, ethylene carbonate (EC) is produced as a by-product in amounts of less than about 5%. In certain embodiments, ethylene carbonate (EC) is produced as a by-product in amounts of less than about 1%. In certain embodiments, the reaction does not produce any detectable by-products (e.g., as detectable by ¹H-NMR and/or liquid chromatography (LC)).

### Applications of Polyesters

As described above, polyesters are biocompatible and biodegradable materials with numerous uses ranging from high-performance applications in material science to use as biodegradable consumer packaging. In certain embodiments, the present invention provides polyesters having two carbon atoms separating the carbonate moieties made by the copolymerization of an epoxide and CO₂.

Such applications of provided APCs are contemplated as part of the present disclosure. However, this listing is not meant to be exhaustive or limiting, and it will be appreciated by one of ordinary skill in the art that other related applications of provided polyesters are within the scope of the invention.

### Exemplification

As depicted in the Examples below, in certain exemplary embodiments, compounds are prepared according to the following general procedures. It will be appreciated that, although the general methods depict the synthesis of certain compounds of the present invention, the following general methods, and other methods known to one of ordinary skill in the art, can be applied to all compounds and subclasses and species of each of these compounds, as described herein.

The foregoing has been a description of certain non-limiting embodiments of the invention. Accordingly, it is to be understood that the embodiments of the invention herein described are merely illustrative of the application of the principles of the invention. Reference herein to details of the illustrated embodiments is not intended to limit the scope of the claims.

### EXEMPLIFICATION

### Example 1

### Copolymerization of Certain Epoxides and Cyclic Anhydrides Generates Polymer Compositions with Low PDI

The present Example describes certain metal complex catalysts and their use in co-polymerization of epoxides and cyclic anhydrides to generate certain polyesters. In particular, the present Example describes use of (BDI)ZnOAc catalysts for the synthesis of new aliphatic polyesters with high Mn values and narrow molecular weight distributions (MWD−Mw/Mn)

Scheme 1 below illustrates the reaction performed, and the metal complexes utilized as catalysts. Tables 1 and 2 below depicts the results. As can be seen, the (BDI)ZnOAc metal complexes catalyzed synthesis polyesters. As can further be seen, metal complexes catalyzed synthesis of high Mn polymers (e.g., Mn of 10,000 g/mol, for example 12,000 g/mol and 23,000 g/mol); and also of low Mn polymers (e.g., Mn of less than 10,000 g/mol, e.g., 4,000 g/mol). Furthermore, the metal complexes catalyzed synthesis of polymers with narrow molecular weight distributions (below 2.0, and specifically within the range of 1.2-1.4).

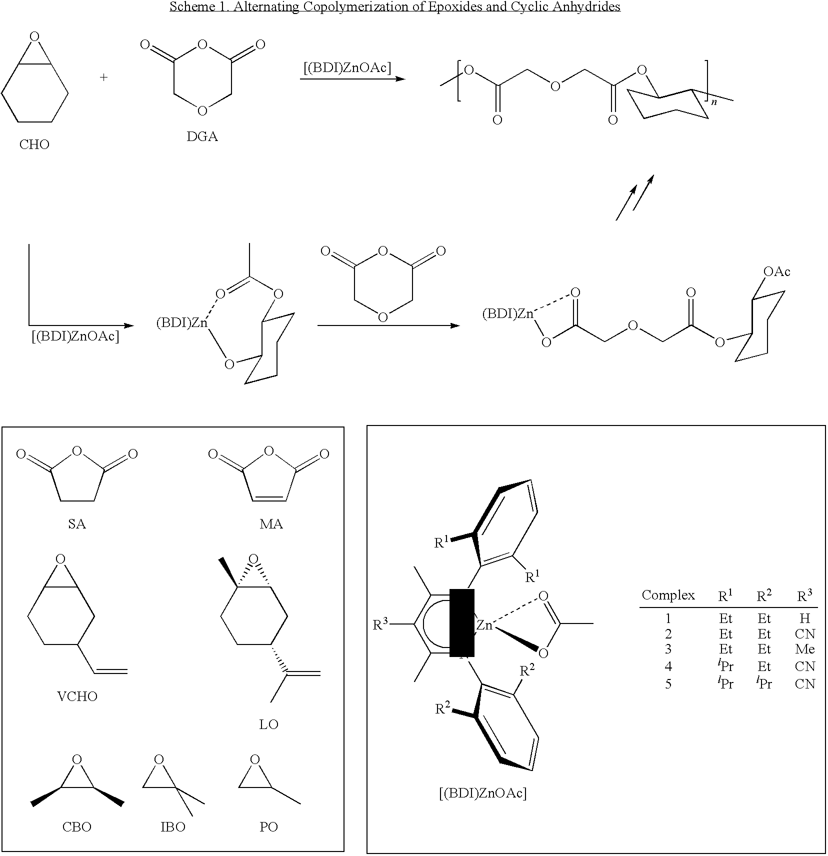

TABLE 1
Catalyst Screening for CHO/DGA copolymerization^{a}

| | | | Mₙ^{c} | MWD^{c} |
|---|---|---|---|---|
| entry | complex | conversion^{b} % | (g/mol) | (M_{w}/Mₙ) |
| 1^{d} | 1 | <1 | ND^{e} | ND^{e} |
| 2 | 2 | 14 | 4 000 | 1.4 |
| 3^{d} | 3 | <1 | ND^{e} | ND^{e} |
| 4 | 4 | 79 | 23 000 | 1.2 |
| 5 | 5 | 33 | 12 000 | 1.3 |

^{a}Conditions: 20 ┌mol Zn, 4 mmol CHO, 4 mmol DGA, 1.2 mL toluene, 50° C., 2 h.
^{b}Determined by ¹H NMR spectroscopy, conversion of CHO.
^{c}Determined by gel permeation chromatography (GPC), in THF, calibrated by polystyrene standards.
^{d}Polymerization run for 24 h.
^{e}Not determined.

As can be seen with reference to Table 1, metal complex 1 did not give detectable polymer from diglycolic anhydride (DGA) and cyclohexene oxide (CHO) under various reaction conditions. Without wishing to be bound by any particular theory, we propose that one explanation for this observed lack of polymer production is that metal complex 1 may react with DGA under the conditions tested, resulting in destruction of the complex. Indeed, investigation of the stoichiometric interaction of complex 1 with DGA using 1H NMR spectroscopy revealed nearly complete degradation of complex 1 after 1 h at 25° C. Other complexes did not show similar degradation. In particular, we note that complexes bearing a nitrile group at R3 were not degraded. Without wishing to be bound by any particular theory, we propose that the electron withdrawing nature of the nitrile group may help prevent ligand degradation, particularly since complex 3, which does not contain such an electron withdrawing group, also gave no detectable polymer formation, suggesting that it might also have been degraded. We confirmed that complex 2 is stable to DGA for 24 h at 50° C. These findings show, among other things, that complexes bearing an electron withdrawing group, and particularly complexes containing a nitrile group, may be particularly useful in catalyzing copolymerization of certain epoxides and cyclic anhydrides.

Reference to Table 1 further reveals that complex 4 shows unexpectedly good activity, even as compared with complexes 2 and 5. Without wishing to be bound by any particular theory, we propose that these findings reflect a steric effect of the substituents on the aryl ring. Specifically, we note that the substituents in complex 4 are intermediate in steric bulk relative to those of complexes 2 and 5. These findings therefore demonstrate a surprisingly good activity for metal complexes whose ligands have aryl substituents of intermediate steric bulk.

TABLE 2
Optimized Conditions for Alternating Copolymerization
of Epoxides and Cyclic Anhydrides using Complex 4^{a}

| | | | Zn | toluene | Tᵣₓₙ | tᵣₓₙ | conversion^{c} | Mₙ^{d} | MWD^{d} | T_{g}^{e} |
|---|---|---|---|---|---|---|---|---|---|---|
| entry | epoxide | anhydride | (mol %)^{b} | (mL) | (□C.) | (h) | (%) | (g/mol) | (M_{w}/Mₙ) | (□C.) |
| 1 | CHO | DGA | 0.33 | 1.2 | 50 | 6 | 91 | 31 000 | 1.2 | 51 |
| 2 | VCHO | DGA | 0.33 | 1.2 | 50 | 6 | 93 | 55 000 | 1.2 | 54 |
| 3 | LO | DGA | 0.33 | 1.2 | 70 | 16 | 81 | 36 000 | 1.2 | 51 |
| 4^{f} | PO | DGA | 0.50 | 0.0 | 30 | 16 | 89 | 18 000 | 1.3 | −1.8 |
| 5^{f} | CBO | DGA | 0.50 | 0.0 | 30 | 8 | 93 | 24 000 | 1.5 | 27 |
| 6^{f} | IBO | DGA | 0.50 | 0.0 | 30 | 48 | 53 | 10 000 | 1.5 | −13 |
| 7 | CHO | SA | 1.0 | 2.4 | 70 | 16 | 93 | 12 000 | 1.2 | 57 |
| 8 | VCHO | SA | 1.0 | 2.4 | 70 | 16 | 84 | 20 000 | 1.3 | 50 |
| 9 | LO | MA | 1.0 | 0.3 | 60 | 24 | 55 | 12 000 | 1.1 | 62 |

^{a}All reactions were carried out with 20 ┌mol catalyst; [epoxide] = [anhydride] unless otherwise noted.
^{b}With respect to anhydride.
^{c}Conversion of epoxide (entries 1, 3, 7, 9), conversion of anhydride (entries 2, 4-6, 8); determined by ¹H NMR spectroscopy.
^{d}Determined by GPC, in THF vs. polystyrene standards.
^{e}Determined by differential scanning calorimetry (DSC).
^{f}[Zn]:[epoxide]:[anhydride] = 1:800:200.

Reference to Table 2 illustrates, among other things, that under optimized conditions, the CHO/DGA copolymerization afforded poly(cyclohexene diglycolate) with a high Mn and narrow MWD (entry 1). Vinyl cyclohexene oxide (VCHO) reacted with DGA under the same conditions as the CHO/DGA copolymerization (entry 2). The comonomer trans-(R)-limonene oxide13 (LO), which can be synthesized from the biorenewable terpene limonene, also copolymerizes with DGA; however the reaction was better performed at higher temperatures and with longer reaction times (entry 3). Notably, polyesters containing LO and VCHO subunits have the potential to be useful precursors to more elaborate polymers through post-polymerization modification of the pendant vinyl groups. Aliphatic epoxides, including propylene oxide (PO), isobutylene oxide (IBO) and cis-butene oxide (CBO), are also viable monomers for copolymerization with DGA (entries 4-6); neat conditions were optimal for these reactions.

Preliminary analysis of the polymer derived from IBO (entry 6) shows what we believe to be regiorandom insertion of the epoxide. This is noteworthy because the PO/DGA copolymer exhibits regioregular stereochemistry¹³.

We also explored other anhydrides as comonomers and found that succinic anhydride (SA) copolymerizes with CHO (entry 7) and VCHO (entry 8), although the Mₙ values of the resulting copolymers are somewhat lower than the DGA-containing polymers. Maleic anhydride (MA) reacts with LO to give polyester with a moderate Mₙ (entry 9). We note that other epoxides, including CHO did not cleanly copolymerize with MA.

The polyesters produced in our reactions were characterized by ¹H and ¹³C{¹H} NMR spectroscopy, GPC, and DSC. The ¹H NMR spectra of the polymers do not show consecutive anhydride or epoxide sequences, which supports the alternating structure shown in Scheme 2¹². GPC results revealed high Mₙ values and narrow MWDs. In many cases, the GPC chromatograph exhibits a slightly higher molecular weight shoulder. Without wishing to be bound by any particular theory, we propose that this can be attributed to the presence of truce amounts of hydrolyzed anhydride, which could act as a bifunctional initiator and give an Mₙ value twice as large as expected. Glass transition temperatures of the polymers with alicyclic backbones (T_{g}, Table 2, entries 103, 7-9) are comparable to PLA (T_{g}=55-60° C.).² The polyesters reported herein have decomposition temperatures approaching 290° C., which allow easier melt processing than poly(3-hydroxybutyrate), a polymer that decomposes at a temperature close to its melting point³.

This example therefore demonstrates the use of highly active catalysts to achieve alternating copolymerization of a range of epoxides and cyclic anhydrides. This work resulted in efficient synthesis of new aliphatic polyesters with high Mₙ values and narrow MWDs.

### REFERENCES

(1)(a) Biopolymers Steinbüchel, A., Doi, Y., Eds.; Wiley-VCH: Weinheim, 2002; Vol. 4. (b) Okada, M. Prog. Polym. Sci. 2002, 27, 87-133. (c) Dechy-Cabaret, O.; Martin-Vaca, B.; Bourissou, D. Chem. Rev. 2004, 104, 6147-6176. (d) Müller, H. M.; Seebach, D. Angew. Chem. Int. Ed. Engl. 1993, 32, 477-502.
(2) Coulembier, O.; Degée, P.; Hedrick, J. L.; Dubois, P. Prog. Polym. Sci. 2006, 31, 723-747.
(3) Williams, S. F.; Martin, D. P. Biopolymers Steinbüchel, A., Doi, Y., Eds.; Wiley-VCH: Weinheim, 2002; Vol. 4, 91-127.
(4)(a) Vink, E. T. H.; Magri, K. R.; Glassner, D. A.; Springs, B.; O'Connor, R. P.; Kolstad, J.; Gruber, P. R. Macromol. Biosci. 2004, 4, 551-564. (b) Gruber, P. R.; O'Brien, M. Biopolymers Steinbtichel, A., Doi, Y., Eds.; Wiley-VCH: Weinheim, 2002; Vol. 4, 235-250.
(5)(a) Odian, G. Principles of Polymerisation, 4th Ed; John Wiley and Sons: Hoboken, N.J., 2004. (b) Seppälä, J. V.; Korhonen, H.; Kylmä, J.; Tuominen, J. Biopolymers Steinbüchel, A., Doi, Y., Eds.; Wiley-VCH: Weinheim, 2002; Vol. 3b, 327-369.
(6) Gemgross, T. U.; Slater, S. C. Sci. Am. 2000, 283(2), 36-41.
(7) O'Keefe, B. J.; Hillmyer, M. A.; Tolman, W. B. Dalton Trans. 2001, 2215-2224.
(8)(a) Aida, T.; Inoue, S. J. Am. Chem. Soc. 1985, 107, 1358-1364. (b) Aida, T.; Sanuki, K.; Inoue, S. Macromolecules 1985, 18, 1049-1055. (c) Takasu, A.; Ito, M.; Inai, Y.; Hirabayashi, T.; Nishimura, Y. Polym. J. 1999, 31, 961-969. (d) Hua, Z.; Qi, G.; Chen, S. J. Appl. Polym. Sci. 2004, 93, 1788-1792. (e) Maeda, Y.; Nakayama, A.; Kawasaki, N.; Hayashi, K.; Aiba, S.; Yamamoto, N. Polymer 1997, 38, 4719-4725.
(9) (a) Cheng, M.; Lobkovsky, E. B.; Coates, G. W. J. Am. Chem. Soc. 1998, 120, 11018-11019. (b) Cheng, M.; Moore, D. R.; Reczek, J. J.; Chamberlain, B. M.; Lobkovsky, E. B.; Coates, G. W. J. Am. Chem. Soc. 2001, 123, 8738-8749. (c) Allen, S. D.; Moore, D. R.; Lobkovsky, E. B.; Coates, G. W. J. Am. Chem. Soc. 2002, 124, 14284-14285. (d) Moore, D. R.; Cheng, M.; Lobkovsky, E. B.; Coates, G. W. Angew. Chem. Int. Ed. Engl. 2002, 41, 2599-2602. (e) Moore, D. R.; Cheng, M.; Lobkovsky, E. B.; Coates, G. W. J. Am. Chem. Soc. 2003, 125, 11911-11924.
(10)(a) Cheng, M.; Attygalle, A. B.; Lobkovsky, E. B.; Coates, G. W.; J. Am. Chem. Soc. 1999, 121, 11583-11584. (b) Chamberlain, B. M.; Cheng, M.; Moore, D. R.; Ovitt, T. M.; Lobkovsky, E. B.; Coates, G. W. J. Am. Chem. Soc. 2001, 123, 3229-3238. (c) Rieth, L. R.; Moore, D. R.; Lobkovsky, E. B.; Coates, G. W. J. Am. Chem. Soc. 2002, 124, 15239-15248.
(11) BDI complexes have been shown to react at the carbon bearing R³ with a variety of electrophiles. See: (a) Radzewich, C. E.; Coles, M. P.; Jordan, R. F. J. Am. Chem. Soc. 1998, 120, 9384-9385. (b) Yokota, S.; Tachi, Y.; Itoh, S. Inorg. Chem. 2002, 41, 1342-1344. (c) Carey, D. T.; Cope-Eatough, E. K.; Vilaplana-Mafé, E.; Mair, F. S.; Pritchard, R. G.; Warren, J. E.; Woods, R. J. Dalton Trans. 2003, 1083-1093. (d) Basuli, F.; Huffman, J. C.; Mindiola, D. J. Inorg. Chem. 2003, 42, 8003-8010.
(¹2) See Example 2.
(13) We have previously investigated LO as a monomer: Byrne, C. M.; Allen, S. D.; Lobkovsky, E. B.; Coates, G. W. J. Am. Chem. Soc. 2004, 126, 11404-11405.
(14) Rowley, J. R.; Lobkovsky, E. B.; Coates, G. W. J. Am. Chem. Soc. 2007, 129, 4948-4960.

### Example 2

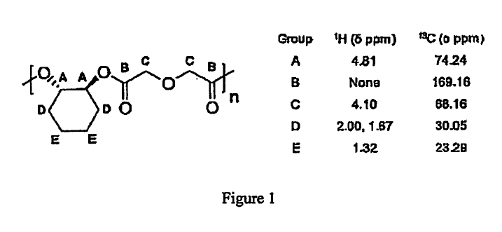

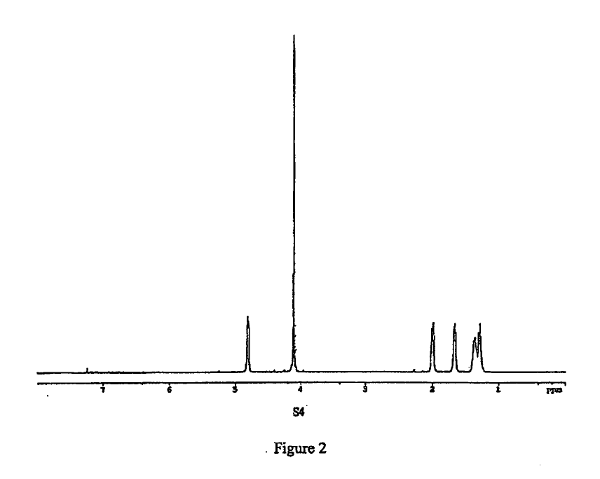

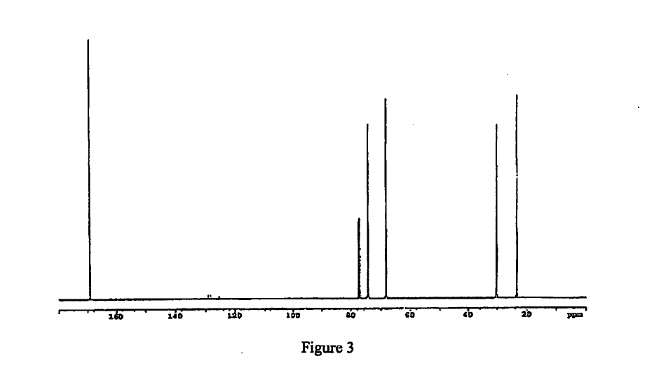

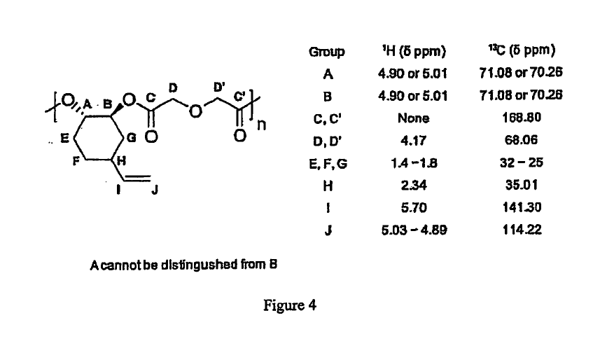

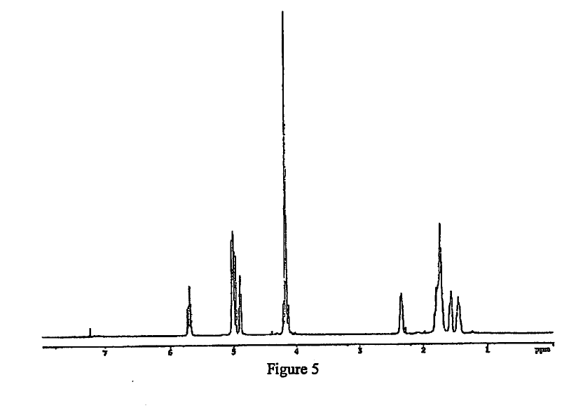

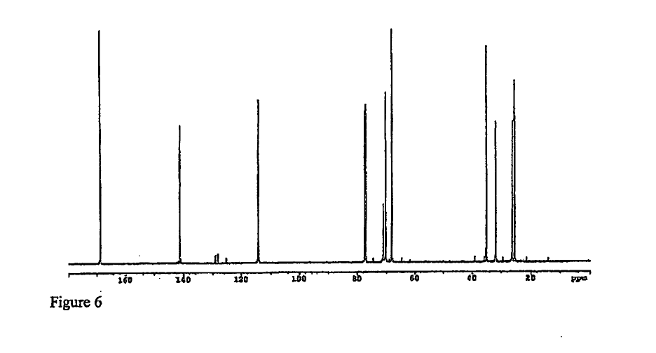

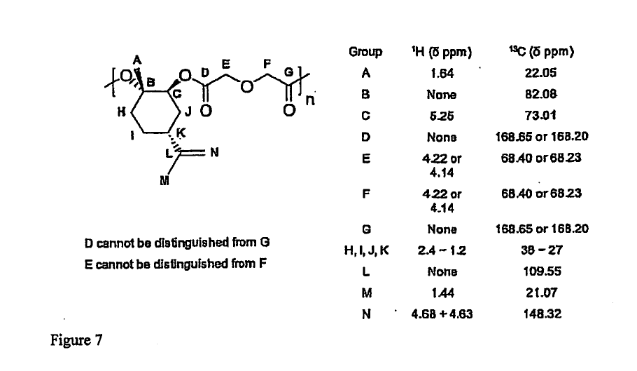

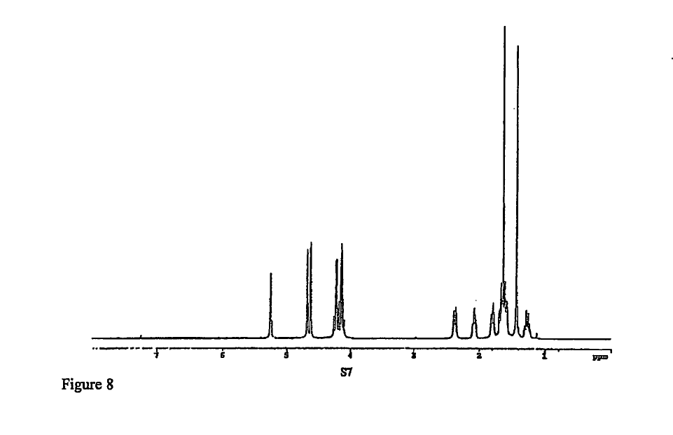

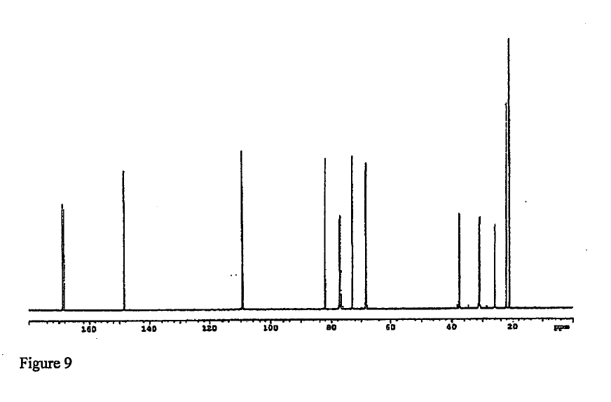

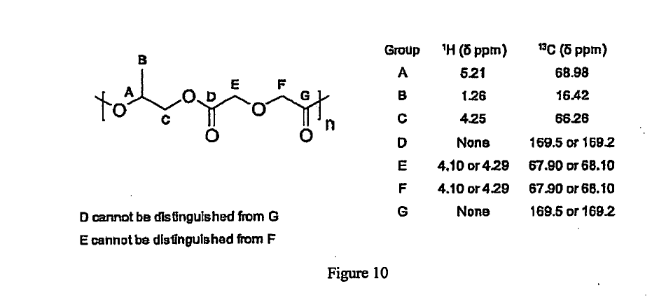

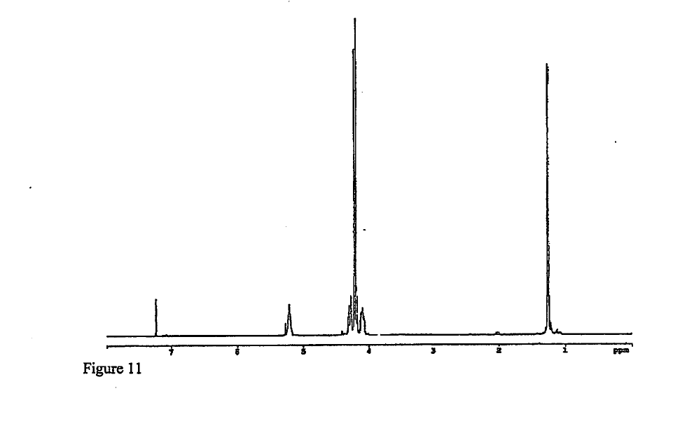

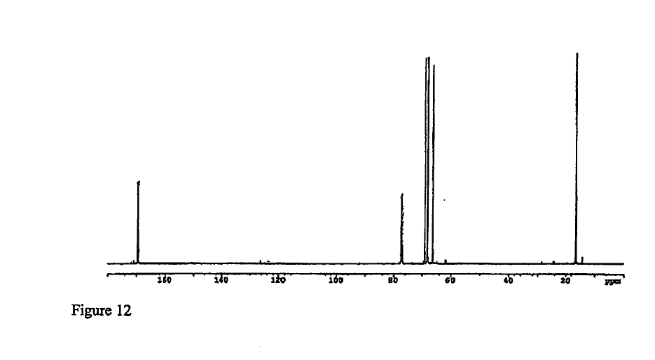

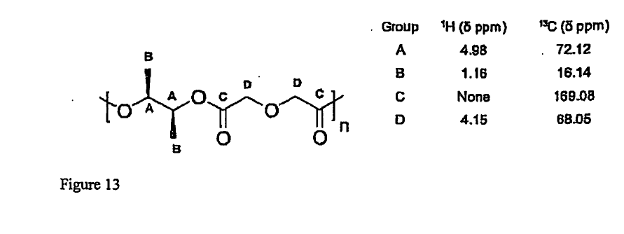

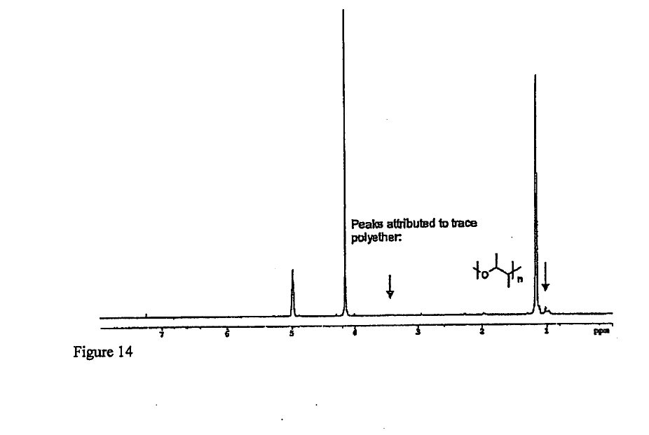

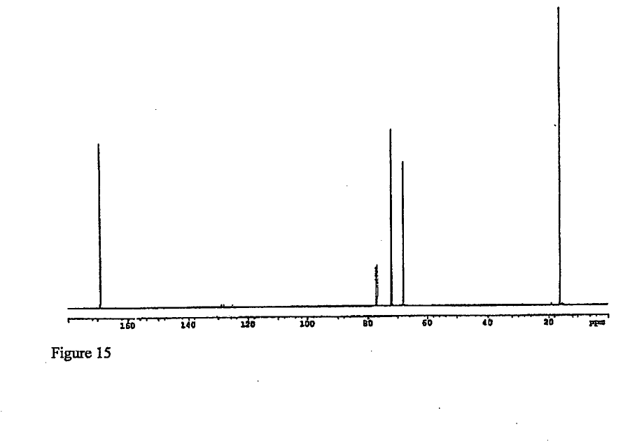

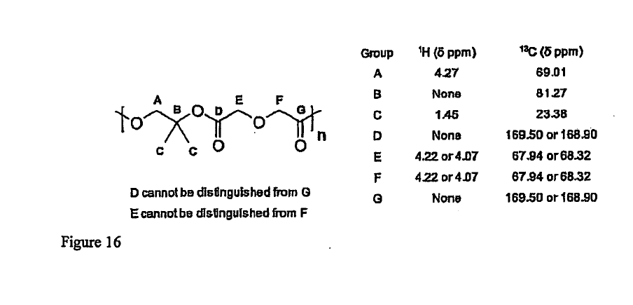

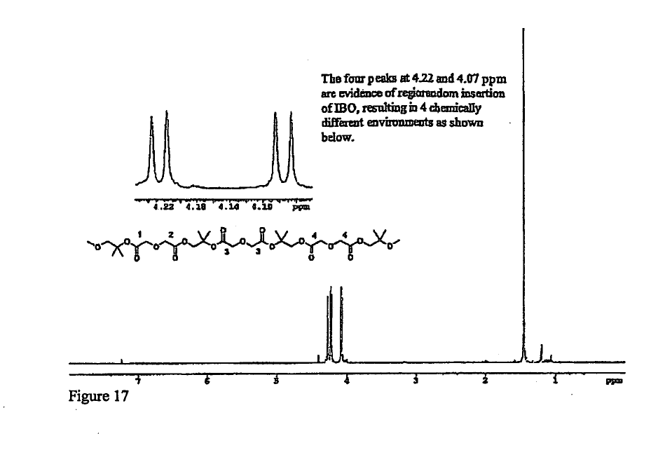

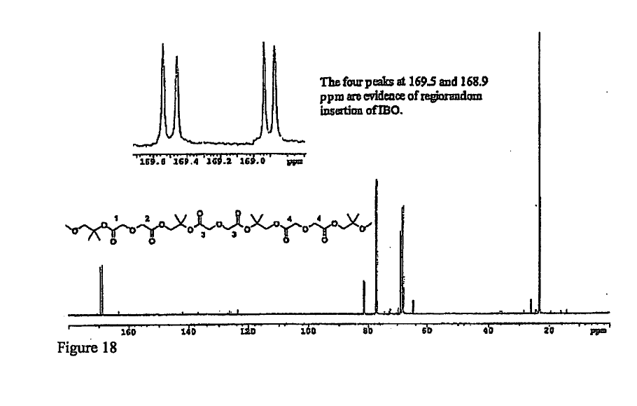

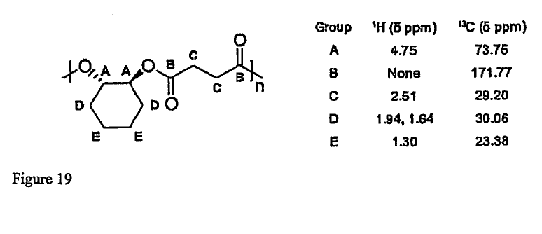

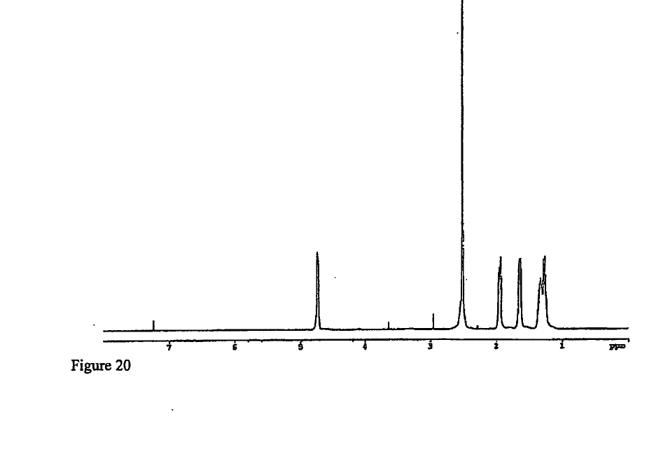

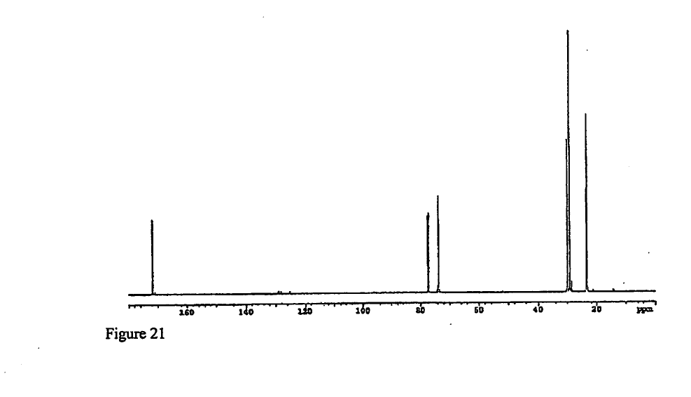

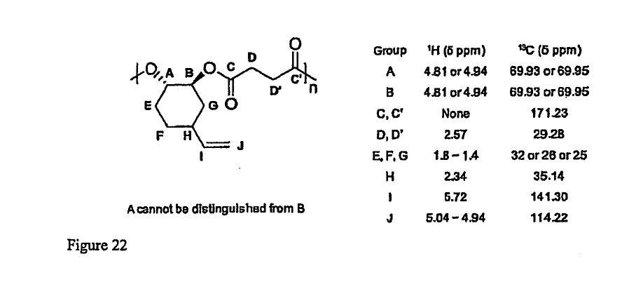

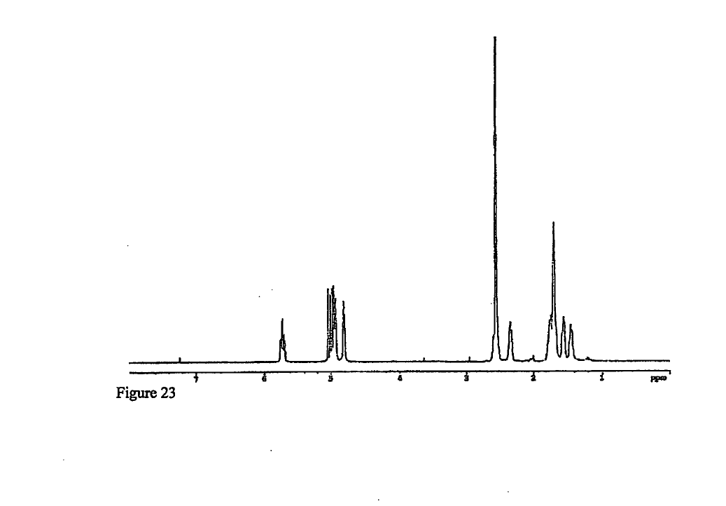

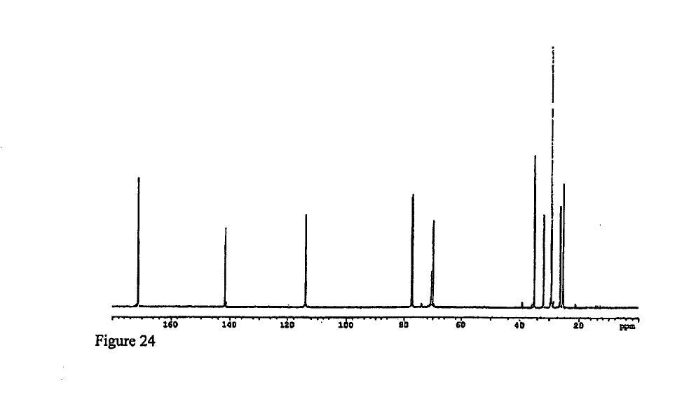

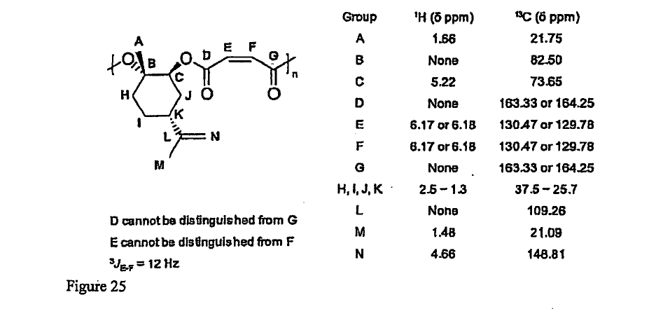

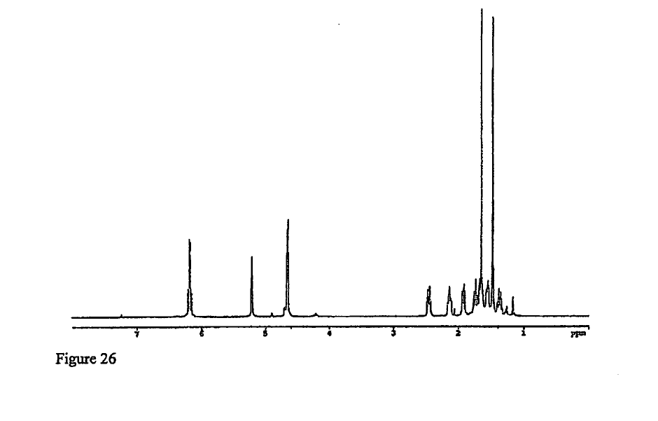

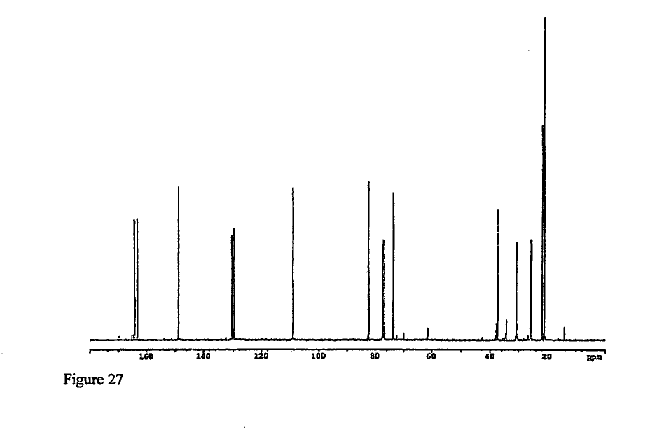

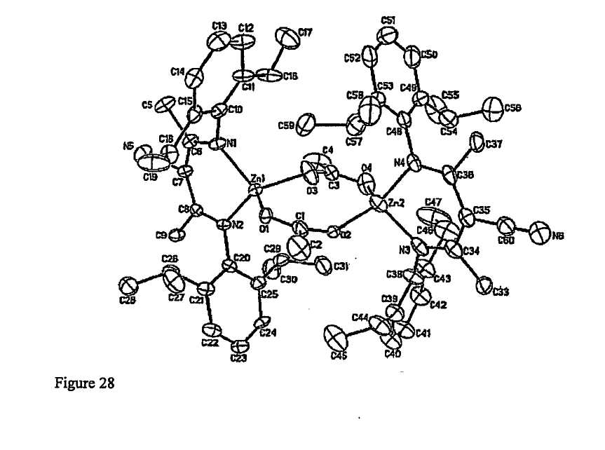

### Supporting Information Evidencing Copolymerization of Certain Epoxides and Cyclic Anhydrides that Generates Polymer Compositions with Low PDI as Described in Example 1 (see FIGS. 1-28)

### General Methods

Manipulations of air and water sensitive compounds were carried out under dry nitrogen using a Braun Labmaster glovebox or standard Schlenk line techniques. ¹H NMR spectra were recorded on a Varian Mercury (¹H, 300 MHz), Varian INOVA 400 (¹H, 400 MHz) or Varian NOVA 500 (¹H, 500 MHz) spectrometer and referenced with residual non-deuterated solvent shifts (CHCl₃=7.26 ppm, C₆D₅H=7.16 ppm). ¹³C NMR spectra were recorded on a Varian INOVA (¹³C, 125 MHz) spectrometer and referenced to chloroform, 77.23 ppm.

Gel permeation chromatography (GPC) analyses were carried out using a Waters instrument, (M515 pump, 717+ Autosampler) equipped with a Waters UV486 and Waters 2410 differential refractive index detectors, and three 5 μm PSS SDV columns (Polymer Standards Service; 50 Å, 500 Å, and Linear M porosities) in series. The GPC columns were eluted with tetrahydrofuran at 40° C. at 1 mL/min and were calibrated using 20 monodisperse polystyrene standards.

Differential scanning calorimetry of polymer samples was performed on a TA Instruments Q1000 instrument equipped with a LNCS and automated sampler. Typical DSC experiments were made in crimped aluminum pans under nitrogen with a heating rate of 10° C./min from −100° C. to +230° C.

### Materials

HPLC grade toluene, methylene chloride, tetrahydrofuran, pentane and Optima grade hexanes were purchased from Fisher Scientific and purified over solvent columns Cyclohexene oxide and propylene oxide (purchased from Aldrich), cis-2-butene oxide (purchased from GFS Chemicals) and isobutylene oxide (purchased from TCI America), were stirred over calcium hydride, put through three freeze-pump-thaw cycles, then vacuum transferred under nitrogen and stored in a glove box. Trans-(R)-limonene oxide (purchased from Millenium) was distilled under nitrogen from calcium hydride after three freeze-pump-thaw cycles and stored in a glove box. Diglycolic anhydride and succinic anhydride (purchased from Acros) and maleic anhydride (purchased from Aldrich) were dried overnight under vacuum, sublimed twice under dry nitrogen and stored in the glovebox. Diethyl zinc was purchased from Aldrich and used as received. All other reagents were purchased from common commercial sources and used as received.

### Synthesis of Metal Complexes

Synthesis of 1-4. [(BDI)ZnOAc]₂ complexes exist as dimers in the solid state and in a monomer/dimer equilibrium in solution. Complexes 1-4 were prepared according to literature procedures,¹ except complex 4 was crystallized from tetrahydrofuran and pentane to yield X-ray quality, clear, colorless crystals. X-ray crystal structure data for 4 is given later in the supporting information.

Synthesis of 5. The ligand was synthesized as reported for other nitrile-bearing BDI ligands in reference 1a. Diethyl zinc, (2.1 mL of 0.9 M solution in heptane, 1.89 mmol) was added to a solution of ligand, (590 mg, 1.34 mmol) in a schlenk tube under N₂ in toluene (15 mL). After stirring overnight at 85° C., the clear solution was dried in vacuo, giving a quantitative yield of the (BDI)ZnEt complex. ¹H NMR(C₆D₆, 300 MHz) δ 7.00 (6H, b, ArH), 2.88 (4H, septet, J=7.0 Hz, CHMe₂), 2.14 (6H, s, α-Me), 1.14 (12H, d, J=7.0 Hz, CHMeMe), 1.00 (12H, d, J=7.0 Hz, CHMeMe), 0.71 (3H, t, J=8.0 Hz, CH₂CH₃), 0.11, (2H, quartet, J=8.0 Hz, CH₂CH₃). The (BDI)ZnEt complex was dissolved in 25 mL CH₂Cl₂, cooled to 0° C., and acetic acid (0.071 mL, 1.24 mmol) was added dropwise over 5 minutes. The solution was stirred for 16 h, slowly warming to RT. The volatiles were removed in vacuo, and the white solid was recrystallized by layering a CH₂Cl₂ solution with pentane at RT to give colorless, block shaped crystals (0.480 g, 65% yield). X-ray crystal data is reported later in the supporting information. ¹H NMR (THF-d₈, 400 MHz) δ 7.12 (6H, b, ArH), 3.26 (4H, septet, J=7.0 Hz, CHMe₂), 2.00 (6H, s, α-Me), 1.63 (3H, s, O₂CCH₃), 1.21 (12H, d, J=7.0 Hz, CHMeMe), 1.13 (12H, d, J=7.0 Hz, CHMeMe).

### Representative Copolymerization Procedure

In the glovebox, 20 μmol complex, and 4 mmol anhydride were placed in a vial equipped with a small stir bar. Toluene (1.2 mL) was added, followed by 4 mmol of epoxide. The vial was sealed with a teflon lined cap, removed from the glovebox and placed in an aluminum heat block preheated to the desired temperature. Initially the mixture was heterogeneous, but gradually became homogeneous as the polymerization proceeded. After the alloted reaction time, the vial was removed from the heat block and a small aliquot was removed for crude ¹H NMR analysis. The viscous sample was dissolved in a minimum amount of toluene (dichloromethane for entries 7 and 8), and precipitated into an excess of diethyl ether (pentane, entries 7 and 8). The polymer was collected and dried in vacuo to give a white solid typically in 90-95% recovery by weight.

### X-Ray Crystallography

Crystals of 4 or 5 were transferred from a schlenk vessel into a drop of viscous oil. Using a nylon loop, a suitable single crystal was chosen and mounted on a Broker X8 APEX II diffractometer (MoK_{α} radiation) and cooled to −100° C. Data collection and reduction were done using Broker APEX2² and SAINT+³ software packages. An empirical absorption correction was applied with SADABS.⁴ With a crystal size of 0.4×0.25×0.2 mm³, 61995 reflections were collected, 6921 of which were symmetry independent (Rᵢₙₜ=0.0700); 6000 of which were ‘strong’ (with Fₒ>4σFₒ). The crystal structure was solved by direct methods and refined on F² by full matrix least-squares techniques using the SHELXTL⁵ software package. All non-hydrogen atoms were refined anisotropically. Hydrogen atoms were included into the structure in calculated positions. One of the bridging oxygen atoms (O2) is disordered into two positions. Final R₁=4.89%. Crystallographic data (excluding structure factors) have been deposited with the Cambridge Crystallographic Data Center (CCDC-201673-201684). Copies of the data can be obtained free of charge on application to CCDC, 12 Union Road, Cambridge CB21EZ, UK (fax: (+44)1223-336-033).

Crystal data and structure refinement for 4 are presented below in Table 3:

TABLE 3
Crystal data and structure refinement for 4.

| Identification code | rj4 | |
|---|---|---|
| Empirical formula | Zn₂ C₆₀ H₇₈ N₆ O₄ | |
| Formula weight | 539.01 | |
| Temperature | 173(2) K | |
| Wavelength | 0.71073 Å | |
| Crystal system | Orthorhombic | |
| Space group | Pca2(1) | |
| Unit cell dimensions | a = 22.641(3) Å | α = 90°. |
| | b = 13.976(3) Å | β = 90°. |
| | c = 17.924(3) Å | γ = 90°. |

| | |
|---|---|
| Volume | 5671.7(17) Å³ |
| Z | 8 |
| Density (calculated) | 1.262 Mg/m³ |
| Absorption coefficient | 0.896 mm⁻¹ |
| F(000) | 2288 |
| Crystal size | 0.40 × 0.25 × 0.20 mm³ |
| Theta range for data collection | 1.46 to 21.97°. |
| Index ranges | −23 <= h <= 23, −14 <= k <= 14, |
| | −18 <= l <= 18 |
| Reflections collected | 61995 |
| Independent reflections | 6921 [Rᵢₙₜ = 0.0700] |
| Completeness to theta = 21.97° | 100.0% |
| Absorption correction | Semi-empirical from equivalents |
| Max. and min. transmission | 0.8411 and 0.7157 |
| Refinement method | Full-matrix least-squares on F² |
| Data/restraints/parameters | 6921/2/660 |
| Goodness-of-fit on F² | 1.028 |
| Final R radices [I>2sigma(I)] | R1 = 0.0489, wR2 = 0.1193 |
| R indices (all data) | R1 = 0.0596, wR2 = 0.1247 |
| Absolute structure parameter | 0.027(16) |
| Largest diff. peak and hole | 0.893 and −0.801 e.Å⁻³ |

### REFERENCES

(1) (a) Allen, S. D.; Moore, D. IL; Lobkovsky, E. B.; Coates, G. W. J. Am. Chem. Soc. 2002 124, 14284-14285. (b) Moore, D. IL; Cheng, M.; Lobkovsky, E. B.; Coates, G. W. J. Am. Chem. Soc. 2003, 125, 11911-11924. (c) Moore, D. IL, Ph.D. Dissertation, Cornell University, Ithaca, N.Y., 2003.
(2) APEX2 v.1.0-22 User Manual, Bruker AXS Inc., Madison Wis. 53719, 2004.
(3) SAINT+ v.6.02 User Manual, Bruker AXS Inc., Madison Wis. 53719, 1999.
(4) Scheldrick, G. M. SADABS, Program for Empirical Absorption Correction of Area Detector Data, University of Göttingen, 1996.
(5) Scheldrick, G. M. SHELXTL v. 5.10 Bruker AXS Inc., Madison Wis. 53719, 1999.

### Example 3

### Further Examples of Copolymerization of Epoxides and Cyclic Anhydrides

### Representative Copolymerization Procedure

In the glovebox, 20 μmol a metal complex depicted below in Table XXX,

TABLE 4

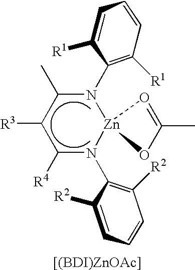

| Complex | R¹ | R² | R³ | R⁴ |
|---|---|---|---|---|
| 1 | Et | Et | H | Me |
| 2 | Et | Et | CN | Me |
| 3 | Et | Et | Me | Me |
| 4 | ⁱPr | Et | CN | Me |
| 5 | ⁱPr | ⁱPr | CN | Me |
| 6 | Et | Et | CN | CF₃ |
| 7 | Me | Et | CN | Me |

together with 4 mmol anhydride were placed in a vial equipped with a small stir bar. Toluene (1.2 mL) was added, followed by 4 mmol of epoxide. The vial was sealed with a teflon lined cap, removed from the glovebox and placed in an aluminum heat block preheated to' the desired temperature. Initially the mixture was heterogeneous, but gradually became homogeneous as the polymerization proceeded. After the alloted reaction time, the vial was removed from the heat block and a small aliquot was removed for crude ¹H NMR analysis. The viscous sample was dissolved in a minimum amount of toluene (dichloromethane for entries 7 and 8), and precipitated into an excess of diethyl ether (pentane, entries 7 and 8). The polymer was collected and dried in vacuo to give a white solid typically in 90-95% recovery by weight.

Relevant structures referred to in this Example include:

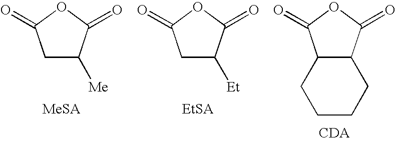

### Copolymerization of Methyl Succinic Anhydride (MeSA) and CHO

Procedure was the same as above except that complex 6 (1 mol %) was used. The reaction proceeded at 70° C. for 24 hr. 99% conversion to alternating polyester. Mn=16000 g/mol, PDI=1.3

### Copolymerization of Ethyl Succinic Anhydride (EtSA) and CHO

Procedure was the same as above except that complex 7 (1 mol %) was used. The reaction proceeded at 70° C. for 16 hr. 93% conversion to alternating polyester. Mn=7800 g/mol, PDI=1.2

### Copolymerization of Cyclohexande Dicarboxylic Anhydride (CDA) and CHO

Procedure was the same as above except that complex 4 (1 mol %) was used. The reaction proceeded at 80° C. for 24 hr. 78% conversion to alternating polyester. Mn=12000 g/mol, PDI=1.3.

### Diels-Alder Cycloaddition Between Poly(Limonene Maleate) and Dicyclopentatdiene (Table 2, Entry 9) (RCJ-4-281)

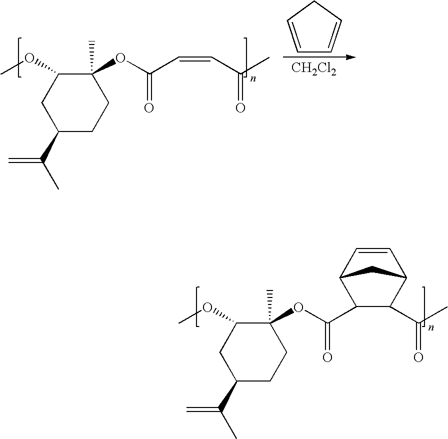

Polymer (100 mg, 0.4 mmol repeat units) was combined with cracked cyclopentadiene (100 uL, 1.2 mmol), toluene, 1 mL and dichloromethane, 1 mL in a small vial. The vial was stirred and heated at 40° C. for 20 hr. 99% conversion to cycloaddition product. T_{g} increased from 62 to 128° C.

Representative Copolymerization Procedure Using (rac)-(Salcy)CoOBzF₅ and F₅ and [PPN]Cl

In the glovebox, Compound 8, (10 mg, 0.012 mmol):

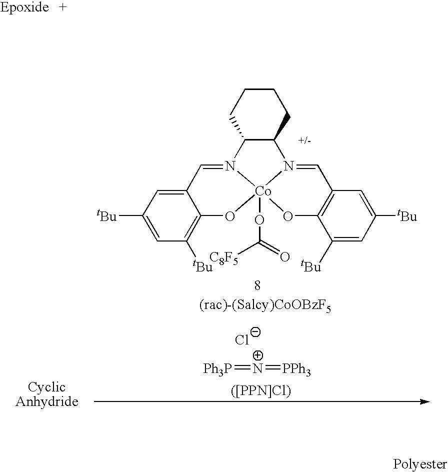

was combined with [PPN]Cl, (7.1 mg, 0.012 mmol), propylene oxide (PO), (170 μL, 2.4 mmol), diglycolic anhydride, (140 mg, 1.2 mmol) and toluene, 0.2 mL, were combined in a small vial equipped with a small stir bar. The vial was sealed with a teflon lined cap, removed from the glovebox and stirred at room temperature (21° C.). Initially the mixture was heterogeneous, but gradually became homogeneous as the polymerization proceeded. After 24 hr, the vial was opened and a small aliquot was removed for crude ¹H NMR analysis. The viscous sample was dissolved in a minimum amount of toluene or dichloromethane, and precipitated into an excess of pentane. 99% conversion of anhydride to polyester with no polyether formation. Mn=5100 g/mol, PDI=3
Copolymerization of PO and Glutaric Anhydride (GA) with Metal Complex 8 with [PPN]OAc as Cocatalyst.

Procedure was the same as above except that [PPN]OAc (7 mg, 0.12 mmol) was used in place of [PPN]Cl. 99% conversion of anhydride to polyester with no polyether formation.

Copolymerization of CHO and DGA with Metal Complex 8

Procedure was the same as above except that CHO (120 μL, 1.2 mmol) was used in place of PO. 45% conversion of anhydride to polyester with no polyether formation.

Copolymerization of CHO and Glutaric Anhydride with Metal Complex 8

Procedure was the same as above except that CHO (120 μL, 1.2 mmol) and glutaric anhydride (140 mg, 1.2 mmol) was used in place of PO and DGA. 25% conversion of anhydride to polyester with no polyether formation.

Copolymerization of CHO and CDA with Metal Complex 8

Procedure was the same as above except that CHO (120 μL, 1.2 mmol) and CDA (190 mg, 1.2 mmol) were used in place of PO and DGA. 25% conversion of anhydride to polyester with no polyether formation.

Copolymerization of PO and CDA with Metal Complex 8

Procedure was the same as above except that CDA (190 mg, 1.2 mmol) was used in place of DGA. 40% conversion of anhydride to polyester with no polyether formation.

Copolymerization of PO and GA with Metal Complex 8

Procedure was the same as above except that GA (140 mg, 1.2 mmol) was used in place of DGA. 99% conversion of anhydride to polyester with no polyether formation. Mn=14000 g/mol, PDI=1.6

Terpolymerization of PO, DGA and CO₂ with Metal Complex 8

In the glovebox, Compound 8, (18 mg, 0.021 mmol), [PPN]Cl, (13 mg, 0.022 mmol), propylene oxide (PO), (3 mL, 44 mmol), and diglycolic anhydride, (500 mg, 4.3 mmol) were combined in a Parr reactor equipped with an overhead stirrer. The reactor was sealed, removed from the glovebox, pressured to 200 psig with CO₂ and stirred at room temperature (21° C.). After 4 hr, the reactor was vented and opened and a small aliquot was removed for crude ¹H NMR analysis. The viscous sample was dissolved in a minimum amount of dichloromethane, and precipitated into an excess of pentane. 10% conversion of epoxide to polyester and 18% conversion of epoxide to polycarbonate with no polyether formation. Mn=18000 g/mol, PDI=1.2

Copolymerization of PO and DGA with Metal Complex 9

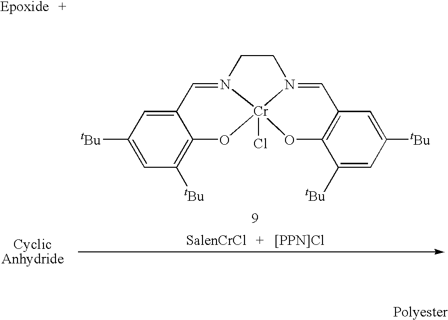

Procedure was the same as for catalyst 8, but complex 9, (7.2 mg, 0.012 mmol) was used. 75% conversion of anhydride to alternating polyester with no polyether formation.

Copolymerization of PO and DGA with Metal Complex 10

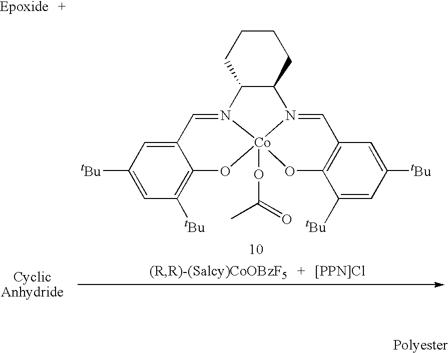

Procedure was the same as for catalyst 8, but complex 10, (10 mg, 0.021 mmol) was used. 99% conversion of anhydride to alternating polyester with no polyether formation.

### Example 4

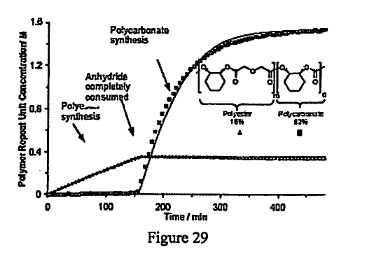

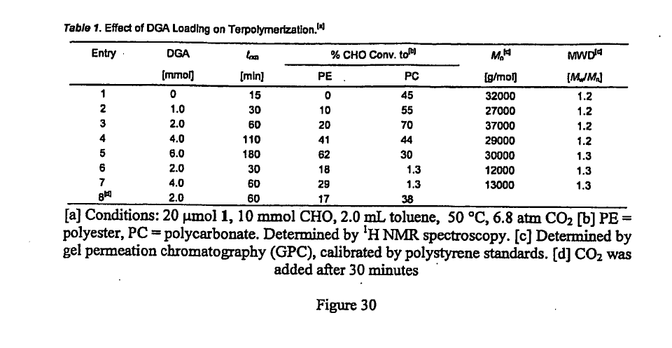

### One-Step Preparation of Diblock Copolymers via Terpolymerization of Epoxides, Cyclic Anhydrides, and CO₂ (See FIGS. 29-30)

The present Example describes preparation of poly(ester-block-carbonate)s through a one-step, one-pot procedure using a β-diiminate (BDI) zinc metal complex 4 (see Scheme 2, below):

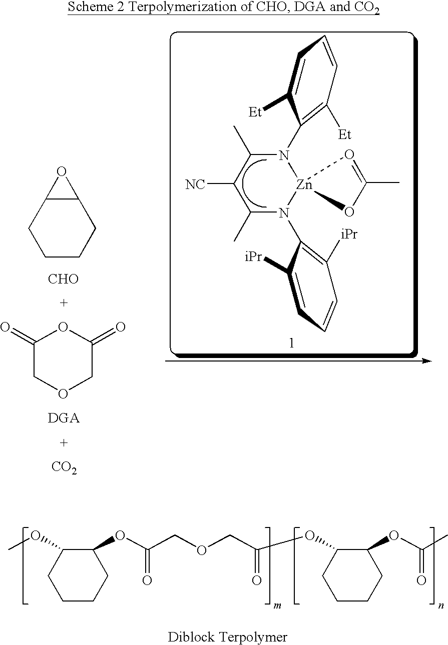

Block copolymers have found widespread use in membrane synthesis⁽¹⁾, drug delivery⁽²⁾, lithography⁽³⁾, among other things, as well as as thermoplastic elastomers^{(4,5)}, Polymers containing ester and carbonate linkages are useful as biodegradable implants⁽¹²⁾ and have been shown to have adjustable degradation rates⁽¹³⁾.

We performed the terpolymerization reaction depicted in Scheme 2, initially expecting that the product would be a random polyester-carbonate). However, we surprisingly found that the 1H NMR spectrum of the product was consistent with two separate homopolymers. Also, during the polymerization, it was noted that the CO₂ pressure remained constant (6.8 atm) until the anhydride was consumed, at which point it began to decrease.

When the reaction was repeated and quenched before the anhydride was completely consumed, the ¹H NMR spectrum revealed that about 90% of the anhydride was incorporated into polyester, but very little polycarbonate (˜1%) was present. Without wishing to be bound by any particular theory, we propose that a diblock terpolymer was generated in the initial reaction via the mechanism proposed in Scheme 3, in which the rate of path A is much higher than the rate of path B.

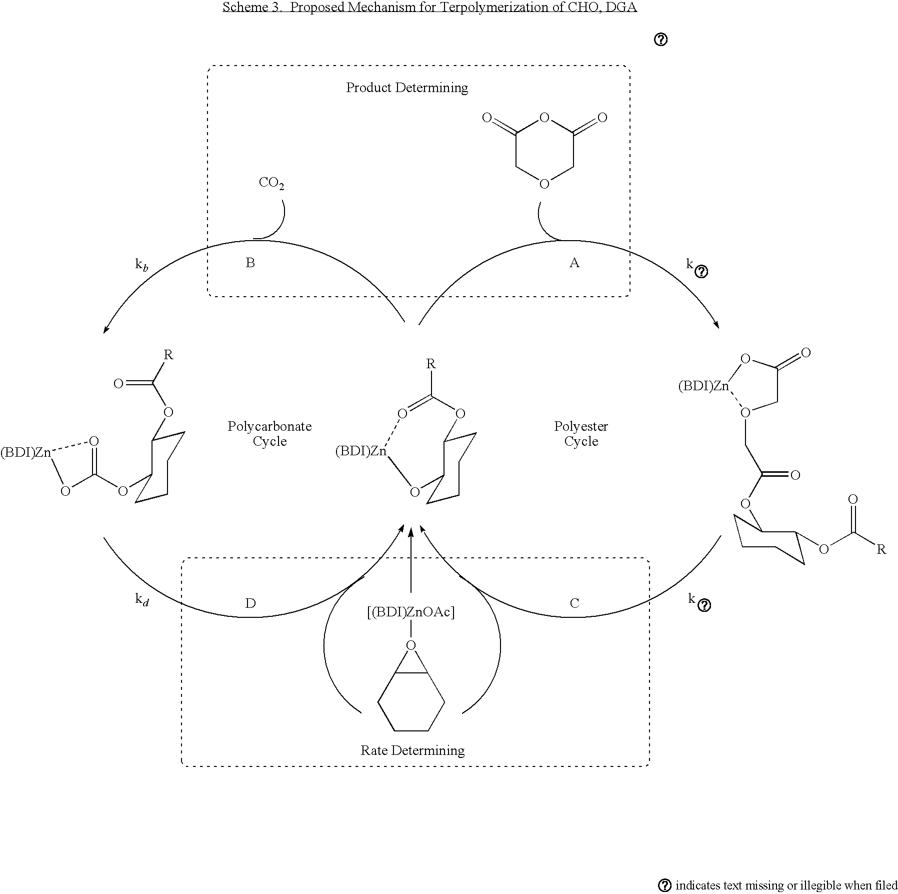

We performed the reaction with a number of different (BDI)ZnOAc comlpexes⁽¹⁶⁾ and found that complex 4⁽¹⁴⁾, shown in Scheme 2 above, was the most active of those tested.

We also exampled the effect of anhydride loading. As shown in FIG. 29, as [DGA] increases relative to [CHO] and [CO₂] (entries 1-5 on FIG. 29) more polyester is produced, but the overall polymerization is slower due to the lower rate of polyester formation⁽¹⁷⁾. Entries 6 and 7 in FIG. 29, which were quenched before complete conversion of DGA, support a block structure as shown by the very low conversion to polycarbonate⁽¹⁸⁾.

Prior to the present work, there were few reported of terpolymerizations that incorporate CO₂^{(19, 20, 21)}, and all of them require high pressures of CO2 (>27 atm). Furthermore, one case resulted in concomitant polyether formation⁽²⁰⁾. Moreover, all reported methods produce random terpolymers.

To more clearly observe the synthesis of polyester and polycarbonate blocks we monitored the terpolymerization of CHO, DGA, and CO₂ by in situ IR spectroscopy^{(15c, 22, 23)} A plot of the polymer repeat unit concentration as a function of time demonstrates that polyester is formed first followed by polycarbonate in two very distinct blocks with little tapering (FIG. 29). Surprisingly little polycarbonate was produced during the polyester block, even though the second block formed significantly faster than the first. Without wishing to be bound by any particular theory, we hypothesize that this remarkable two-stage catalysis may result from the interplay of two competing catalytic cycles⁽²³⁾.

According to our hypothesis, the proposed mechanism of terpolymerization occurs via a combination of reported catalytic cycles^{(14, 15c)} which share a common zinc alkoxide intermediate (Scheme 3). Previous mechanistic studies have shown that for polycarbonate synthesis, insertion of CO₂ is rapid (B), whereas insertion of CHO is rate limiting (D)^{(15c)}. Based on the typical reactivity of the monomers, insertion of anhydride (A) is expected to be much faster than insertion of CO₂ (B), and insertion of CHO is likely the rate-determining step for polyester (C) as well as polycarbonate (D) formation.

Based on these predicted activities, the observed block formation is consistent with a product-determining step that is pre-rate determining. The polymerization initiates when (BDI)ZnOAc ring-opens CHO to give a zinc alkoxide intermediate. Then, in the product-determining step (A vs. B), the zinc alkoxide reacts preferentially and irreversibly with DGA to form a zinc carboxylate and an ester bond (A) followed by a slower, rate-determining insertion of CHO (C) to produce polyester and regenerate zinc alkoxide. Production of the polyester block continues until nearly all the DGA is consumed, at which point incorporation of CO₂ becomes competitive (˜150 min, FIG. 1). Then the zinc alkoxide can react with CO₂, form a zinc carbonate, and insert CHO to form polycarbonate (B and D). This second block is produced more rapidly than the first because, in the rate-determining step, insertion of CHO into a zinc carbonate (I)) is more rapid than insertion into a zinc carboxylate (C)⁽²⁴⁾.

To verify that the proposed mechanism results in the observed selectivity and relative rates of block formation, we derived a kinetic model to predict the concentrations of polyester and polycarbonate as a function of time during the reaction. Using experimentally measured values for the rate constants and k_{c} and k_{d} estimated values for kₐ and k_{b}, we were able to fit the simulated concentrations to the experimental data. The best fit resulted from kₐ/k_{b}=130±10⁽²⁵⁾. As seen from FIG. 30, the simulated (solid lines) and experimental data (points) were in excellent agreement throughout the reaction, particularly when the product and, consequently, the rate of polymerization change dramatically. Thus, the proposed mechanism accurately models the observed synthesis of discrete blocks with the second block produced faster than the first.

There are very few examples of diblock polymer synthesis via kinetic resolution. In the previously mentioned example by Spassky(11), the reaction only slowly approached 100% conversion because of the inactivity of the (S,S) enantiomer. This example, which exhibits a slower rate for the second block, is in stark contrast to our terpolymerization, in which the second block (polycarbonate) has a faster overall rate of formation than the first block, (polyester, FIG. 30) yet displays little tapering.

We next explored the effect of CO₂ pressure on composition and rate. As seen in FIG. 29, as CO₂ pressure increases to 27 atm, the reaction proceeds with little change. Above 27 atm, the overall rate decreases, and CO₂ insertion becomes more competitive with DGA insertion (entries 6 and 7). Inspection of the ¹³C NMR spectra of reactions with varying CO₂ pressure reveals a small shoulder emerging on the polyester carbonyl resonance (169 ppm) as pressure increases from 6.8 to 54 atm (FIG. S8)⁽¹⁶⁾. We attribute this peak to the random incorporation of CO₂ into the polyester block, which increases as CO₂ pressure increases. Entry 8 shows that the reaction does not stop, but merely continues at a slower rate at 54 atm. The rate inhibition above 27 atm can be ascribed to a dilution effect resulting from the increased amount of CO₂ in the reactor.

TABLE 3
Effect of CO₂ Pressure on Terpolymerization.^{[a]}

| | | | |
|---|---|---|---|
| CO₂ | % CHO Conv. to^{[b]} | Mₙ^{[c]} | MWD^{[c]} |

| Entry | [atm] | PE | PC | [g/mol] | [M_{W}/Mₙ] |
|---|---|---|---|---|---|
| 1^{[d]} | 0 | 17 | 0 | 13000 | 1.3 |
| 2 | 3.4 | 18 | 51 | 17000 | 1.3 |
| 3 | 6.8 | 18 | 54 | 22000 | 1.4 |
| 4 | 14 | 20 | 67 | 31000 | 1.2 |
| 5 | 27 | 19 | 51 | 34000 | 1.2 |
| 6 | 41 | 14 | 6 | 13000 | 1.2 |
| 7 | 54 | 8 | 3 | 650 | 1.3 |
| 8^{[e]} | 54 | 17 | 55 | 29000 | 1.3 |

^{[a]}Conditions: 40 μmol 1, 20 mmol CHO, 4.0 mmol DGA, 4.0 mL toluene, 55° C., 1 h.
^{[b]}PE = polyester, PC = polycarbonate. Conversion determined by ¹H NMR spectroscopy.
^{[c]}Determined by GPC.
^{[d]}Reaction run for 30 min.
^{[e]}Reaction run for 2 h⁽¹⁶⁾.

We have also found that succinic anhydride will react with CHO and CO₂ to form a diblock terpolymer with similar properties to the DGA containing polymer, albeit with a slower overall rate⁽¹⁴⁾ (Scheme 4a). Furthermore, incorporation of vinyl cyclohexene oxide offers the opportunity for post polymerization modification (Scheme 4b):

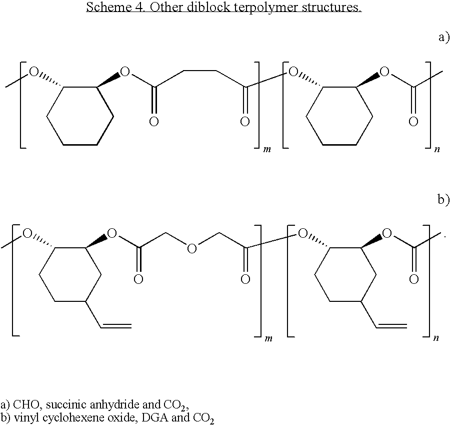

The present Example therefore describes a novel method for the block terpolymerization of epoxides, cyclic anhydrides, and CO₂ in a simple one-step, one-pot procedure under mild reaction conditions. This reaction is of significant interest because it produces terpolymers with very little tapering, which is clearly evident from a plot of repeat unit concentration versus time for each polymer block (FIG. 30). The precise block structure results from a highly selective product-determining step that is pre-rate-determining. Calculations of the concentrations of both polymer blocks as a function of time support the proposed mechanism shown in Scheme 3.

### REFERENCES

(1) G. Krausch, I L Magerle, Adv. Mater. 2002, 14, 1579-1583.
(2) N. Kumar, M. N. V. Ravilcumar, A. J. Domb, Adv. Drug Delivery Rev. 2001, 53, 23-44
(3) D. Zschech, D. H. Kim, A. P. Milenin, I L Scholz, I L Hillebrand, C. J. Hawker, T. P. Russell, M. Steinhart, U. Gosele, Nano Lett. 2007, 7, 1516-1520 and references therein.
(4) G. J. Domski, J. M. Rose, G. W. Coates, A. D. Bolig, M. Brookhart, Prog. Polym. Sci. 2007, 32, 30-92.
(5) D. Pospiech, H. Komber, D. Jehnichen, L. Haussler K. Eckstein, H. Scheibner, A. Janke, H. R. Krieheldorf, O. Petermann, Biomacromolecules 2005, 439-446.
(6) N. Hadjichristidis, S. Pispas, G. A. Floudas, Block Copolymers esthetic Strategies, Physical Properties, and Applications, Wiley-Interscience, Hoboken, N.J.; 2003.
(6) N. Hadjichristidis, S. Pispas, G. A. Floudas, Block Copolymers Synthetic Strategies, Physical Properties, and Applications, Wiley-Interscience, Hoboken, N.J. 2003.
(7) M. A. Hillmyer, Curr. Opin. Solid State Mater. Sci, 1999, 4, 559-564.
(8) D. Mecerreyes, 0. Moineau, P. Dubois, R. Jérôme J. L. Hedrick, C. J. Hawker E. B. Malaström, M. Trollsas, Angew. Chem. 1998, 110, 1306-1309; Angew. Chem Int. Ed. 1998, 37, 1274-1276.
(9) M. W. Weinier O. A. Scherman, D. Y. Sogah, Macromolecules 1998 31 8425-8428...
(10) C. W. Bielawski J. Louie R. H Grubbs, J. Am. Chem. Soc. 2000, 122, 12872-12873.
(11) N. Spassky, M. Wisniewski, C. Pluta, A. Le Borgne, Macromol. Chem. Phys. 1996, 197, 2627-2637.
(12) M. Schappa_cher, T. Fabre, A. F. Mingotaud, A. Soum, Biomaterials 2001, 22, 2849-2855. b) T. Fabre, M. Schappacher, R. Bareille, B. Dupuy, A. Sown, J. Bertrand-Barat, C. Baquey, Biomaterials 2001, 22, 2951-2958.
(13) J. Xu, Z. Liu, R. Zhuo, J. Appl. Poly. Sci. 2006 101, 1988-1994.
(14) R. C. Jeske, A. M. DiCiccio, G. W. Coates, J. Am. Chem. Soc. 2007, 129, 11330-11331.
(15) a) M. Cheng, D. R. Moore, J. J. Reczelc, B. M. Chamberlain, E. B. Lobkovsky, G. W. Coates, J. Am. Chem. Soc. 2001, 121, 8738-8749. b) D. R. Moore, M. Cheng E. B. Lobkovsky, G. W. Coates, Angew. Chem. 2002, 114, 2711-2714; Angew. Chem. Int. Ed 2002, 41, 2599-2602. c) D. IL Moore, M. Cheng, E. B. Lobkovsky, U. W. Coates, J. Am. Chem. Soc. 2003, 125, 11911-11924. d) S. D. Allen, D. IL Moore, E. B. Lobkovsky, G. W. Coates, J. Am. Chem. Soc. 2002, 124, 14284-14285.
(16) See Example 6.
(17) In some cases, the experimental molecular weight are less than the theoretical molecular weights. Without wishing to be bound by any particular theory, we propose that, despite ngorous purification, trace protic impurities, diacid, may act as chain transfer agents and therefore may be responsible for this discrepancy.
(18) The ratio of polyester to polycarbonate repeat units in the diblock polymer is identical before and after precipitation in methanol; however, the precipitation of a 1:1 ratio of polyester and polycarbonate homopolymers leads to significant enrichment in polycarbonate.
(19) Y. Hwang, J. Jung M. Ree, H. Kim, Macromolecules 2003, 36, 8210-8212.
(20) Y. Liu, K. Huang, D. Peng, H. Wu, Polymer 2006, 47, 8453-8461.
(21) M. Kröger, C. Folli, O. Walter, M. Döring, Adv. Synth. Catal. 2006, 348, 1908-1918.
(20) For reports of IR spectroscopy used to monitor catalytic reactions see: a) D. J. Darensbourg, J. C. Yarbrough, C. Ortiz, C. C. Fang, J. Am. Chem. Soc. 2003, 125, 7586-7591. b) T. L. Church, Y. D. Y. L. Getzler, G. W. Coates, J. Am. Chem. Soc. 2006, 128, 10125-10133.
(22) For reports of IR spectroscopy to monitor catalytic reactions see: a) D. J. Darensbourg, J. C. Yarbrough, C. Ortiz, C. C. Fang, J. Am. Chem. Soc. 2003, 12.5, 10125-10133.
(23) For an example of a related two-stage mechanism see: J. M. Rowley, E. B. Lobkovsky, G. W. Coates, J. Am. Chem. Soc. 2007, 129, 4948-4960.
(24) For further discussion of the mechanism see Example 6.
(25) The error bars associated with this measurement result from the uncertainty in the CO₂ concentration measurement; see Example 6.

### Example 5

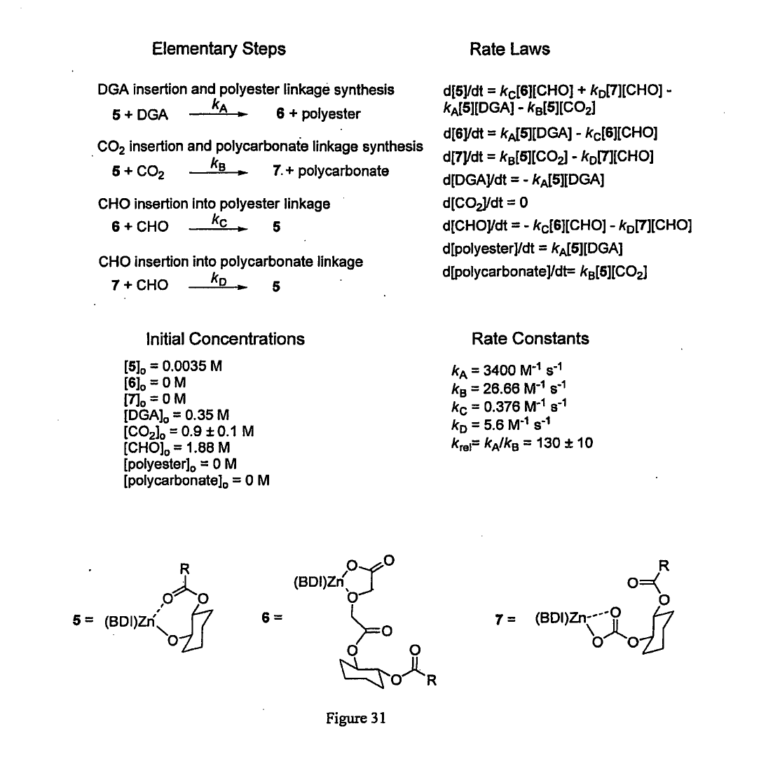

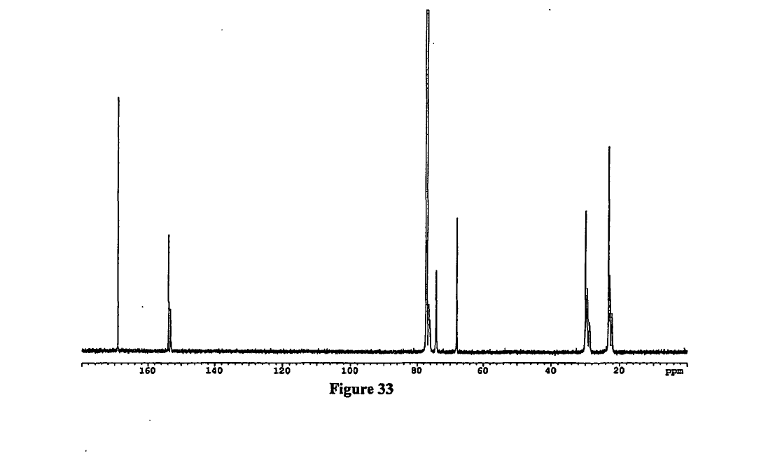

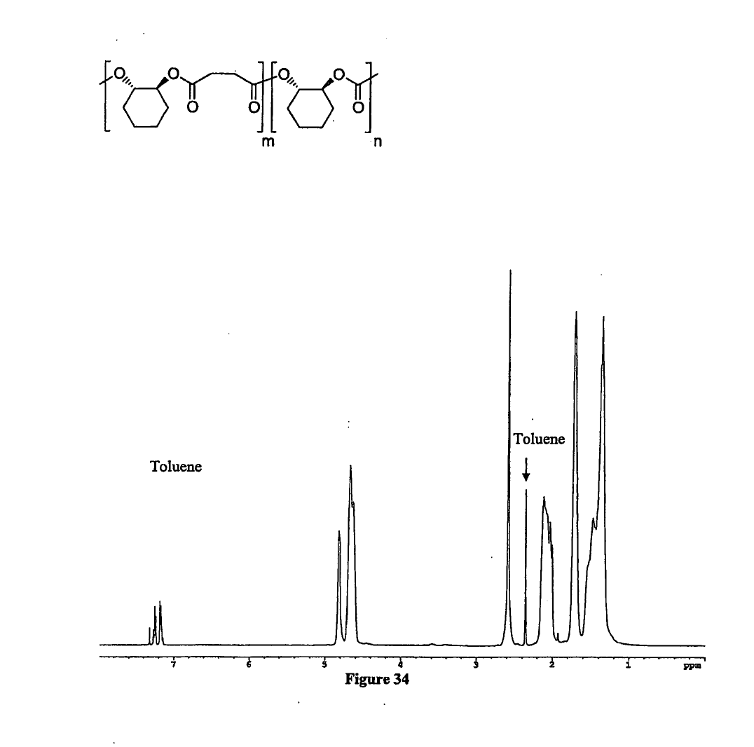

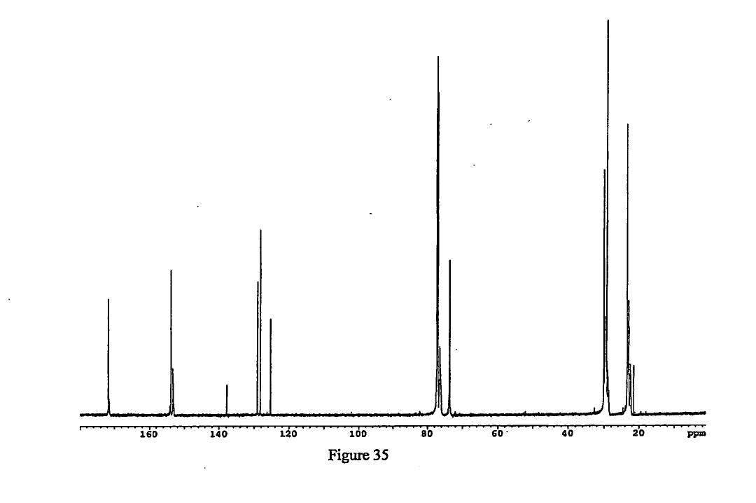

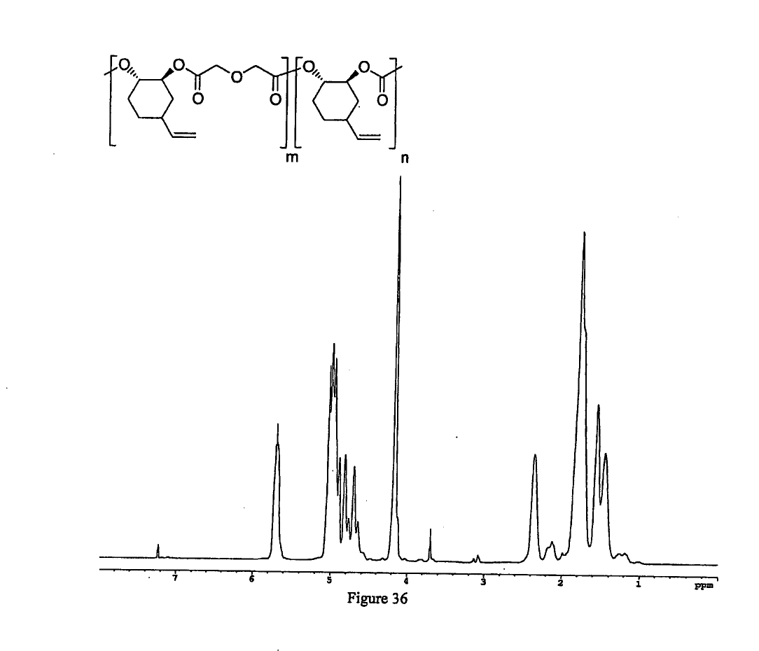

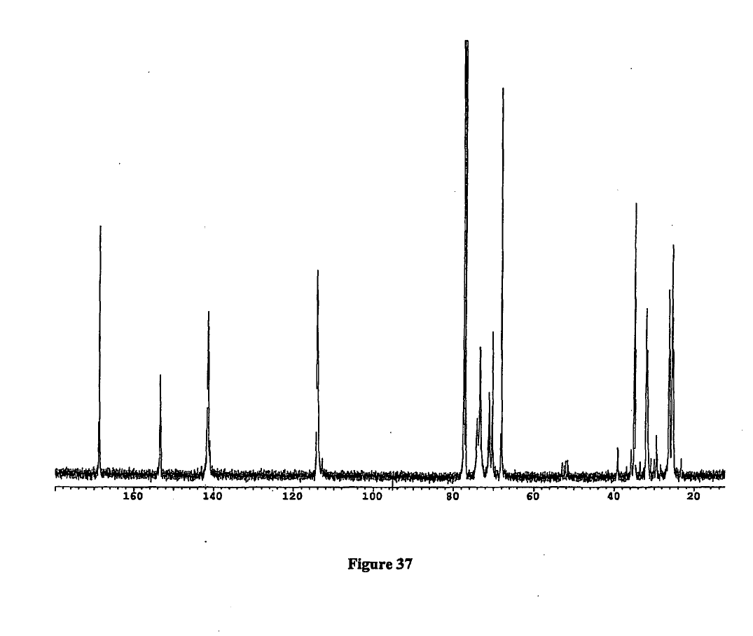

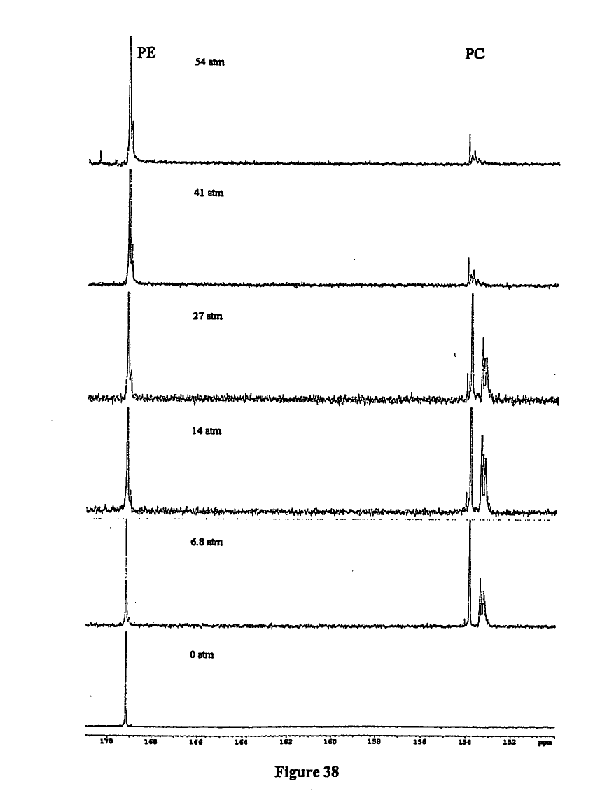

### Supporting Information Evidencing One-Step Preparation of Diblock Copolymers via Terpolymerization of Epoxides, Cyclic Anhydrides, and CO₂ as Described in Example 4 (see FIGS. 31-38)

### General Methods

Manipulations of air and water sensitive compounds were carried out under dry nitrogen using a Braun Labmaster glovebox or standard Schlenk line techniques. ¹H NMR spectra were recorded on Varian Mercury (300 MHz), Varian 1NOVA 400 (400 MHz) or Varian NOVA 500 (500 MHZ) spectrometer and referenced to residual non-deuterated solvent shifts (CHCl₃=7.26 ppm, C₆D₅H=7.16 ppm). ¹³C {¹H} NMR spectra were recorded on a Varian NOVA 500 (125 MHz) spectrometer and referenced to chloroform, 77.23 ppm.

Gel permeation chromatography (GPC) analyses were carried out using a Waters instrument, (M515 pump, 717+ Autosampler) equipped with a Waters UV486 and Waters 2410 differential refractive index detectors, and three 5 μm PSS SDV columns (Polymer Standards Service; 50 Å, 500 Å, and Linear M porosities) in series. The GPC columns were eluted with THF at 40° C. at 1 mL/min and were calibrated using 20 monodisperse polystyrene standards.

Differential scanning calorimetry (DSC) of polymer samples was performed in crimped aluminum pans using a TA Instruments Q1000 instrument equipped with a liquid nitrogen cooling accessory under nitrogen with a heating rate of 10° C./min from −100° C. to +230° C.

A high pressure stainless steel reactor was purchased from the Parr Instrument Co. A separate Parr reactor was modified for use with a ReactIR 4000 purchased from Mettler Toledo. An 85 mL glass pressure reactor was purchased from Andrews Glass Co. and fitted with a pressure gauge, resettable pressure release valve, injector port, and Swagelok quick connect.

### Materials

HPLC grade toluene, methylene chloride, tetrahydrofuran, pentane and Optima grade hexanes were purchased from Fisher Scientific and purified over solvent columns. Cyclohexene oxide (purchased from Aldrich) and vinyl cyclohexene oxide (purchased from Dow Chemical) were dried over calcium hydride, degassed via three freeze-pump-thaw cycles, then vacuum transferred under nitrogen and stored in the glove box. Diglycolic anhydride and succinic anhydride (purchased from Acros) were dried overnight under vacuum, recrystallized twice from acetic anhydride, sublimed twice under dry nitrogen and stored in the glovebox. Diethyl zinc was purchased from Aldrich and used as received. All other reagents were purchased from common commercial sources and used as received.

### Complex Synthesis

[(BDI)ZnOAc] complexes exist as dimers in the solid state and in a monomer/dimer equilibrium in solution. Complexes 4, 5, 6, and 8 were prepared according to literature proceedures.¹⁻⁴

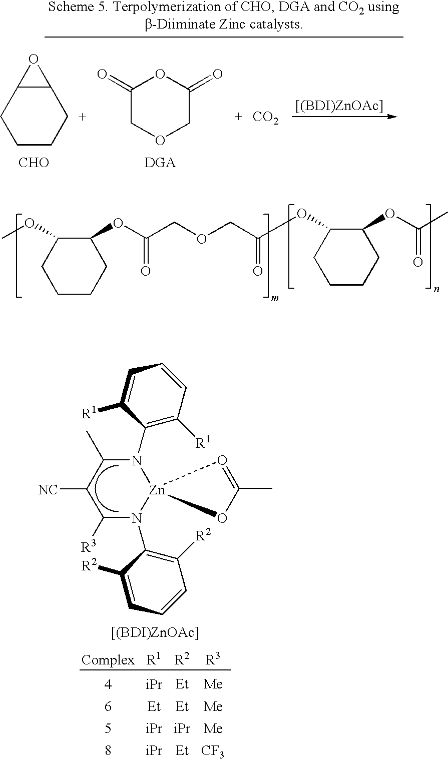

TABLE 4
Terpolymerization of CHO, DGA, and CO₂^{[a]}

| | | tᵣₓₙ | Conv. of CHO^{[b]} | | Mₙ^{[c]} | MWD^{[c]} |
|---|---|---|---|---|---|---|
| Entry | Complex | (min) | % Polyester | % PC | (g/mol) | (M_{W}/Mₙ) |
| 1 | 4 | 60 | 20 | 70 | 37000 | 1.2 |
| 2 | 6 | 420 | 18 | <1 | 8700 | 1.6 |
| 3 | 5 | 60 | 11 | <1 | nd^{[d]} | nd^{[d]} |
| 4 | 8 | 60 | 22 | 8 | nd^{[d]} | nd^{[d]} |

^{[a]}Conditions: 20 μmol Zn, 10 mmol CHO, 2.0 mmol DGA, 2.0 mL toluene, 50° C., 6.8 atm CO₂
^{[b]}Conversion determined by ¹H NMR spectroscopy.
^{[c]}Determined by gel permeation chromatography (GPC), in THF, calibrated by polystyrene standards.
^{[d]}Not determined.

### Representative Terpolymerization of CHO, DGA and CO₂ at 6.8 atm (Table 4, Entry 3)

In the glovebox, complex 4 (10.7 mg, 20 μmol), DGA (230 mg, 2.0 mmol), CHO (1.0 mL, 9.9 mmol), and toluene (2 mL) were combined in a dry, glass, pressure reactor. The reactor was sealed, removed from the glovebox and warmed to 50° C. in a pre-heated water bath. Upon equilibration at 50° C., 6.8 atm CO₂ was added and the reactor was vented to 0.7 atm. The flushing procedure was repeated for a total of 5 times, repressured to 6.8 atm, and the reaction was stirred for 1 hr. As DGA is not fully soluble in toluene, the initially heterogeneous solution became homogeneous over the course of the reaction. The pressure was vented, and a small sample of the viscous solution was removed for crude ¹H NMR spectroscopy analysis in order to determine conversion of CHO. A delay time of 25 seconds between pulses was used when acquiring the crude spectrum to quantitatively integrate the methine protons on CHO. The solution was diluted with a minimum of toluene (˜3 mL) and slowly poured into methanol (˜40 mL) to precipitate the polymer. The polymer was collected and dried in vacuo at 55° C. to give a white solid typically in 90-95% recovery by weight. Note: For terpolymers with a higher percentage of polyester (Table 1, Entries 4-7, Table 2, Entries 1, 6, 7), diethyl ether was used as a non-solvent to precipitate. ¹H NMR (CDCl₃, 500 MHz): δ 4.84 (m, CH, polyester), 4.62 (m, CH, polycarbonate), 4.13 (s, CH₂, diglycolate), 2.02 (m, CH₂, cyclohexane ring), 1.67 (m, CH₂, cyclohexane ring), 1.40 (m, CH₂, cyclohexane ring); ¹³C NMR (CDCl₃, 125 MHz): δ 169.2, 153.5, 153.2, 77.2, 76.4, 74.3, 68.1, 29.7, 28.8, 23.3, 22.4. See below for NMR spectra.

### Terpolymerization of CHO, DGA and CO₂ at Various Pressures

A 100 mL stainless steel Parr reactor was dried at 100° C. under vacuum for 8 hours. Upon cooling, it was taken into a glovebox, where complex 4 (21.4 mg, 40 μmol), DGA (460 mg, 4.0 mmol), CHO (2.0 mL, 20 mmol), and toluene (4.0 mL) were combined in a dried glass insert and placed in the reactor. The reactor was sealed, removed from the glovebox, and heated to 55° C. in a pre-heated oil bath. The appropriate pressure of CO₂ was introduced, and the reaction was stirred for 1 or 2 hr. The polymer was isolated as in above.

### Terpolymerization of SA, CHO and CO₂

Procedure was identical to that of Table 4, entry 3 (above) except that succinic anhydride (200 mg, 2.0 mmol) was added instead of DGA, and the reaction was run for 16 hr. Diethyl ether was used as a non-solvent to precipitate. The ¹H NMR spectrum indicated 21% conversion to polyester, 71% conversion to polycarbonate. Mₙ=27000 g/mol, PDI=1.2. ¹H NMR (CDCl₃, 500 MHz): δ 4.82 (m, CH, polyester), 4.65 (m, CH, polycarbonate), 2.59 (s, CH₂, succinate), 2.10 (m CH₂, cyclohexane ring), 1.71 (m, CH₂ cyclohexane ring), 1.43 (m, CH₂, cyclohexane ring); ¹³C NMR (CDCl₃, 125 MHz): δ 171.7, 153.8, 153.3, 77.1, 76.5, 73.7, 30.0, 22.6. See below for NMR spectra.

### Terpolymerization of DGA, Vinyl Cyclohexene Oxide, and CO₂

Procedure was identical to that of Table 4, entry 3 (above) except that vinyl cyclohexene oxide (1.3 mL, 9.9 mmol) was added instead of CHO. The ¹H NMR spectrum indicated 20% conversion to polyester, 70% conversion to polycarbonate. Mₙ=16000 g/mol, PDI=1.4. ¹H NMR (CDCl₃, 500 MHz): δ 5.68 (m, CH═CH₂), 4.80 (m, CH polyester, CH polycarbonate, CH═CH₂), 4.17 (s, CH₂, diglycolate), 2.36 (m, CH—CH═CH₂), 1.77 (m, CH₂ cyclohexane ring), 1.50 (m, CH₂ cyclohexane ring); ¹³C NMR (CDCl₃, 125 MHz): δ 168.8, 153.5, 141.5, 114.3, 77.2, 74.2, 73.4, 71.2, 70.3, 68.1, 35.0, 31.9, 26.4, 25.5. See Figure ______ for NMR spectra.

### Terpolymerization Monitored by ReactIR

The Parr reactor adapted for in situ IR monitoring was dried under vacuum at 90° C. overnight. Upon cooling, it was introduced into a glovebox where 4 (20 mg, 37 μmol), DGA (490 mg, 3.7 mmol) and toluene (8.0 mL) were added. The reactor was sealed, removed from the glovebox and pressured to 14 atm with CO₂. The reactor was mechanically stirred and heated to 50° C. Upon equilibration, pressure was reduced to 1.7 atm, and CHO (2.0 mL, 20 mmol) was injected through a septum via syringe at time=0. The reactor was immediately repressured to 6.8 atm, and IR spectra were collected once per minute (16 scans/spectrum at 4 cm⁻¹ resolution). Absorbances of polyester and polycarbonate were measured at 1139 and 1328 cm⁻¹, respectively. Absorbances were measured in the C—O stretching region rather than the carbonyl region because of the difficulty in measuring the overlapping ester and carbonate carbonyl peaks. When plotting the data, we assumed a linear relationship between absorbance and concentration for both polyester and polycarbonate.

### Determination of CO₂ Concentration in Solution

A glass pressure reactor was charged with a stirbar and 10.5 mL of a 2:1 toluene:CHO solution. The reactor was weighed at 0 atm (1 atm air in the headspace) (1117.75 g), then flushed with CO₂ via five cycles of pressuring to 6.8 atm psig and venting to 0.7 atm. The bottle was weighed again after equilibration at 6.8 atm of CO₂ (1119.23 g), and this increase (1.48 g) corresponds to the additional mass of CO₂ in the bottle, both in the headspace and dissolved in solution. Next, the toluene and CHO solution was removed and replaced with two Teflon-coated stirbars, which had equivalent volume (10.5 mL), but would not absorb CO₂. The bottle was again weighed at 0 atm CO₂ (1 atm air in the headspace) (1146.89 g) and 6.8 atm CO₂ (1147.96 g) to find the mass of CO₂ in the headspace (1.07 g). The difference between headspace and total CO₂ must be the CO₂ that dissolved in the reaction solution (0.41 g in 10.5 mL=0.9 M CO₂). We also independently calculated the mass of CO₂ in the headspace using a measured headspace volume of 81.5 mL which supports our measured value for the mass of CO₂ in the headspace:

$$g of gas = \frac{MW * P * V}{R * T} \to \frac{44 g \text{/} mol C {O}_{2} * 6.8 atm * 0.0815 L}{0.0821 L * atm \text{/} ( K * mol ) * 298 K} = 0.997 g$$

### Note on Proposed Mechanism

Without wishing to be bound by any particular theory, we note that that the relevant reaction mechanism may be described in terms of monomeric species; however, it is likely that the catalytic cycle operates, at least in part, through dimeric zinc intermediates. We propose that the terpolymerization may operate by a mechanism analogous to that reported for CHO/CO₂ copolymerization with [(BDI)ZnOR] catalysts,³. For example, the following may be true: (1) zinc allcoxides rapidly insert CO₂ to form zinc carbonates; (2) insertion of CHO into a zinc carbonate is the rate-limiting step; (3) in this step, the zinc carbonate exists in a monomer/dimer equilibrium in the ground state, and (4) proceeds through a bimetallic transition state, (5) resulting in a total order in zinc which varies from 1.0 to 1.8 depending on the ground state equilibrium.

### Calculation of Polyester and Polycarbonate Concentration as a Function of Time

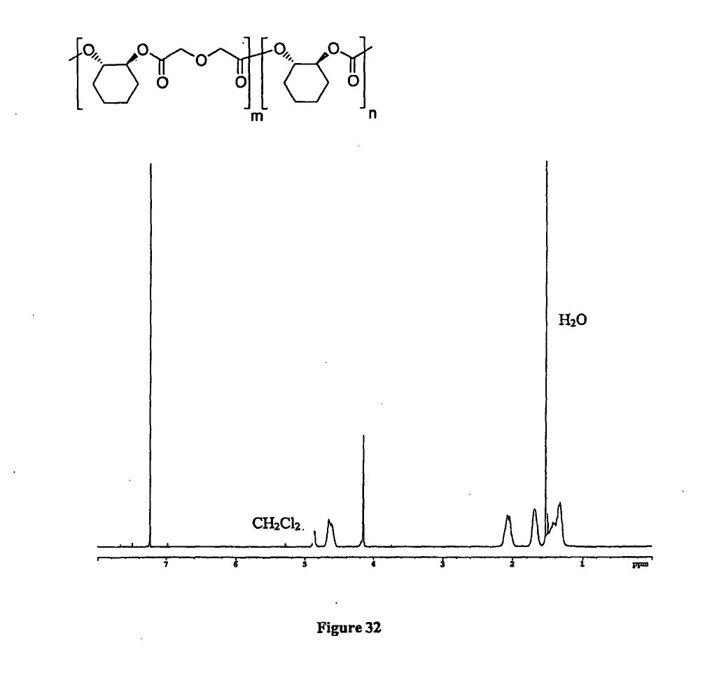

To verify that our proposed mechanism results in the observed kinetic behavior, we derived a mathematical model for the catalytic cycle. Based on insight from related mechanistic studies,³ we made the following assumptions: (1) the rate of initiation of [(BDI)ZnOAc] is comparable to the rate of propagation, thus [(BDI)ZnOAc] rapidy inserts CHO (FIG. 32) and begin the catalytic cycle; (2) substrate coordination to zinc is fast and reversible; (3) monomer insertion is irreversible; (4) insertion of CHO is rate-limiting; and (5) the mechanism operates through monomeric zinc species.⁵ With these assumptions, the mechanism can be simply expressed as four elementary steps, and rate laws can be derived for the concentration of each species in the proposed mechanism. Since CO₂ in solution is in equilibrium with CO₂ in the headspace, we assumed dissolution was rapid and that the effective concentration of CO₂ in solution remained constant throughout the reaction. Initial concentrations were selected from the in situ IR experiment; rate constants k_{C} and k_{D} were calculated from experimental data; and the pre-rate-determining rate constants (k_{A} and k_{B}) were initially estimated. This set of differential equations was then solved using the software program Scientist, available from Micro Math Scientific Software, Inc. Concentrations of polyester and polycarbonate calculated as a function of time were overlaid with the experimental concentrations, and then the values of k_{A} and k_{B} were adjusted to give the best fit to the experimental data.

### REFERENCES

(1) R. C. Jeske, A. M. DiCiccio, G. W. Coates, J. Am. Chem. Soc., 2007, 129, 11330-11331.
(2) S. D. Allen, D. R. Moore, E. B. Lobkovsky, G. W. Coates, J. Am. Chem. Soc., 2002, 124, 14284-14285.
(3) D. R. Moore, M. Cheng, E. B. Lobkovsky, G. W. Coates, J. Am. Chem. Soc., 2003, 125, 11911-11924.
(4) Moore, D. R., Ph.D. Dissertation, Cornell University, Ithaca, N.Y., 2003.
(5) Although a zinc monomer-dimer equilibrium and bimetallic transition state result in a total order in zinc ranging from 1 to 2, we have chosen to present the simplest model wherein the order in zinc is 1. If the model is recalculated with higher orders of zinc, the absolute values of the rate constants change, but the same kinetic behavior is observed.

1. A polymer of formula I: 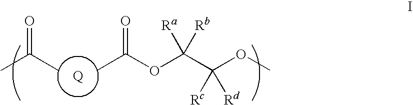
wherein:
R^{a}, R^{b}, R^{c}, and R^{d} are each independently a hydrogen or C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group;
wherein the PDI of the polymer is less than 2.

2. A block copolymer of formula II: 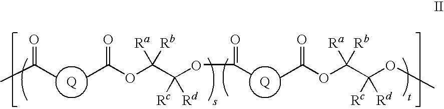
wherein:
s is an integer from 1 to 100,000;
t is an integer from 1 to 100,000;
the sum of s and t is greater than 9;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group;
wherein at least one [t] bracketed structure is different from an [s] bracketed structure.

3. A random copolymer of formula III: 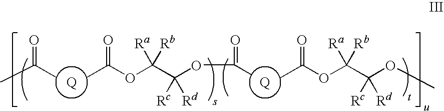
wherein:
s is an integer from 1 to 100,000;
t is an integer from 1 to 100,000;
the sum of s and t is greater than 9;
u is an integer greater than zero;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
each occurrence of R^{y} is independently hydrogen or an optionally substituted C₁₋₆ aliphatic group;
wherein at least one [t] bracketed structure is different from the [s] bracketed structure; and
wherein each occurrence of a [t] bracketed structure and [s] bracketed structure are dispersed randomly within a [u] bracketed structure.

4. A block copolymer of formula IV: 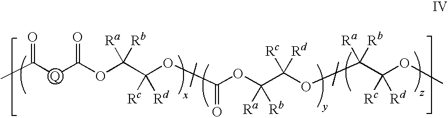
wherein:
x is an integer from 1 to 100,000;
y is an integer from 1 to 100,000;
z is an integer from 0 to 5000;
the sum of x and y is greater than 9;
z has a value that is less than 3% of the sum of x+y+z;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group.

5. A random copolymer of formula V: 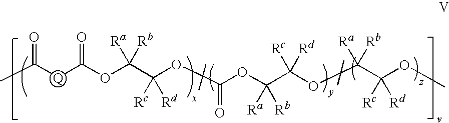
wherein:
x is an integer from 1 to 100,000;
y is an integer from 1 to 100,000;
z is an integer from 0 to 5000;
the sum of x and y is greater than 9;
z has a value that is less than 3% of the sum of x+y+z;
v is an integer greater than zero;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
each occurrence of R^{y} is independently hydrogen or an optionally substituted C₁₋₆ aliphatic group; and
wherein each occurrence of a [α] bracketed structure, [y] bracketed structure, and [z] bracketed structure are dispersed randomly within a [v] bracketed structure.

6. A method of polymerization, the method comprising:
(a) providing an epoxide of formula VI: 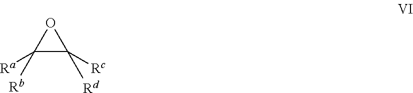
wherein:
R^{a}, R^{b}, R^{c}, and R^{d} are each independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
(b) providing a cyclic anhydride of formula VII: 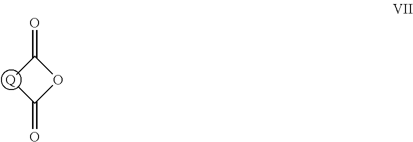
wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
each occurrence of R^{y} is independently hydrogen or an optionally substituted C₁₋₆ aliphatic group;
(c) admixing the epoxide and cyclic anhydride under suitable conditions for polymerization in the presence of a metal complex of formula VIII:
Lₙ-M-(X)ₙ VIII
wherein:
M is a metal atom;
Lₙ is a suitable permanent ligand set comprised of one or more ligands;
X is a nucleophilic ligand; and
n is an integer between 1-5, inclusive;
to provide a polymer of formula I:

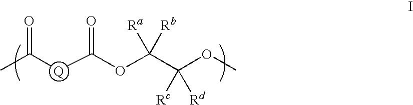

7. A method of polymerization, the method comprising:
(a) providing at least a first epoxide of formula VI: 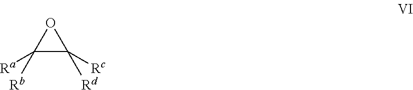
wherein:
R^{a}, R^{b}, R^{c}, and R^{d} are each independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
(b) providing at least a first cyclic anhydride of formula VII: 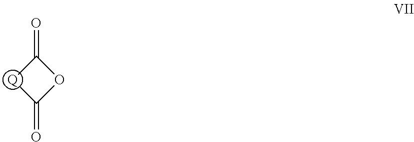
wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R⁷)—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
each occurrence of R^{y} is independently hydrogen or an optionally substituted C₁₋₆ aliphatic group;
(c) admixing a first epoxide and a first cyclic anhydride, under suitable conditions for polymerization in the presence of a metal complex of formula VIII:
Lₙ-M-(X)ₙ VIII
wherein:
M is a metal atom;
Lₙ is a suitable permanent ligand set comprised of one or more ligands;
X is a nucleophilic ligand; and
n is an integer between 1-5, inclusive;
and
(d) after substantially complete incorporation of a first epoxide or a first cyclic anhydride to the polymer, admixing at least one selected from:
(i) a second epoxide of formula VI, or
(ii) a second cyclic anhydride of formula VII;
to provide a polymer of formula II: 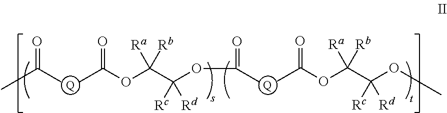
wherein:
s is an integer from 1 to 100,000;
t is an integer from 1 to 100,000;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group;
wherein at least one [t] bracketed structure is different from an [s] bracketed structure.

8-11. (canceled)

12. A method of polymerization, the method comprising:
(a) providing at least a first epoxide of formula VI: 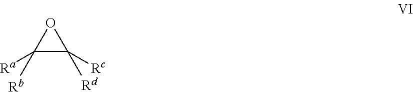
wherein:
R^{a}, R^{b}, R^{c}, and R^{d} are each independently hydrogen or a C₁₋₃₀ carbon containing moiety; wherein any of (R^{a} and R^{c}), or (R^{a} and R^{c}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
(b) providing at least a first cyclic anhydride of formula VII: 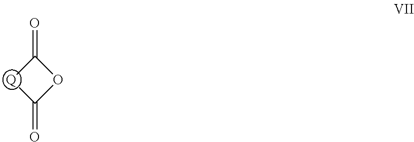
wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
each occurrence of R^{y} is independently hydrogen or an optionally substituted C₁₋₆ aliphatic group;
(c) admixing at least a first epoxide and at least first cyclic anhydride, under suitable conditions for polymerization in the presence of a metal complex of formula VIII:
Lₙ-M-(X)ₙ VIII
wherein:
M is a metal atom;
Lₙ is a suitable permanent ligand set comprised of one or more ligands;
X is a nucleophilic ligand; and
n is an integer between 1-5, inclusive;
to provide a random copolymer of formula III: 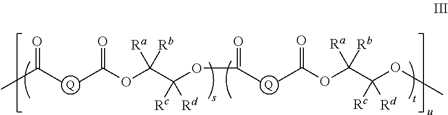
wherein:
s is an integer from 1 to 100,000;
t is an integer from 1 to 100,000;
u is an integer greater than zero;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group;
wherein at least one [t] bracketed structure is different from the [s] bracketed structure.
wherein each occurrence of a [t] bracketed structure and [s] bracketed structure are dispersed randomly within a [u] bracketed structure.

13-15. (canceled)

16. A method of polymerization, the method comprising:
(a) providing at least a first epoxide of formula VI: 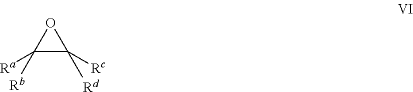
wherein:
R^{a}, R^{b}, R^{c}, and R^{d} are each independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
(b) providing at least a first cyclic anhydride of formula VII: 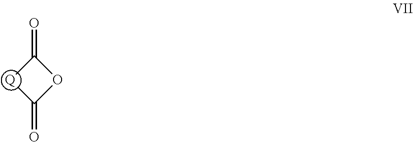
wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
each occurrence of R^{y} is independently hydrogen or an optionally substituted C₁₋₆ aliphatic group;
(c) admixing a first epoxide, a first cyclic anhydride, and CO₂ under suitable conditions for polymerization in the presence of a metal complex of formula VIII:
Lₙ-M-(X)ₙ VIII
wherein:
M is a metal atom;
Lₙ is a suitable permanent ligand set comprised of one or more ligands;
X is a nucleophilic ligand; and
n is an integer between 1-5, inclusive;
to provide a block copolymer of formula IV: 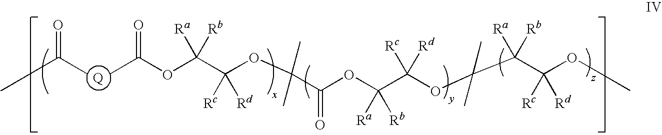
wherein:
x is an integer from 1 to 100,000;
y is an integer from 1 to 100,000;
z is an integer from 0 to 5000;
z has a value that is less than 3% of the sum of x+y+z;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group.

17-20. (canceled)

21. A method of polymerization, the method comprising:
(a) providing at least a first epoxide of formula VI: 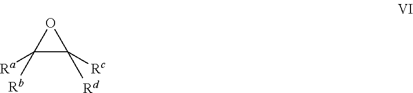
wherein:
R^{a}, R^{b}, R^{c}, and R^{d} are each independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
(b) providing at least a first cyclic anhydride of formula VII: 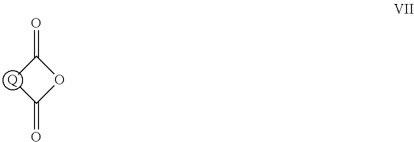
wherein Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—;
each occurrence of R^{y} is independently hydrogen or an optionally substituted C₁₋₆ aliphatic group;
(c) admixing at least a first epoxide, at least first cyclic anhydride, and CO₂ under suitable conditions for polymerization in the presence of a metal complex of formula VIII:
Lₙ-M-(X)ₙ VIII
wherein:
M is a metal atom;
Lₙ is a suitable permanent ligand set comprised of one or more ligands;
X is a nucleophilic ligand; and
n is an integer between 1-5, inclusive;
to provide a random copolymer of formula V: 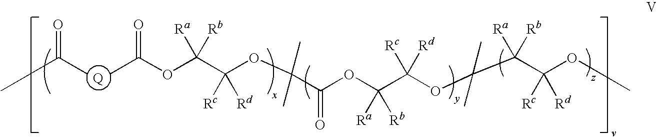
wherein:
x is an integer from 1 to 100,000;
y is an integer from 1 to 100,000;
z is an integer from 0 to 5000;
z has a value that is less than 3% of the sum of x+y+z;
v is an integer greater than zero;
each occurrence of R^{a}, R^{b}, R^{c}, and R^{d} is independently hydrogen or a C₁₋₃₀ carbon containing moiety; wherein any of (R^{a} and R^{c}), or (R^{a} and R^{b}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
each occurrence of Q is an optionally substituted group selected from the group consisting of C₇₋₁₂ arylalkyl; 6-10-membered aryl; 5-10-membered heteroaryl having 1-4 heteroatoms independently selected from nitrogen, oxygen, or sulfur; 4-7-membered heterocyclic having 1-2 heteroatoms independently selected from the group consisting of nitrogen, oxygen, and sulfur; and a saturated or unsaturated, straight or branched, C₁-C₃₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—; and
each occurrence of R^{y} is independently hydrogen or an optionally substituted C₁₋₆ aliphatic group.
wherein each occurrence of a [x] bracketed structure, [y] bracketed structure, and [z] bracketed structure are dispersed randomly within a [v] bracketed structure.

22-24. (canceled)

25. The polymer of claim 4, wherein the polymer has a PDI between 1 and about 2.

26. The polymer of claim 4, wherein the polymer has a PDI of less than 1.5.

27. The polymer of claim 4, wherein the polymer has a PDI of less than 1.4.

28. The polymer of claim 4, wherein the polymer has a PDI of less than 1.3.

29. The polymer of claim 4, wherein the polymer has a PDI of less than 1.2.

30. The polymer of claim 4, wherein the polymer has a PDI of less than 1.1.

31. The polymer of claim 4, wherein the polymer has an Mₙ of less than 10,000 g/mol.

32. The polymer of claim 4, wherein the polymer has an Mₙ greater than 10,000 g/mol.

33. The polymer of claim 4, wherein the polymer has an Mₙ in the range of about 50,000 to about 300,000 g/mol.

34. The polymer of claim 4, wherein the polymer has an Mₙ in the range of about 100,000 to about 200,000 g/mol.

35. The polymer of claim 4, wherein the polymer has a T_{g} above 50° C.

36. The polymer of claim 4, wherein the polymer has a T_{g} in the range of about 50° C. to about 120° C.

37. The polymer of claim 4, wherein the polymer has a T_{g} in the range of about 50° C. to about 70° C.

38. The polymer of claim 4, wherein the mole fraction of polyether linkages in the polymer is less than 3%.

39. The polymer of claim 4, wherein the mole fraction of polyether linkages in the polymer is less than 2%.

40. The polymer of claim 4, wherein the mole fraction of polyether linkages in the polymer is less than 1%.

41-113. (canceled)
